(19) United States
(12) Patent Application Publication
(10) Pub. No.: US 2016/0019324 A1
(43) Pub. Date: Jan. 21, 2016

(54) ANALYSIS AND SHARING OF CUSTOM DEFINED COMPUTATION MODELS AND EXPERIMENTAL DATA

(71) Applicant: WikiModel LLC, Fairfax, VA (US)

(72) Inventors: Sami Kanderian, Germantown, MD (US); Ameet Nayak, Fairfax, VA (US)

(73) Assignee: WikiModel LLC, Fairfax, VA (US)

(21) Appl. No.: 14/800,301

(22) Filed: Jul. 15, 2015

Related U.S. Application Data
(60) Provisional application No. 62/024,664, filed on Jul. 15, 2014.

(51) Int. Cl. G06F 17/50; G06F 17/10

(52) U.S. Cl. CPC G06F 17/5009; G06F 17/10

(57) ABSTRACT

The present application relates to systems, methods, and computer program products for analyzing or simulating a mathematical model. A mathematical model analysis computer system may generate a simulation of a mathematical model including one or more model equations based on the model equations and a parameter set. The one or more model equations may include at least a differential equation and/or at least one closed form equation. The one or more model equations may not be written in a syntax particular to a specific programming language. The one or more model equations may include one or more parameters. The parameter set may include a parameter value for each of the one or more parameters from a device remote from the computer. The mathematical model analysis computer system may generate simulation results including a plot of the model simulation and a dataset that includes experimental data related to the model.

### CROSS REFERENCE TO RELATED APPLICATION

This application claims the benefit of priority to U.S. Provisional Application Ser. No. 62/024,664, filed on Jul. 15, 2014, which is incorporated herein by reference in its entirety.

### BACKGROUND

1. Field of Invention

The present invention relates generally to systems, apparatuses, and methods for simulating a mathematical model. The present invention may facilitate comparing and/or fitting simulated mathematical models to experimental data. The present invention may also allow users to share models and datasets easily with others.

2. Discussion of Background

In a typical scenario, a scientist or engineer hypothesizes a mathematical model describing some physical phenomena and needs to validate and refine the model by comparing it and fitting it to (i.e., replicating) experimental data. After parameters have been fit or identified, the model is simulated under different inputs so as to make predictions as to how the system would behave under different conditions.

Such analysis could also be useful in understanding the underlying physical phenomena by seeing how well different models fit the experimental data. Identified (fit) model parameters fit to the experimental data help classify the source of the data. For example, in the design of a suspension system consisting of a mass, spring, and dashpot, fitting a second order model to experimental data allows an engineer to classify the system as under damped, critically damped, or over damped.

Scientists and engineers must manually program custom software (e.g., in C++, Java, or another programming language) or program a specialized numerical programming language such as Matlab, Mathmatica, R, Python, Perl, S+, or SAS Institute software to describe a mathematical model, to choose and implement the computational methods for solving the model, and to apply experimental data to the model. A custom program needs to be written for each mathematical model to be analyzed. Because most physical phenomena are described by dynamic systems consisting of multiple differential equations, writing computer programs or scripts in mathematical modeling tools is very involved and requires specialized knowledge of applied mathematics (e.g., computational algorithms for integrating differential equations). These software packages are installed on personal computers requiring much hard drive space hardware infrastructure with heavy processing capability.

Typically, a scientist who hypothesizes a mathematical model does not possess the programming expertise required to perform the mathematical analysis. A programmer is usually hired to perform the task. Moreover, a model typically needs to be changed multiple times as the scientist considers the results, and the program must be updated accordingly each time. There is a fair deal of overhead involved in this back-and-forth between the scientist and programmer.

Publishing a model or sharing it with other scientists is also problematic. Although there are many sources of published models and their related data (usually paper publications), a different party wishing to study the models will have to implement it on their own platform—requiring more programming.

Publishing models is typically done via paper publications that only cover the findings and not all of the data analyzed to arrive at those findings. For example, the raw experimental data used to test the hypothesis (model) is typically not included in the publication. It is very difficult for third-party scientists to validate the published model using their own experimental data. In order to do so, a third-party scientist would have to contact the publisher and ask for the necessary models and data, program the model to run in their own analysis tool (or custom program), and apply their own data to the model. In order to ask questions and resolve anomalies in the results, the third-party scientist will likely have to contact the author via email or phone, and the author will not be able to see exactly what the other scientist is doing unless the author replicates the analysis on this own system. There is considerable cost in reconciling differences in findings.

Accordingly, there is a need in the art for improved systems, apparatus, and methods for facilitating the creation and analysis of mathematical models as compared to experimental data and/or sharing models and datasets.

### SUMMARY

The present invention provides, among other advantages, improved systems, apparatuses, and methods for facilitating the creation and analysis of mathematical models as compared to experimental data. Some aspects of the invention may address one or more of the problems of convention mathematical model analysis by providing a system, apparatus, or method for analyzing mathematical models without the need for any programming. In some embodiments, the system may also provide a shareable, searchable repository where one or more user can publish their models and data. In one embodiment, a user may choose a model from the repository and run analysis on the chosen model. Some embodiments may enable collaboration, commenting, and/or asking questions. In some embodiments, users may be able to navigate to a specific workspace (i.e., model with its related data set) via the click of a link. In some embodiments, users may be able to run batches of computations on multiple combinations of models and data sets (e.g., a model may be fit to multiple data sets or multiple models may be fit to a data set or both). Some embodiments may use distributed processing (e.g., using map-reduce or other means) to speed batch computation.

Some aspects of the invention may provide a mathematical model analysis tool that requires no installation by the end user. The tool may run on a website and may be compatible with multiple devices and operating systems. In some embodiments, any device with a web browser may serve as a front end Graphical User Interface. In some non-limiting embodiment, inputs and/or data may be sent to a remote server where analysis is performed and results are sent back to the user's device.

In some embodiments, a system embodying aspects of the present invention may provide a visual tool (e.g., a graph) to ensure that the initial guess is reasonable. The visual tool may plot a simulation of the model using a set of values assigned to the parameters so that the user can choose a decent initial guess when fitting model parameters to experimental data. In some embodiments, the system may solve models consisting of multiple interdependent equations that may be discrete equations, differential equations, closed form equations, or a combination of two or more equation types. In some embodiments, the system may handle discrete inputs (e.g., step functions, impulses, interpolation methods, or a combination of them) well, and inputs may be constant or may change with time. In some embodiments, parameters may be constrained to be within certain bounds or constrained to a certain function. Parameters may be constrained as constants while others may be fit/identified by the system. In some embodiments, after fitting a model to a particular experimental dataset, the system may re-simulate the model under different inputs and initial conditions to optimize an output profile. This may allow the user to test the effect of different input profiles by computer before implementing them in real life.

In some embodiments, a system embodying aspects of the present invention may be capable of performing tests on multiple models against a particular data set and determining which models most adequately fit the data for their complexity (i.e., by using the residual runs test or the f test to compare pairs of models.) In some embodiments, the system may enable the user to run one or more tests to determine whether parameters identified from a group of data sets is significantly different from those derived from other data sets (e.g., the system may perform the P test or the Anova test.)

In some embodiments, a system embodying aspects of the present invention may offer a common platform and repository where mathematical models can be uploaded, searched, and tested against different data sets. Accordingly, the system may greatly improve collaboration between scientists, who can easily publish their models and data, and others, who can easily replicate the findings and verify them using their own experimental data. In some embodiments, there may be a forum/blog where questions can be posed alongside the model and data set to which they pertain. This may allow anomalies in scientists' findings to be easily resolved because all parties will be looking at the same results on the same platform, and all factors leading to the results may be clearly shown.

One aspect of the invention may provide a method of analyzing or simulating a mathematical model. The method may include receiving, at a computer, an identification of a user-defined model from a device remote from the computer. The method may include receiving the identified model. The model may include one or more model equations. The one or more model equations may include at least one differential equation and/or at least one closed form equation. The one or more model equations may not be written in a syntax particular to a specific programming language. The one or more model equations may include one or more parameters. The method may include receiving a parameter set including a parameter value for each of the one or more parameters from a device remote from the computer. The method may include receiving an identification of a dataset from a device remote from the computer. The method may include receiving the identified dataset. The dataset includes experimental data related to the model. The method may include generating a simulation of the model based on the one or more model equations and the parameter set. The method may include generating simulation results including a plot of the model simulation and the dataset. The method may include transmitting the simulation results to a device remote from the computer.

In some embodiments, the method may include calculating an error between the simulated model and the experimental data, and the simulation results may include the calculated error. In some embodiments, the method may include identifying a best fit parameter set including a best fit parameter for each of the one or more parameters.

In some embodiments, the parameter set may be an initial parameter set, and identifying the best fit parameter set may include: calculating an error between the simulated model and the experimental data; generating a new parameter set including a parameter value for each of the one or more parameters, wherein one or more of the parameter values of the new parameter set is different from a corresponding parameter value of the initial parameter set; generating a new simulation of the model based on the one or more model equations and the new parameter set; and calculating an error between the new simulated model and the experimental data.

In some embodiments, identifying the best fit parameter set may include iteratively generating new parameter sets, wherein the best fit parameter set is a set of the new parameter sets that minimizes a calculated error between a simulation of the model based on the one or more model equations and the set of the new parameter sets and the experimental data. In some embodiments, identifying the best fit parameter set may include using either a linear or non-linear least squares procedure. In some embodiments, identifying the best fit parameter set may include automatically determining whether to use a linear least squares procedure or a non-linear least squares procedure.

In some embodiments, the method may include generating a best fit simulation of the model based on the one or more model equations and the best fit parameter set, and generating best fit results including the best fit parameter set and a plot of the best fit simulation and the dataset. In some embodiments, the method may include receiving a second dataset, which includes experimental data related to the model, from a device remote from the computer; generating second simulation results including a plot of the model simulation and the second dataset; and transmitting the second simulation results to a device remote from the computer.

In some embodiments, the method may include receiving a second model from a device remote from the computer. The second model may include one or more second model equations that (i) include at least a differential equation or multiple closed form equations, (ii) are not written in a syntax particular to a specific programming language, and (iii) include one or more second model parameters. The method may include receiving a second parameter set including a parameter value for each of the one or more second model parameters from a device remote from the computer, generating a second simulation of the second model based on the one or more second model equations and the second parameter set, generating second simulation results including a plot of the second model simulation and the dataset, and transmitting the second simulation results to a device remote from the computer. In some embodiments, generating the second simulation of the second model may require none of re-writing, re-interpreting, and re-compilation of a program.

In some embodiments, the one or more model equations may include a differential equation. In some embodiments, the one or more model equations may include two or more differential equations. In some embodiments, the one or more model equations may include a closed form equation. In some embodiments, the one or more model equations include multiple closed form equations.

In some embodiments, the method may include receiving a second parameter set including a second parameter value for each of the one or more parameters from a device remote from the computer, generating a second simulation of the model based on the one or more model equations and the second parameter set, generating second simulation results including a plot of the second simulation of the model and the dataset, and transmitting the second simulation results to a device remote from the computer.

In some embodiments, generating the simulation of the model may include interpreting the one or more model equations as an interdependent system of equations. In some embodiments, interpreting the one or more model equations as an interdependent system of equations may include treating a state variable listed on the left hand side of a model equation of the one or more model equations that also appears on the right hand side of a model equation of the one or more model equations as the same variable.

Another aspect of the invention may provide a computer system for analyzing or simulating a mathematical model. The computer system may include a storage device; a computer; and a computer readable medium storing computer readable instructions executable by said computer. The computer may be operative to receive an identification of a user-defined model from a remote device. The computer may be operative to receive the identified model from the storage device. The received model may include one or more model equations. The one or more model equations may include at least a differential equation and/or at least one closed form equations. The one or more model equations may not be written in a syntax particular to a specific programming language. The one or more model equations may include one or more parameters. The computer may operative to receive an identification of a dataset from the remote device. The computer may be operative to receive the identified dataset from the storage device. The received dataset may include experimental data related to the model. The computer may operative to receive a parameter set including a parameter value for each of the one or more parameters from the remote device. The computer may be operative to generate a simulation of the model based on the one or more model equations and the parameter set. The computer may be operative to generate simulation results including a plot of the model simulation and the dataset. The computer may be operative to transmit the simulation results to the remote device.

Further variations encompassed within the systems and methods are described in the detailed description of the invention below.

### DEFINITIONS

A “model” or “mathematical model” refers to a set of one or more equations, that may be differential equations, closed-form equations, or discrete equations, representing physical phenomena or other dynamical systems. The equations may be dependent on each other. The equations may feature one of more parameters which may be fixed or may be identified by the tool via systems identification.

A “closed form equation” refers to an equation that takes the form y=f(x) where y is any variable name and f(x) is a formula. Examples of closed form in this document include equations include Equations 7, 19, 24, 32, 33, 34, 35, 36, and 37.

An “independent variable” refers to a variable that is not dependent on any other variable in a model. It never appears on the left hand side of an equation. However, it is noted that the t in dy/dt does not count as dy/dt signifies the derivative of the dependent variable y with respect to the independent variable, t. The range of values of the independent variable is controlled by a user in a numerical simulation. In all the Examples in this document, the independent variable is t (time), but it could any unique variable defined by the user such as x, but then every t would have to be replaced by x.

A “discrete equation” refers to an equation where a value of a state variable at a point in time is dependent on another. For example, the equation x[t]=2*x[t−1]+y[t] is a discrete equation.

A “state variable” refers to a dependent variable whose value is calculated for every value spanned by the independent variable. The value of the state variable may change as the independent variable changes. In some embodiments of the invention, every variable lifted on the left hand side of a model equation may be treated as a state variable. State variables may also appear on the right hand side of an equation.

“Systems identification” or “model fitting” refers to the process by which parameters of a model are identified by fitting a simulated model variable to a data set though linear or non-linear least squares.

“Linear least squares” or “linear regression” refers to the process by which an output variable of a linear model is fit to a dataset whereby the optimal parameters of the model are solved for such that the Sum Squared Error (SSE) between the model and the dataset is minimized. Linear least squares gives a true and direct solution (no iteration and therefore no initial guess is required) for optimal parameters. An example of a linear model is the equation of a line, or a set of linear equations.

“Nonlinear least squares” refers to the process by which an output variable of a non-linear model is fit to a dataset whereby the optimal parameters of the model are solved for such that the sum of squared errors of prediction (SSE) between the model and the dataset is minimized. The identification of optimal in nonlinear least squares is an iterative process that requires an initial guess for each parameter. For instance, if we are trying to identify parameters a and b in the example equation y=a*exp(−t/b) where t is the independent variable, then non-linear least squares is required, however if b is a constant, then linear least squares can solve for the optimal a.

“Repository” refers to the database of models and their related data sets.

“Computational methods” refer to the application of computer simulation and other numerical analysis to solve problems in various scientific disciplines. Examples of computational methods that may be used in the invention are, without limitation, numerical simulations, model fitting, and/or computational optimization.

“Numerical simulations” refers to calculation of values of one or more variables in the model for a series of inputs across the entire span of an independent variable.

“Cloud” refers to an Internet-based development and use of computer technology stored on servers rather than the client computers. In some embodiments, the cloud may be implemented in heavily redundant and load-balanced cluster of servers and network infrastructure to ensure maximum availability.

“Cloud storage” refers to a model of networked online storage. Distribution, replication, and/or load balancing across database servers may be used to ensure minimal data loss.

“Load balancing” refers to a method for distributing workloads across multiple computers or a computer cluster, network links, central processing units, disk drives, or other computing resources.

“Distributed processing” refers to the use of distributed computer systems to solve computational problems (single or multiple models fit to one or more datasets). In distributed computing, a problem may be divided into many tasks, each of which is solved by one or more computers.

“Programming” refers to writing lines of code in a particular syntax unique to a particular programming language. For every different model, current state of the art software (e.g., MATLAB, Mathematica, R, Python, Perl, and SAS) requires that a new program be re-written (re-coded), re-interpreted or re-compiled in syntax particular to the programming language. There is a difference between interpreting the equations that are input to the software, which is what the invention does, versus writing (i.e., coding), interpreting and/or compiling the program required by the state of the art.

### BRIEF DESCRIPTION OF THE DRAWINGS

The accompanying drawings, which are incorporated herein and form part of the specification, illustrate various, non-limiting embodiments of the present invention. In the drawings, like reference numbers indicate identical or functionally similar elements.

FIG. 1 is a schematic view illustrating a system embodying aspects of the present invention.

FIG. 2 is a schematic view illustrating mathematical model analysis computer system computer system embodying aspects of the present invention.

FIG. 3 is a flowchart illustrating a model simulation process according to some embodiments.

FIG. 4 is a flowchart illustrating a mathematical model and data validation process according to some embodiments.

FIG. 5 is a flowchart illustrating a process for simulation of a model having no differential equations according to some embodiments.

FIGS. 6A, 6B, and 6C are flowcharts illustrating a process for simulation of a model having at least one differential equation according to some embodiments.

FIG. 7 is a flowchart illustrating a process for initializing state variables according to some embodiments.

FIG. 8 is a flowchart illustrating a process for fitting a model to experimental data according to some embodiments.

FIGS. 9A and 9B are flowcharts illustrating a process for publishing a model and data according to some embodiments.

FIG. 10 is a flowchart illustrating a process for searching and retrieving a model and/or data according to some embodiments.

FIGS. 11A and 11B are flowcharts illustrating processes for uploading and downloading, respectively, a model and data according to some embodiments.

FIGS. 12A and 12B are flowcharts illustrating a process for batch processing of multiple models and/or datasets according to some embodiments.

FIG. 13 is a block diagram of a mathematical model computer system according to some embodiments.

FIGS. 14A and 14B show the model equations, parameters (initial value), and graph of the resulting simulation of Example 1 (shock absorber) model that may be generated by the mathematical model analysis computer system according to some embodiments.

FIGS. 15A and 15B show the fit parameters and simulation graph as a result of a fit operation performed on Example 1 (shock absorber) model by the mathematical model analysis computer system according to some embodiments.

FIG. 16 illustrates the equivalent results of the script and functions programming/code required by MATLAB to simulate and fit the Example 1 (shock absorber) model to experimental data.

FIGS. 17A, 17B, 17C, and 17D illustrate model equations, parameters (initial value), input and experimental data, graphs of inputs and simulation results of the Example 2 (drug absorbance) model that may be generated by the mathematical model analysis computer system under a set of parameters (initial guess) according to some embodiments.

FIGS. 18A and 18B show the fit parameters and simulation graph as a result of a fit operation performed on Example 2 (drug absorbance) model by the mathematical model analysis computer system according to some embodiments.

FIG. 19 illustrates the equivalent results of the script and functions programming/code required by MATLAB to simulate and fit the Example 2 (drug absorbance) model to experimental data.

FIGS. 20A and 20B show the model equations, fit parameters and simulation graph as a result of a fit operation performed on the Example 3 (metabolic) model by the mathematical model analysis computer system according to some embodiments.

FIGS. 21A and 21B show the model equations, fit parameters and simulation graph as a result of a fit operation performed on the Example 4 (Hodgkin-Huxley model of membrane potential) model by the mathematical model analysis computer system according to some embodiments.

FIG. 22 illustrates how different values for a parameter of the Example 1 (shock absorber) model affect the result and how a fit result for the parameter can be used to classify a property of the system from which the data was obtained.

FIGS. 23A, 23B, and 23C illustrates a new simulation, by a mathematical model analysis computer system embodying aspects of the present invention, of an identified Example 2 (drug absorbance) model under new input conditions for the basal and bolus infusions whereby parameters were fit from prior input and experimental data.

FIGS. 24A and 24B illustrates the results of a re-simulation, by a mathematical model analysis computer system embodying aspects of the present invention, of the Example 3 (metabolic) model under different input conditions whereby parameters were fit from prior input and experimental data.

FIGS. 25-28 illustrate the results of simulations and fit operations, by a mathematical model analysis computer system embodying aspects of the present invention, on the Example 1 (shock absorber) model based on different initial guesses for the parameters.

FIG. 29 illustrates user-definable graphing properties with the results of a simulation of the Example 4 model (Hodgkin-Huxley model of membrane potential) model by the mathematical model analysis computer system according to some embodiments.

FIGS. 30A and 30B illustrate model equations and the results of a subsequent simulation of the Example 4 model (Hodgkin-Huxley model of membrane potential) model by the mathematical model analysis computer system according to some embodiments under different input conditions.

FIGS. 31A, 31B and 31C show the diagram, equations and fit results of one model (Model 1) fit to dose response experimental data that may be generated by the mathematical model analysis computer system according to some embodiments.

FIGS. 32A, 32B and 32C show the diagram, equations and fit results of another model (Model 2) fit to dose response experimental data that may be generated by the mathematical model analysis computer system according to some embodiments.

FIGS. 33A and 33B show a statistical comparison of the goodness of fit of two different models fit to the same experimental data set that may be generated by the mathematical model analysis computer system according to some embodiments.

FIG. 34 is a flowchart illustrating a process for determining elements of an independent variable vector according to some embodiments.

FIGS. 35A, 35B, and 35C illustrate an example where an input value to the model is changed at a time not spanned by the independent array defined by “Start,” “Delta,” and “End” values.

FIGS. 36A-E illustrate the social networking aspect of the website where the creator of a model and/or data set provides an adjacent description and users can submit comments.

### DETAILED DESCRIPTION

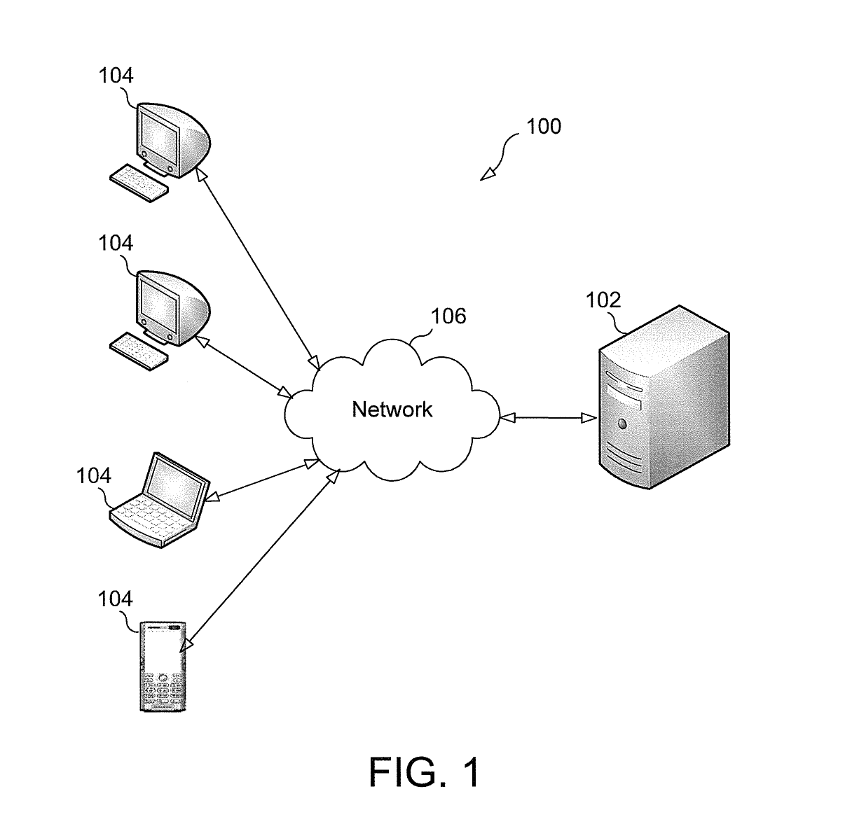

FIG. 1 is a schematic view of a system 100 embodying aspects of the present invention. In some embodiments, the system 100 may include a mathematical model analysis computer system 102. In some non-limiting embodiments, the mathematical model analysis computer system 102 may be a server. In some embodiments, the mathematical model analysis computer system 102 may be connected to a network 106. In some non-limiting embodiments, the network 106 may include, for example, one or more of the Internet, a Wide Area Network (WAN), a local area network (LAN), and a wireless (e.g., cellular) network. In some embodiments, the mathematical model analysis computer system 102 may transmit and receive information to and from the network 106.

In some embodiments, the system 100 may include one or more remote devices 104 (e.g., client or user devices). In some non-limiting embodiments, a remote device 104 may be, for example, a desktop computer, a laptop computer, a tablet computer, or a smartphone. In some non-limiting embodiments, a remote device 104 may include a user interface (e.g., a display and/or input device, such as, for example, a mouse, touchpad, keyboard, stylus, microphone, or touchscreen). In some embodiments, a remote device 104 may transmit and receive information to and from the network 106. In some embodiments, a remote device 104 may connect with the mathematical model analysis computer system 102 (e.g., via a web browser executed on the remote device 104), and the remote device 102 may transmit and receive information to and from the mathematical model analysis computer system 102 over the network 106.

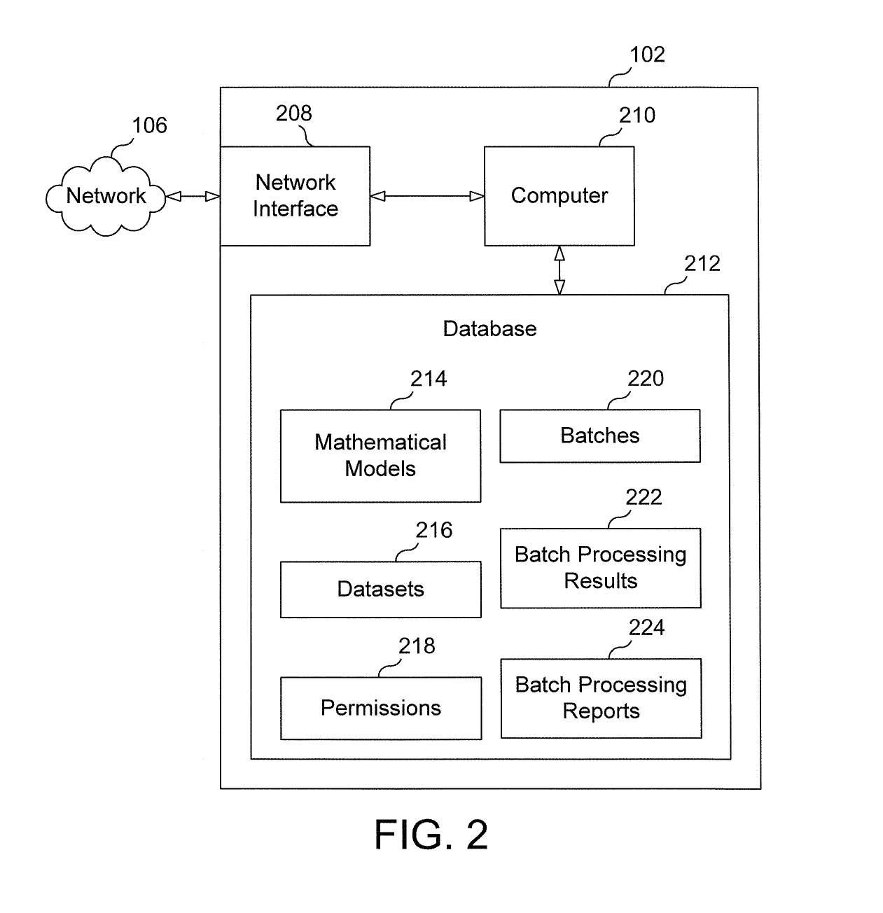

FIG. 2 is a schematic view of a non-limiting embodiment of the mathematical model analysis computer system 102, which may be included in the system 100 illustrated in FIG. 1. As illustrated in FIG. 2, in some embodiments, the mathematical model analysis computer system 102 may include a network interface 208, a computer 210, and a database or storage device 212. The network interface 208 may be connected to the network 106. The network interface 208 may facilitate transmission of data from the computer 210 over the network 106 and receipt of information from the network 106 to the computer 210.

In some embodiments, the database 212 may be a non-volatile storage device. In some embodiments, the database 212 may store one or more of mathematical models 214, datasets 216, permissions 218, batches 220, batch processing results 222, and batch processing reports 224. In some embodiments, one or more of the mathematical models 214 in the database 212 may have been received/uploaded from a remote device 104. Similarly, in some embodiments, one or more of the datasets 216 in the database 212 may have been received/uploaded from a remote device 104. Although the database 212 is illustrated in FIG. 2 as a single unit, this is not required, and, in some alternative embodiments, the database 212 may include one or more databases.

In some embodiments, the computer 210 may receive information (e.g., a selection or identification of a mathematical model 214 and a dataset 216) from a remote device 104 (e.g., via network 106 and network interface 208). In some non-limiting embodiments, based on the received information, the computer 210 may access a mathematical model 214 and a dataset 216 stored in the database 212, simulate the mathematical model 214, fit the mathematical model 214 to experimental data in the dataset 216, generate graphs and/or results, and/or transmit the generated graphs and/or results to the remote device 104 (e.g., via network interface 208 and network 106).

In some embodiments, equations can be added to or removed from a model. In some embodiments, a set of one or more model equations in a mathematical model 214 may be interpreted as an interdependent system of equations and treated appropriately as a mathematical system of equations. That is, a state variable listed on the left hand side of an equation may appear on the right hand side of another equation and may be treated as the same variable. Also, a state variable listed on the left hand side of a model equation may appear in the formula on the right hand side of the same model equation (e.g., “y=y+1” or “dy/dt=−y”). In some embodiments, certain variables that appear in one or more equations can be defined as parameters that may have constants assigned to them. In some embodiments, parameters can be added or removed and their values can be altered.

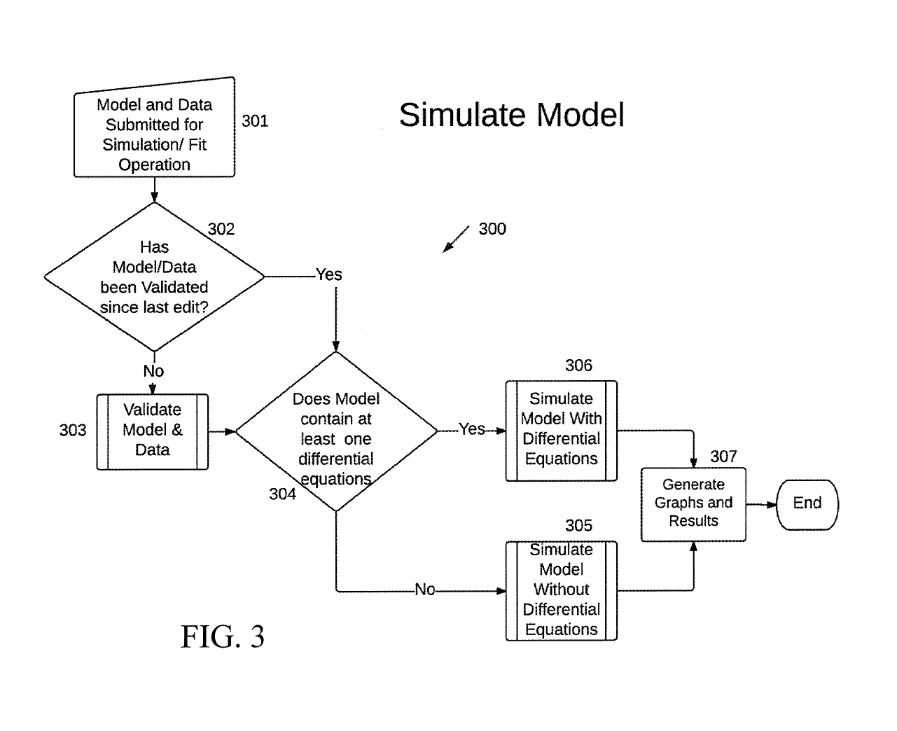

FIG. 3 is a flowchart illustrating a process 300 for simulating a mathematical model according to some embodiments. In some embodiments, the process 300 may begin in step 301 with the computer 210 submitting one or more of a mathematical model and a dataset for a simulation operation. In some non-limiting embodiments, the computer 210 may receive an identification of the one or more of the mathematical model and the dataset for submission from the remote device 104. In some embodiments, the identification of one or more of a mathematical model and a dataset may be received from the remote device 104 via the network 106 and the network interface 208. In some embodiments, the identification of the mathematical model may be a selection of a mathematical model 214 stored in database 212 or a mathematical model transmitted from remote device 104 (e.g., after being input by a user into the remote device 104). In some embodiments, the identification of the dataset may be a selection of a dataset 216 stored in database 212 or a dataset transmitted from remote device 104 (e.g., after being input by a user into the remote device 104). In some embodiments, the remote device 104 may transmit the identification of the one or more of the mathematical model and the dataset for submission in response a user input received via a user interface (e.g., in response to a user clicking on a displayed “simulate model” button).

In some embodiments, the process 300 may include a step 302 in which the computer 210 determines whether the model and/or dataset submitted for the simulation operation has been validated (e.g., since the last edit of the model and/or dataset).

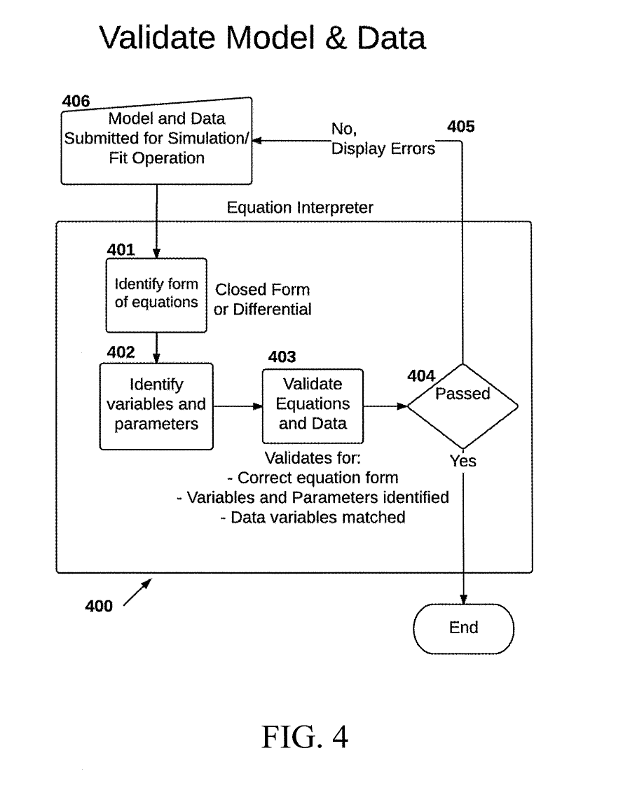

In some embodiments, the process 300 may include a step 303 in which the computer 210 validates the submitted mathematical model and/or dataset. The process 300 may proceed to the validation step 303 if the computer 210 determines in step 302 that the model and/or dataset submitted for the simulation operation has not been validated. A non-limiting embodiment of the processing that may be performed in the validation step 303 is described below with reference to FIG. 4.

In some embodiments, the process 300 may include a step 304 in which the computer 210 determines whether the submitted model contains at least one differential equation. In some embodiments, the process 300 may proceed to the step 304 if the submitted mathematical model and dataset passes validation in step 303. Likewise, if the computer 210 determines in step 302 that the submitted mathematical model and dataset has been validated, the process 300 may proceed to the step 304 of determining whether the submitted model contains at least one differential equation.

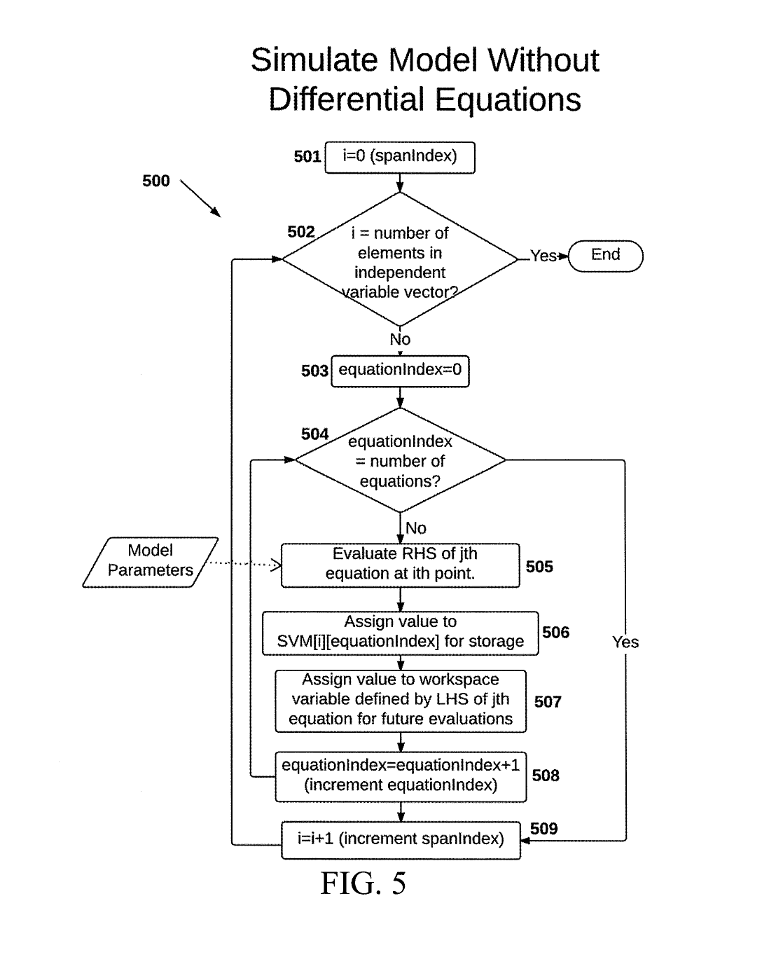

In some embodiments, the process 300 may include a step 305 in which the computer 210 simulates the submitted mathematical model without differential equations. In some embodiments, the process 300 may proceed to the step 305 if the computer 210 determines in step 304 that the submitted model does not contain any differential equations. A non-limiting embodiment of the processing that may be performed in step 305 is described below with reference to FIG. 5.

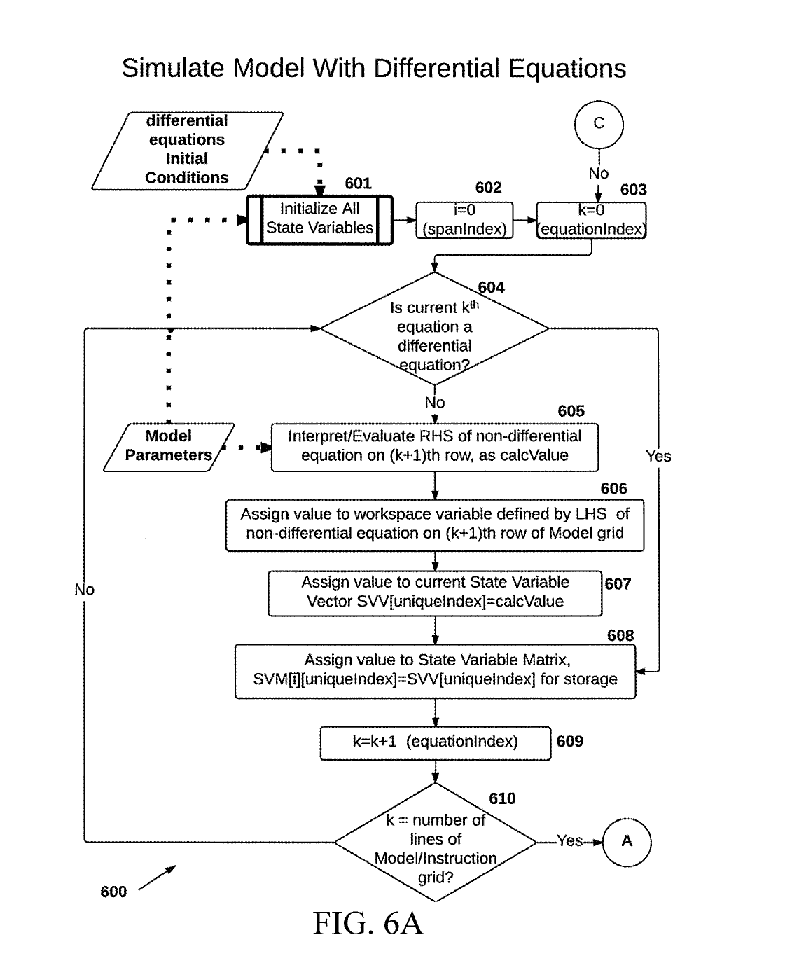

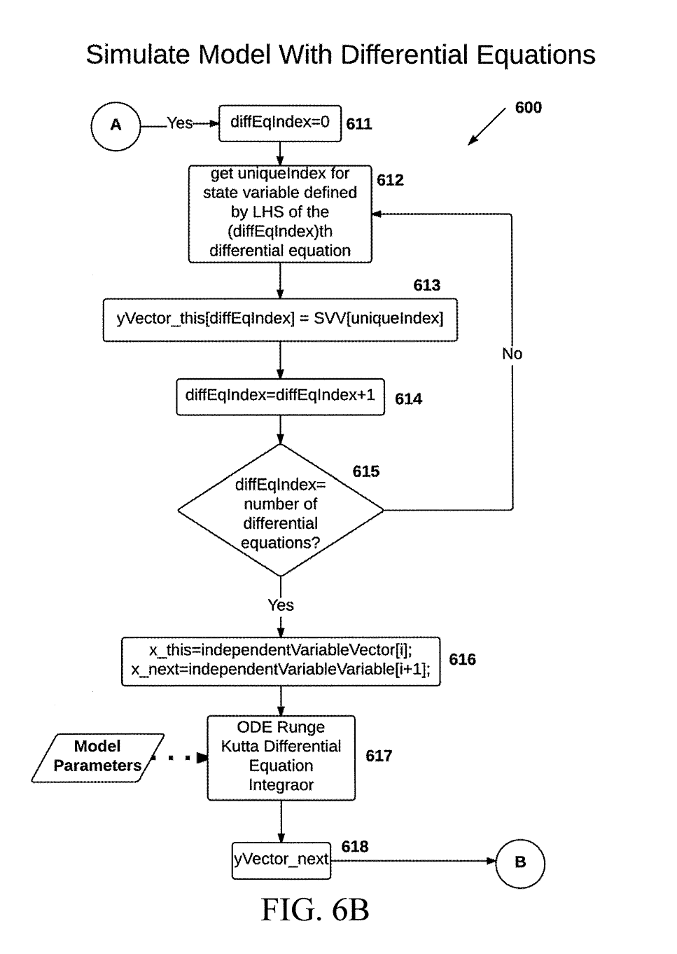

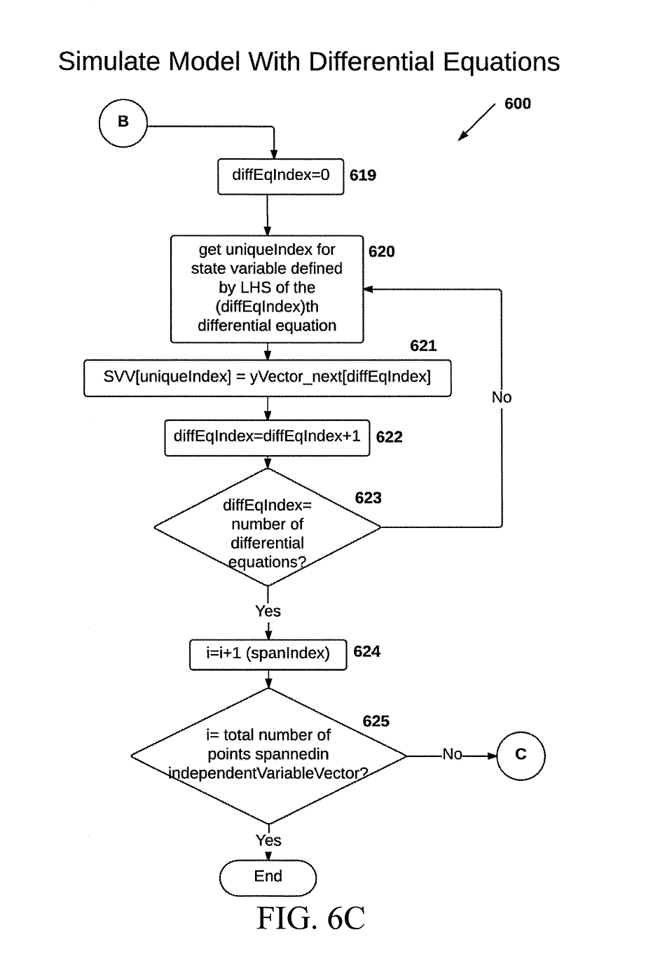

In some embodiments, the process 300 may include a step 306 of simulating the submitted mathematical model with differential equations. In some embodiments, the process 300 may proceed to the step 306 if the computer 210 determines in step 304 that the submitted mathematical model contains at least one differential equation. A non-limiting embodiment of the processing that may be performed in step 306 is described below with reference to FIGS. 6A-C.

In some embodiments, the process 300 may include a step 307 in which the computer 210 generates one or more graphs and/or one or more results. For instance, the computer 210 may generate a graph plotting the simulated model and the dataset. However, if only one of a model and a dataset is submitted in step 301, the computer 210 may generate a graph plotting only the simulated model or only the dataset. In some embodiments, the computer 210 may transmit the generated graphs and/or results to the remote device 104. In some embodiments, the generated graphs and/or results may be transmitted to the remote device 104 via the network interface 208 and the network 106. In some non-limiting embodiments, the remote device 104 may display the generated graphs and/or results to a user of the remote device 104 (e.g., via a user interface).

FIG. 4 is a flowchart illustrating a process 400 for validating the mathematical model and/or dataset according to some non-limiting embodiments. In some embodiments, the process 400 may be performed by the computer 210 during step 303 of the process 300 for simulating a mathematical model. In some embodiments, the process 400 may begin in step 401 with the computer 210 identifying the form (e.g., discrete, closed, or differential) of the equation(s) in the mathematical model. In some embodiments, the process 400 may include a step 402 in which the computer 210 identifies variables and parameters.

In some embodiments, the process 400 may include a step 403 in which the computer 210 validates equations and data. In some non-limiting embodiments, the step 403 may include validating for one or more of correct equation form, the identified variables and parameters, and matching data variables. For example, in some embodiments, the computer 210 may determine an equation that is missing a parenthesis (e.g., “y=(x+3”) to be invalid. For another example, in some embodiments, the computer 210 may determine a model invalid if it includes the equation “y=(x+3)” but x is undefined on a different line (as a state variable on the left hand side of another equation) or as an independent variable or parameter. For still another example, the computer 210 may detect if the variable z was defined as a state variable, and x was not and the user accidentally typed “y=(x+3)” instead of “y=(z+3)”.

In some embodiments, the process 400 may include a step 404 in which the computer 210 determines whether the mathematical model and/or dataset passed validation. If the mathematical model and/or dataset did not pass validation, the process 400 may proceed to a step 405 in which the computer 210 transmits the errors that prevented the mathematical model and/or dataset from passing validation to the remote device 104. In some embodiments, the errors may be transmitted to the remote device 104 via the network interface 208 and the network 106. In some non-limiting embodiments, the remote device 104 may display the errors to a user of the remote device 104 (e.g., via a user interface).

In some embodiments, the process 400 may include a step 406 in which the computer 210 submits a revised or different mathematical model and a dataset for validation. In some non-limiting embodiments, the computer 210 may receive an identification of a different mathematical model and/or dataset from the remote device 104. In some embodiments, the identification of the different mathematical model and/or dataset may be received from the remote device 104 via the network 106 and the network interface 208. In some embodiments, the identification of a different mathematical model may be a selection of a mathematical model 214 stored in database 212 or a mathematical model transmitted from remote device 104 (e.g., after being input by a user into the remote device 104). In some embodiments, the identification of the different dataset may be a selection of a dataset 216 stored in database 212 or a dataset transmitted from remote device 104 (e.g., after being input by a user into the remote device 104). In some embodiments, after submitting a revised or different mathematical model and a dataset for validation in step 406, the computer 210 may repeat steps 401-404 with the revised or different mathematical model and a dataset.

FIG. 34 is a flowchart illustrating a process 3400 for determining elements of an independent variable vector according to some embodiments. In some non-limiting embodiments, the computer 210 may execute process 3400 prior to executing the process 500 of simulating a model with no differential equation described below with reference to FIG. 5 or the process 600 of simulating a model with one or more differential equations described below with reference to FIGS. 6A-C. In some embodiments, the processes 500 and 600 may use independent variable vector generated by process 3400.

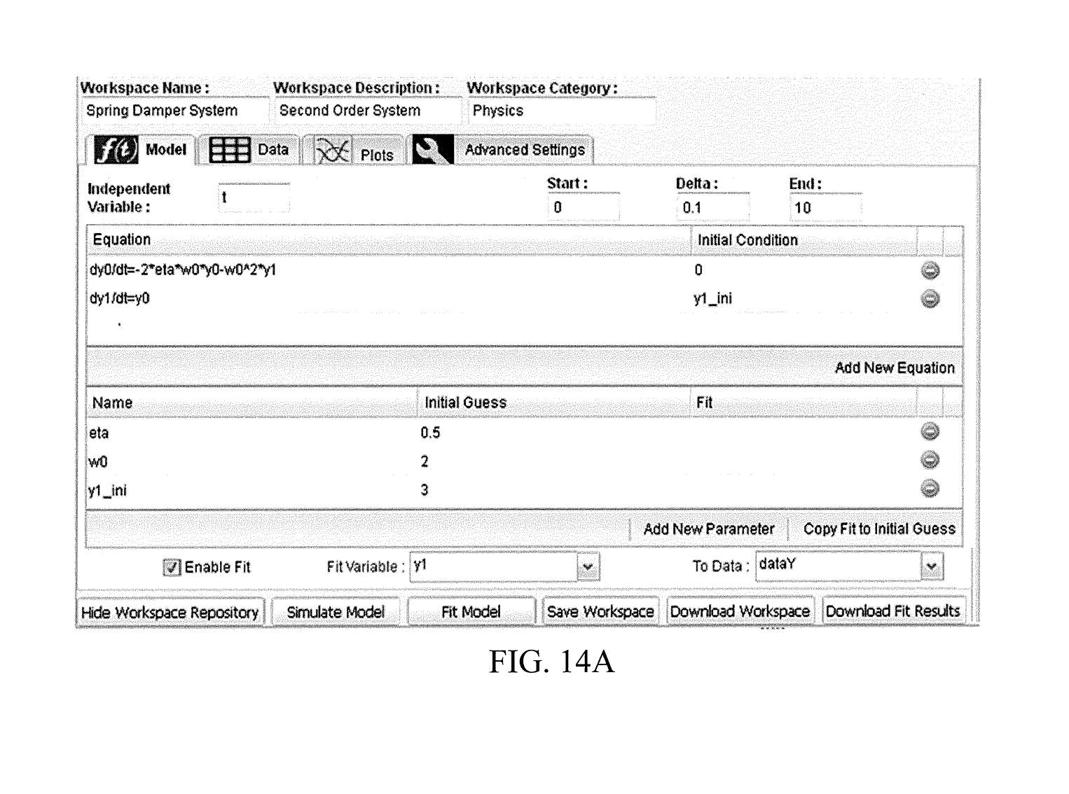

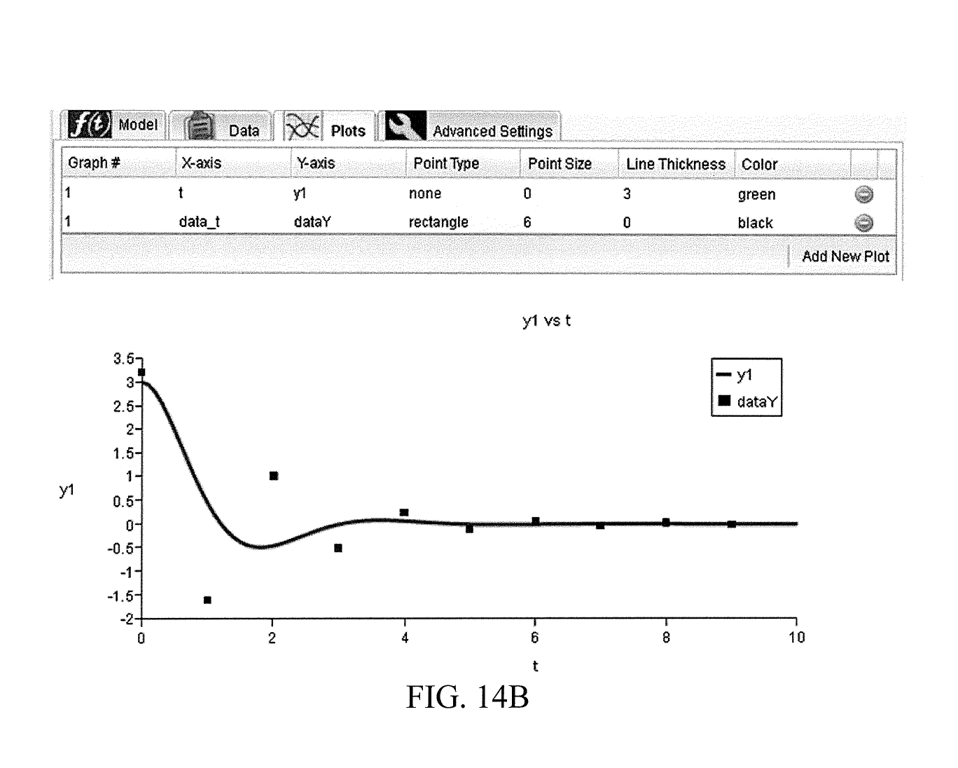

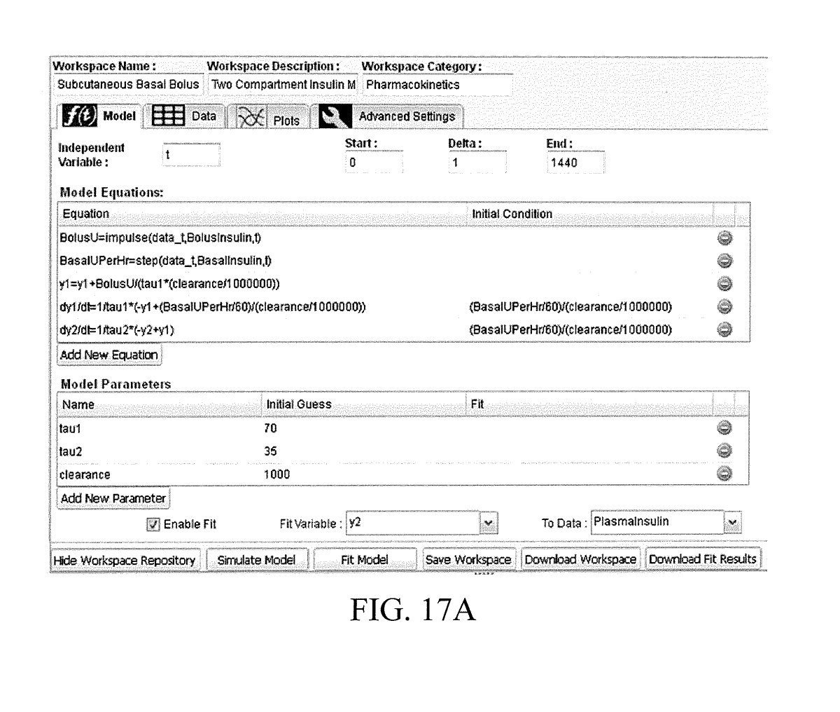

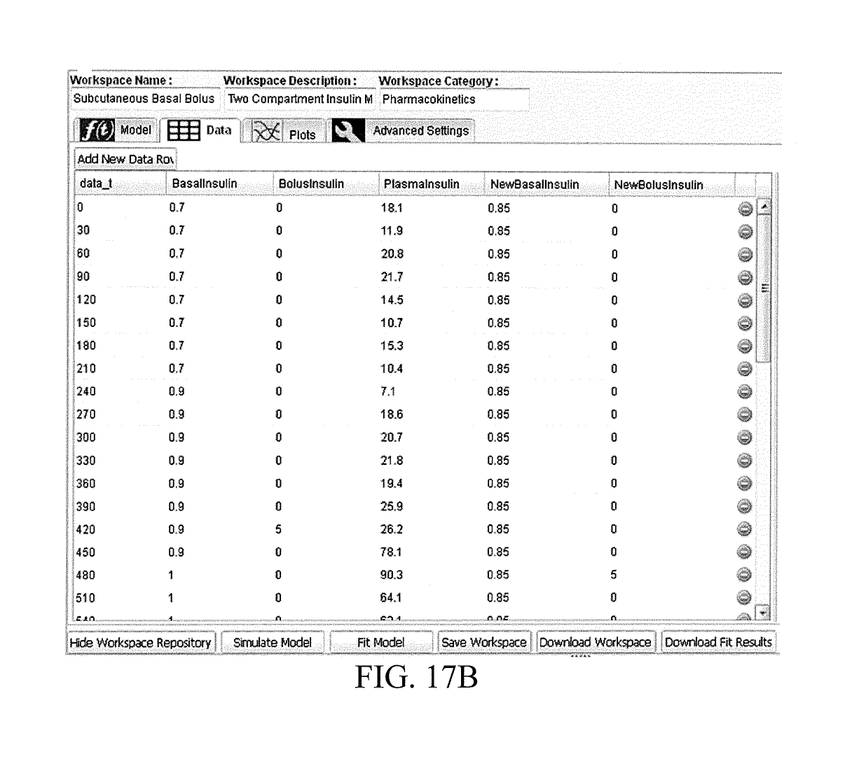

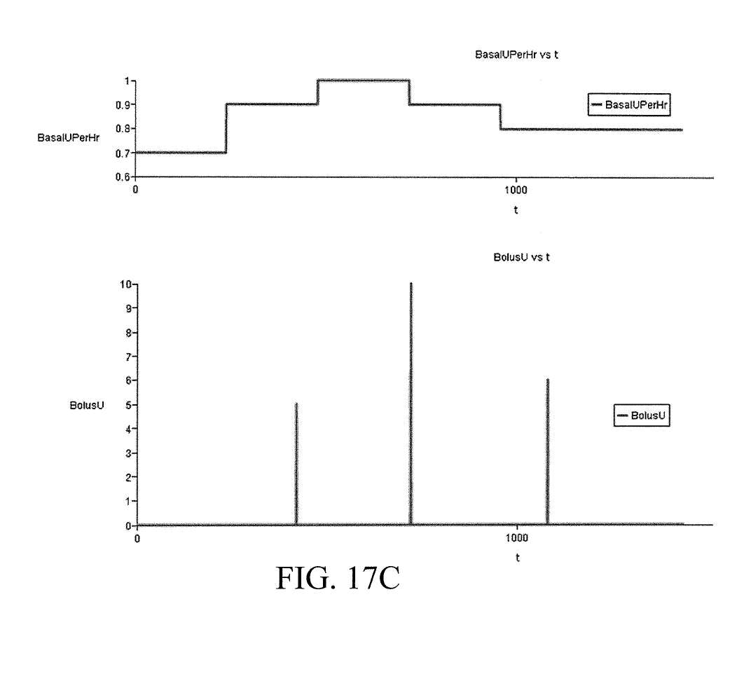

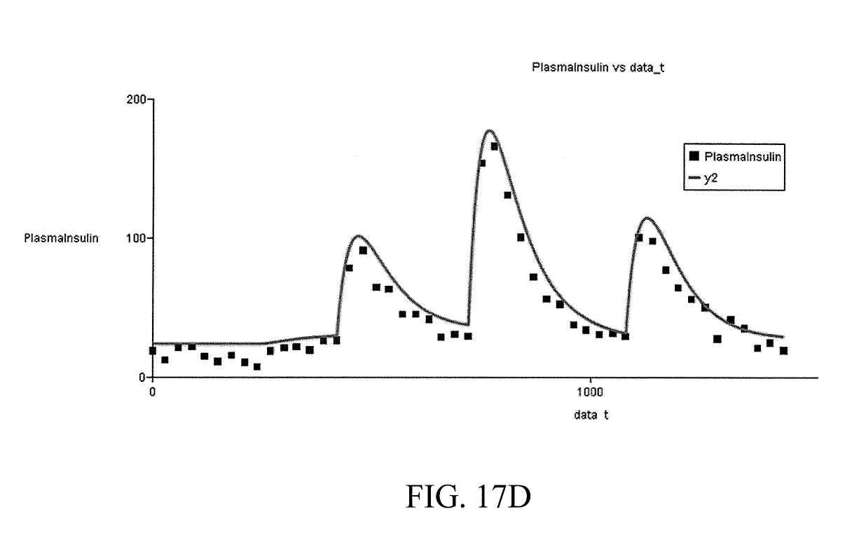

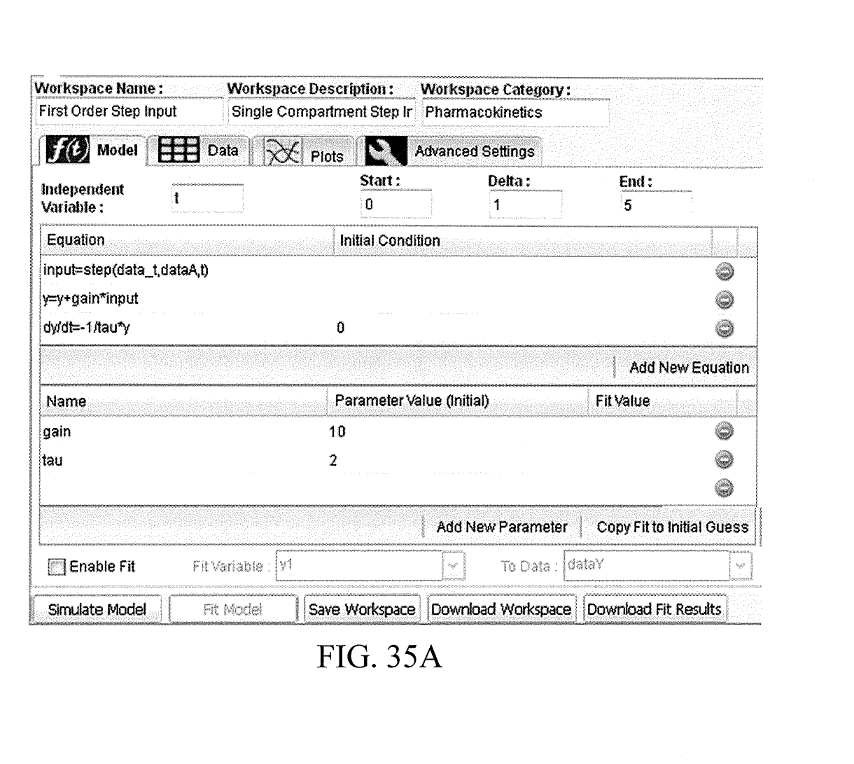

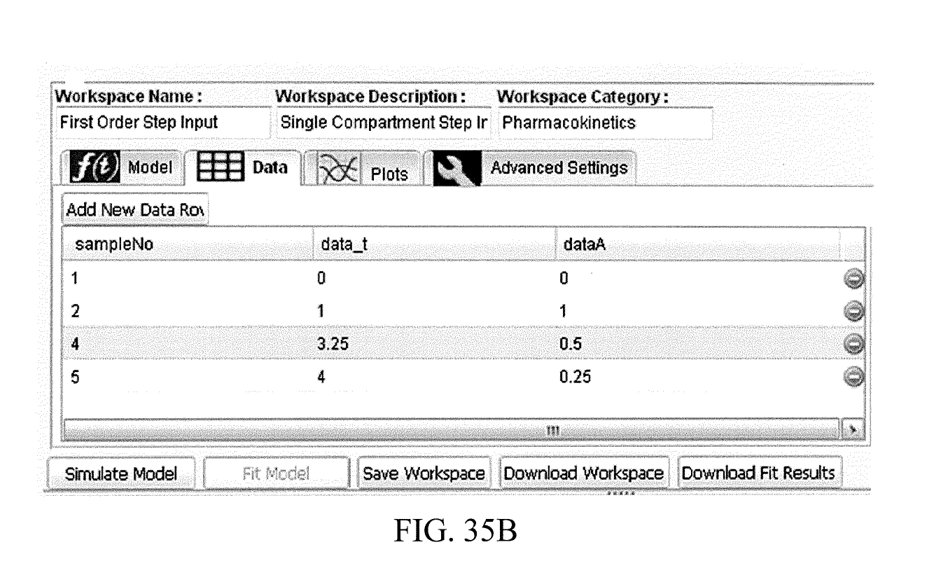

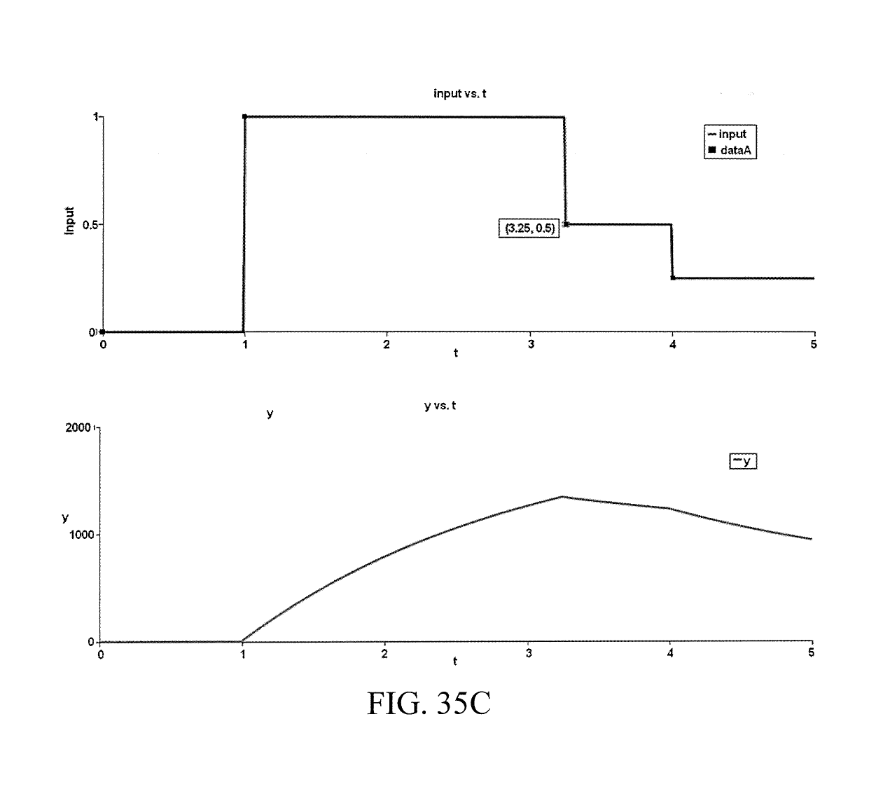

In some embodiments, the process 3400 may begin in step 3401 with the computer 210 receiving start, delta, and end values for an independent variable (e.g., from a remote device 104 via a model tab, such as that illustrated in any one of FIGS. 14A, 15A, 18A, 20A, 21A, 23A, 24A, 25-28, 30A, 31B, and 32B) and generating an Independent Variable array starting with the received start value, incrementing with the received delta value, and ending at the received end value. In some embodiments, the process 3400 may include a step 3402 in which the computer 210 receives an independent variable array of values (e.g., from a remote device 104 via a data table of inputs, which may be entered through a data tab, such as that shown in FIG. 17B) and merges sorted arrays and removes repeated values. In some embodiments, the process 3400 may include a step 3400 in which the computer 210 generates a new independentVariableVector array. In some embodiments, this may enable the proper handling of varying inputs to the model at arbitrary times listed in the data table even when the specified change in input does not happen at a value in the original independentVariableVector 3401 (e.g., time) defined by the “Start”, “Delta” and “End” values. For example, FIG. 35A illustrates a non-limiting example where “Start”, “Delta,” and “End” are 0, 1, and 5 seconds, respectively. Based on these values, the independentVariableVector “t” becomes [0, 1, 2, 3, 4, 5]. In some embodiments, simulated values for each state variable may be guaranteed at these time points. However, as illustrated in FIG. 35B, the data table under the “Data” tab may have an input “dataY” values at time “data_t” at times [0, 1, 3.25, 4]. In the non-limiting example, vectors “t” and “data_t” may be merged and sorted to form a new independentVariableVector of [0, 1, 2, 3, 3.25, 4, 5]. In conjuction with the equation “input=step(data_t,dataY,t),” this may guarantee input state variable returns a value for any time t required by the ODE solver, and the new independentVariableVector may guarantee proper handling of input data as well as output data. As noted above, in some embodiments, the processes 500 and 600 may use the generated independentVariableVector array.

FIG. 5 is a flowchart illustrating a process 500 for simulating a mathematical model that does not contain any differential equations and instead contains only closed form equations according to some non-limiting embodiments. In some embodiments, to simulate a mathematical system, the system may need to know the start and end point, and spacing (delta) of the simulation defined by the independent variable. The start, delta and endpoint may define the array of values that the independent variable spans. For example if the independent variable is “t” (time), the start value is 0, the delta value is 2, and the end value is 10, then the independent value array is [0,2,4,6,8,10], and a variable spanIndex i goes from 0 to 5. The value for each state variable may be computed at each of those time points and returned as an array of the same size.

In some embodiments, the process 500 may be performed by the computer 210 during step 305 of the process 300 for simulating a mathematical model. In some embodiments, the process 500 may begin in step 501 with the computer 210 initializing spanIndex i to zero. In some embodiments, the process 500 may include a step 502 in which the computer 210 determines whether the spanIndex i equals the number of elements in an independent variable vector.

In some embodiments, the process 500 may include a step 503 in which the computer 210 initializes an equationIndex j to zero. In some embodiments, the process 500 may proceed to step 503 if the computer 210 determines that the spanIndex i does not equal the number of elements in the independent variable vector. In some embodiments, the equationIndex j may be a variable that keeps track of the equation (of the mathematical model) being processed. In some embodiments, the process 500 may include a step 504 in which the computer 210 determines whether the equationIndex j equals the number of equations. In some embodiments, the process 500 may proceed to a step 505 if the computer 210 determines that the equationIndex j does not equal number of equations in the mathematical model or to a step 509 if the computer 210 determines that the equationIndex j is equal number of equations in the mathematical model.

In some embodiments, the process 500 may include a step 505 in which the computer 210 evaluates the right hand side (RHS) of the jth equation at the ith point. In some embodiments, the evaluation may be based on one or more parameters of the model. In some embodiments, the process 500 may include a step 506 in which the computer 210 assigns a value to SVM[i][equationIndex] for storage, where SVM stands for State Variable Matrix and is a two dimensional array of simulated values for each state variable at each spanIndex i (e.g., time point). The different rows may represent different spanIndices, and the different columns may represent the different stateVariables. SVM may contain simulated results of all state variables in the model.

In some embodiments, the process 500 may include a step 507 in which the computer 210 assigns a value to a workspace variable defined by the left hand side (LHS) of the jth equation for future evaluations. In other words, because equations may be interdependent, the computer 210 may store the current value (at the current spanIndex) of a state variable (defined in the left hand side of an equation) for use in other equations in the model simulation process 500.

In some embodiments, the process 500 may include a step 505 in which the computer 210 increments the equationIndex before returning to step 504.

In some embodiments, the process 500 may include a step 509 in which the computer 210 increments the spanIndex i before returning to step 502.

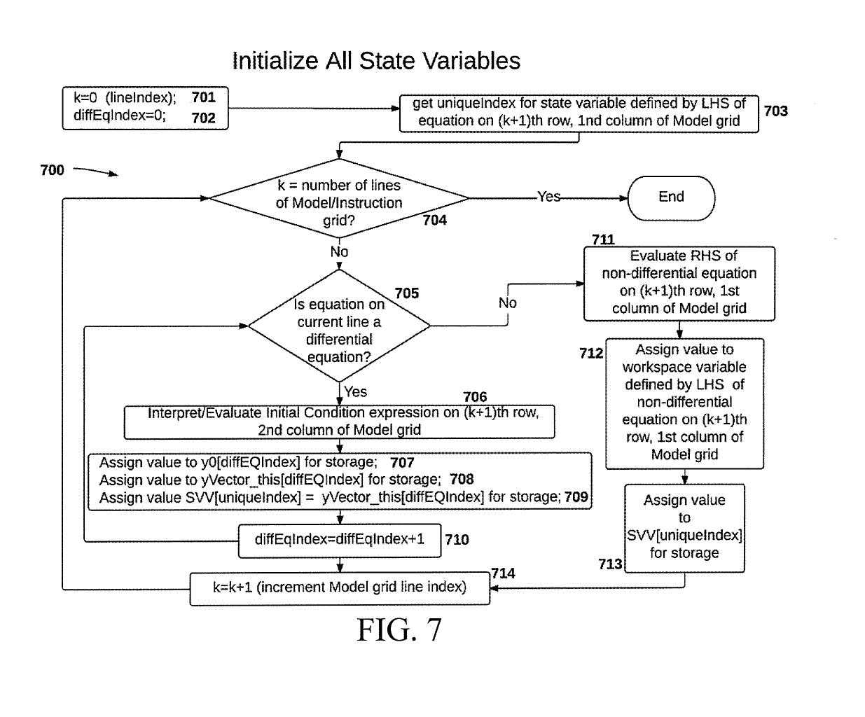

FIGS. 6A-C are a flowchart illustrating a process 600 for simulating a mathematical model that contains at least one differential equation according to some non-limiting embodiments. In some embodiments, the process 600 may be performed by the computer 210 during step 306 of the process 300 for simulating a mathematical model. In some embodiments, the process 600 may begin in step 601 with the computer 210 initializing all state variables. In some embodiments, the initialization of the state variables may be based on one or more parameters of the model. A non-limiting embodiment of the processing that may be performed in step 601 is described below with reference to FIG. 7.

In some embodiments, the process 600 may include a step 602 in which the computer 210 initializes a spanIndex i to zero. In some embodiments, the process 600 may include a step 603 in which the computer 210 initializes an equationIndex k to zero.

In some embodiments, the process 600 may include a step 604 in which the computer 210 determines whether the current kth equation is a differential equation. If the current kth equation is a differential equation, the process 600 may advance to step 608, but, if the current kth equation is not a differential equation.

In some embodiments, the process 600 may include a step 605 in which the computer 210 interprets (i.e., evaluates) the right hand side (RHS) of the non-differential equation on (k+1)th row as calcValue. In some embodiments, the evaluation may be based on one or more parameters of the model. In some non-limiting embodiments, the right hand side of each differential equation and closed form equation may be evaluated and stored in a StateVariableVector (SVV), which may be a one dimensional array of all state variables at the particular spanIndex during the simulation. For elements that correspond to differential equations (derivatives of state variables), the stored values may be the integrated value with respect to the independent variable. In some embodiments, SVV may change for each spanIndex (e.g., time point) of the simulation and may be available for an ordinary differential equation (ODE) solver to integrate the set of differential equations (e.g., in step 617).

In some embodiments, the process 600 may include a step 606 in which the computer 210 assigns a value to a workspace variable defined by the left hand side of the non-differential equation on the (k+1)th row of the model grid. In some embodiments, the process 600 may include a step 607 in which the computer 210 assigns a value to a current state variable vector SVV [uniqueIndex]=calcValue. In some embodiments, the process 600 may include a step 608 in which the computer 210 assigns a value to state variable matrix SVM[i][uniqueIndex]=SVV[uniqueIndex] for storage. In some non-limiting embodiments, the SVM may be a two dimensional state variable matrix or a two dimensional array of simulated values for each state variable at each spanIndex (e.g., time point). The different rows may represent different spanIndices, and the different columns may represent the different stateVariables. If the state variable is expressed as a differential equation (e.g., the “y” in “dy/dt”), then the stored value may be integrated with respect to the independent variable (e.g., “t”) at that particular spanIndex (e.g., point in time). SVV may be a particular row of SWM depending on the current spanIndex. In some embodiments, the process 600 may include a step 609 in which the computer 210 increments the equationIndex k.

In some embodiments, the process 600 may include a step 610 in which the computer 210 determines whether the equationIndex k equals the number of equations in the model. In some non-limiting embodiments, the equations of the model may be entered in a grid or table (e.g., as shown in FIG. 14A, where the top grid contains the model equations, and the bottom grid contains the set of parameters and their assigned values), and the number of model equations may be equal to the number of lines of the model/instruction grid. If the equationIndex k does not equal the number of equations in the model (e.g., the number of lines of the model/instruction grid), the process 600 may return to step 604. If the equationIndex k equals the number of equations in the model (e.g., the number of lines of the model/instruction grid), the process 600 may advance to step 611.

In some embodiments, the process 600 may include a step 611 in which the computer 210 initializes a diffEqIndex to zero. In some embodiments, the process 600 may include a step 612 in which the computer 210 gets a uniqueIndex for a state variable defined by the left had side (LHS) of the (diffEqIndex)th differential equation. In some embodiments, the process 600 may include a step 613 in which the computer 210 yVector_this[diffEqIndex] is set equal to the SVV[uniqueIndex] value. In some embodiments, yVector_this may be a subset of SVV containing integrated state variables whereby the left hand side is expressed as a derivative (e.g., “dy/dt”). yVector_this may be a one dimensional array of integrated variables at the current spanIndex (e.g., time), and yVector_next may be the one dimensional array of integrated variables at the next spanIndex (spanIndex+delta) solved by an ODE differential equation integrator in step 617.

In some embodiments, the process 600 may include a step 614 in which the computer 210 increments the diffEqIndex. In some embodiments, the process 600 may include a step 615 in which the computer 210 determines whether the diffEqIndex is equal to the number of differential equations. If the diffEqIndex is not equal to the number of differential equations, the process 600 may return to step 612. Otherwise, the process 600 may advance to step 616.

In some embodiments, the process 600 may include a step 616 in which the computer 210 sets x this equal to independentVariableVector[i] and sets x next equal to independentVariableVector[i+1]. In some embodiments, the process 600 may include a step 617 in which the computer 210 performs an ordinary differential equation (ODE) Runge Katta differential equation integration. In some embodiments, the integration may be based on one or more parameters of the model.

In some embodiments, the process 600 may include a step 618 in which the computer 210 performs yVector_next. In some embodiments, the process 600 may include a step 619 in which the computer 210 resets the diffEqIndex to zero. In some embodiments, the process 600 may include a step 620 in which the computer 210 gets uniqueIndex for the state variable defined by the left hand side (LHS) of the (diffEqIndex)th differential equation. In some embodiments, the process 600 may include a step 621 in which the computer 210 sets SVV[uniqueIndex] equal to yVector_next[diffEqIndex]. In some embodiments, the process 600 may include a step 622 in which the computer 210 increments diffEqIndex. In some embodiments, the process 600 may include a step 623 in which the computer 210 determines whether diffEqIndex equals the number of differential equations. If the diffEqIndex is not equal to the number of differential equations, the process 600 may return to step 620. Otherwise, the process 600 may advance to step 624.

In some embodiments, the process 600 may include a step 624 in which the computer 210 increments the spanIndex i. In some embodiments, the process 600 may include a step 625 in which the computer 210 determines whether the spanIndex i is equal to the total number of points spanned in the independentVariableVector. If the spanIndex i is equal to the total number of points spanned in the independentVariableVector, the process 600 may return to step 603. Otherwise, the process 600 may end. In other words, in some embodiments, when spanIndex has simulated the result for the end value of the independent variable (e.g., when the result for all state variables at the last time point has been calculated), the simulation process 500 may end.

FIG. 7 is a flowchart illustrating a process 700 for initializing all state variables (e.g., variables on the left hand side of the one or more equations of the model) according to some non-limiting embodiments. Variables may be interdependent (i.e., the initial condition for a state variable described as a function of another variable rather than a fixed numerical value), and the process 700 accounts for this possibility. In some embodiments, the process 700 may be performed by the computer 210 during step 601 of the process 600 for simulating a mathematical model that contains at least one differential equation. In some embodiments, the process 700 may begin in step 701 with the computer 210 initializing the lineIndex k to zero. In some embodiments, the process 700 may include a step 702 in which the computer 210 initializes the diffEqIndex to zero. In some embodiments, the process 700 may include a step 703 in which the computer 210 gets a uniqueIndex for a state variable defined by the left hand side of the equation on the (k+1)th row, 1st column of the model grid. However, it is not required that the uniqueIndex for a state variable be obtained from the 1st column of the model grid, and, in some alternative embodiments, the uniqueIndex may be obtained from a different location, such as, for example, a different column of the model grid, an uploaded file, or a data packet sent from a 3^{rd} party website.

In some embodiments, the process 700 may include a step 704 in which the computer 210 determines whether the lineIndex k is equal to the number of lines of model/instruction grid. If the lineIndex k is equal to the number of lines of model/instruction grid, the process 700 may end. Otherwise, the process 700 may advance to step 705.

In some embodiments, the process 700 may include a step 705 in which the computer 210 determines whether the equation on the current line is a differential equation. If the equation on the current line is a differential equation, the process 700 may advance to step 706. Otherwise, the process 700 may advance to step 711.

In some embodiments, the process 700 may include a step 706 in which the computer 210 interprets (i.e., evaluates) the initial condition expression on the (k+1)th row, second column of the model grid. In some embodiments, the process 700 may include a step 707 in which the computer 210 assigns a value to y0[diffEqIndex] for storage. In some embodiments, the process 700 may include a step 708 in which the computer 210 assigns a value to yVector_this[diffEqIndex] for storage. In some embodiments, the process 700 may include a step 709 in which the computer 210 assigns a value SVV[uniqueIndex] equal to yVector_this[diffEqIndex] for storage. In some embodiments, the process 700 may include a step 710 in which the computer 210 increments diffEqIndex.

In some embodiments, the process 700 may include a step 711 in which the computer 210 evaluates the right hand side of a non-differential equation on the (k+1)th row, 1st column of the model grid. In some embodiments, the process 700 may include a step 712 in which the computer 210 assigns a value to a workspace variable defined by the left hand side of the non-differential equation on the (k+1)th row, 1st column of the model grid. In some embodiments, the process 700 may include a step 713 in which the computer 210 assigns a value to SVV[uniqueIndex] for storage. In some embodiments, the process 700 may include a step 714 in which the computer 210 increments the model grid line index k.

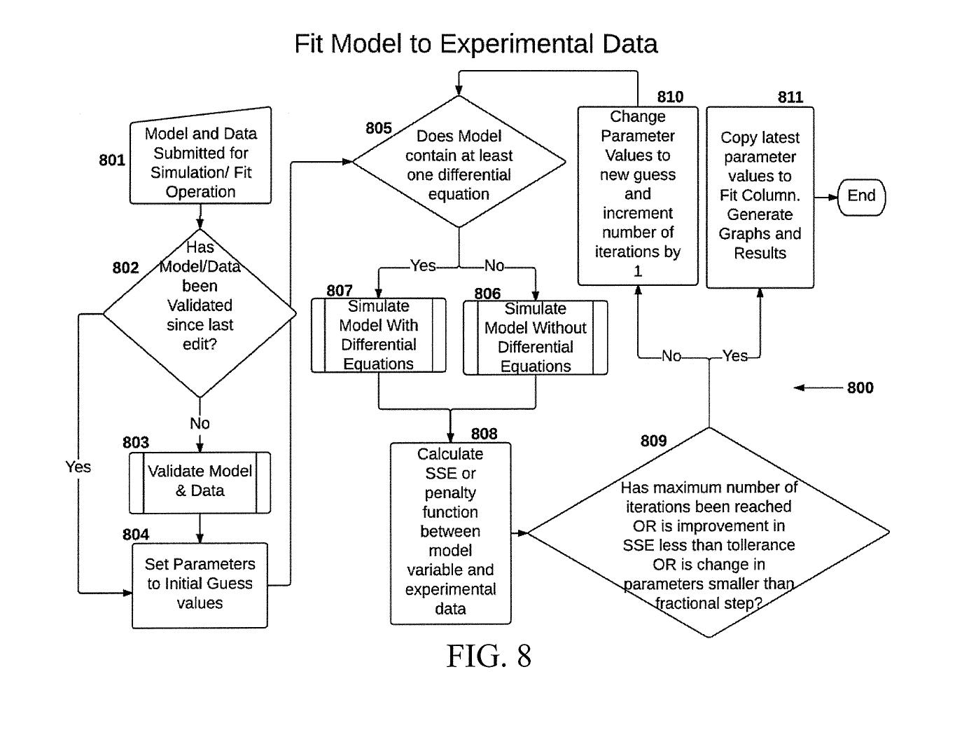

FIG. 8 is a flowchart illustrating a process 800 for fitting a model to experimental data according to some non-limiting embodiments. The fit operation process 800 illustrated in FIG. 8 is an iterative, non-linear least squares (regression) process. In some embodiments, the process 800 may begin in step 801 with the computer 210 submitting one or more of a mathematical model and a dataset for a fit operation. In some non-limiting embodiments, the computer 210 may receive an identification of the one or more of the mathematical model and the dataset for submission from the remote device 104. In some embodiments, the identification of one or more of a mathematical model and a dataset may be received from the remote device 104 via the network 106 and the network interface 208. In some embodiments, the identification of the mathematical model may be a selection of a mathematical model 214 stored in database 212 or a mathematical model transmitted from remote device 104 (e.g., after being input by a user into the remote device 104). In some embodiments, the identification of the dataset may be a selection of a dataset 216 stored in database 212 or a dataset transmitted from remote device 104 (e.g., after being input by a user into the remote device 104). In some embodiments, the remote device 104 may transmit the identification of the one or more of the mathematical model and the dataset for submission in response a user input received via a user interface (e.g., in response to a user clicking on a displayed “simulate model” button).

In some embodiments, the process 800 may include a step 802 in which the computer 210 determines whether the model and/or dataset submitted for the simulation operation has been validated (e.g., since the last edit of the model and/or dataset). In some embodiments, the process 800 may include a step 803 in which the computer 210 validates the submitted mathematical model and/or dataset. The process 800 may proceed to the validation step 803 if the computer 210 determines in step 802 that the model and/or dataset submitted for the simulation operation has not been validated. A non-limiting embodiment of the processing that may be performed in the validation step 803 is described above with reference to FIG. 4.

In some embodiments, the process 800 may include a step 804 in which the computer 210 sets parameters to initial guess values. In some embodiments, the process 800 may proceed to the step 804 if the submitted mathematical model and dataset passes validation in step 803. Likewise, if the computer 210 determines in step 802 that the submitted mathematical model and dataset has been validated, the process 800 may proceed to the step 804 of determining whether the submitted model contains at least one differential equation. In some non-limiting embodiments, the computer 210 may receive the initial guesses from the remote device 104. In some embodiments, the initial guesses may be received from the remote device 104 via the network 106 and the network interface 208.

In some embodiments, the process 800 may include a step 805 in which the computer 210 determines whether the submitted model contains at least one differential equation. In some embodiments, the process 800 may include a step 806 in which the computer 210 simulates the submitted mathematical model without differential equations. In some embodiments, the process 800 may proceed to the step 806 if the computer 210 determines in step 805 that the submitted model does not contain any differential equations. A non-limiting embodiment of the processing that may be performed in step 806 is described above with reference to FIG. 5.

In some embodiments, the process 800 may include a step 807 in which the computer 210 simulates the submitted mathematical model with differential equations. In some embodiments, the process 800 may proceed to the step 807 if the computer 210 determines in step 305 that the submitted mathematical model contains at least one differential equation. A non-limiting embodiment of the processing that may be performed in step 807 is described above with reference to FIG. 6.

In some embodiments, the process 800 may include a step 808 in which the computer 210 calculates Sum Squared Error (SSE) or other penalty function between the model variable and the experimental data. In some embodiments, the process 800 may proceed to the step 808 from either step 806 or step 807. In some embodiments, the process 800 may include a step 809 in which the computer 210 determines whether (a) the maximum number of iterations has been reached, (b) improvement in SSE (or other penalty function) is less than tolerance, or (c) change in parameters is smaller than the fractional step. If not, the process 800 may proceed to a step 810. Otherwise, the process 800 may proceed to a step 811.

In some embodiments, the process 800 may include a step 810 in which the computer 210 changes parameter values to one or more new guesses and increments the number of iterations by one. In some non-limiting embodiments, the processor 210 may iteratively change the parameter values following standard non-linear least squares algorithms, such as, for example and without limitation, the Nelder-Mead, Levenberg-Marquardt, or Gauss-Newton algorithms. In some non-limiting embodiments, the system 100 may provide the user of a remote device 104 (e.g., via a user interface) with the ability to individually set each of the one or more parameters of the one or more model equations of a mathematical model 214 as either (a) fixed to the initial guess or (b) allowed to vary during the non-linear least squares procedure. In these embodiments, the step 810 would only change a parameter value to a new guess if the parameter is allowed to vary. In some non-limiting embodiments, each parameter to be fit can be bounded to fall within a certain range or constrained to satisfy a particular expression. In these embodiments, the step 810 would only change a parameter value to a new guess that is within the certain range and/or satisfies the particular expression.

In some embodiments, the process 800 may include a step 811 in which the computer 210 copies the latest parameter values to the fit column and generates graphics and results. In some embodiments, the computer 210 may transmit the generated graphs and/or results to the remote device 104. In some embodiments, the generated graphs and/or results may be transmitted to the remote device 104 via the network interface 208 and the network 106. In some non-limiting embodiments, the remote device 104 may display the generated graphs and/or results to a user of the remote device 104 (e.g., via a user interface).

Although the fit operation process 800 illustrated in FIG. 8 is an iterative, non-linear least squares (regression) process, this is not required, and some alternative embodiments may use a different process for the fit operation. For example, in one non-limiting alternative embodiment, the fit operation process to solve for best fit parameters may have a closed form analytical linear solution through linear least squares (regression). One example is the equation of a line y=p₂*x+p₁, where the independent variable is x, the dependent state variable is y and p₂ (slope) and p₁ (intercept) are the parameters we wish to identify. Another example of an equation that can be fit via linear least squares is any polynomial equation expressed as: y=p₁+p₂*x^{̂2}+p₃*x^{̂3}+ . . . +pₙ*x^{̂n}. The fit line to experimental data points has an analytical solution whereby the SSE between experimental (x,y) points and modeled y (vertical distance to the line) is minimized. Any equation that can be expressed as

y=p₁+p₂*x₂+p₃*x₃+ . . . +pₙ*xₙ (1)

where x₂, x₃, . . . , xₙ are functions of one or more independent variables has a closed form analytical solution that gives us fit parameters p₁, p₂, . . . , pₙ. If there are m sets of y experimental data points and (x₂, x₃, . . . , xₙ) values, the parameters (p₁, p₂, . . . , pₙ) can be solved with matrix algebra. In matrix form, the equation above is represented as:

$$y = X * P where X = [ 1 {x}_{2} {x}_{3} … {x}_{n} ] and P = [ \begin{matrix}{p}_{1} \\ {p}_{2} \\ {p}_{3} \\ ⋮ \\ {p}_{n}\end{matrix} ] \qquad ( 2 )$$

With a stack of m y values and m sets of (x₂, x₃, . . . , xₙ) values, this is expanded to:

$$[ \begin{matrix}{y}_{1} \\ {y}_{2} \\ {y}_{3} \\ ⋮ \\ {y}_{m}\end{matrix} ] = [ \begin{matrix}1 & {x}_{12} & {x}_{13} & … & {x}_{1 n} \\ 1 & {x}_{22} & {x}_{23} & … & {x}_{2 n} \\ 1 & {x}_{32} & {x}_{33} & … & {x}_{3 n} \\ ⋮ & ⋮ & ⋮ & ⋱ & ⋮ \\ 1 & {x}_{m 2} & {x}_{m 3} & … & {x}_{mn}\end{matrix} ] * [ \begin{matrix}{p}_{1} \\ {p}_{2} \\ {p}_{3} \\ ⋮ \\ {p}_{n}\end{matrix} ] or {Y}_{S} = {X}_{S} * P \qquad ( 3 )$$

As long as m≧n, then the closed form solution for the set of parameters, P exists where the SSE between modeled y values and experimental y values is minimized (no iteration required). The solution is given by the matrix equation where the T superscript denotes matrix transpose:

P=X_{S}^{T}*X_{S}*X_{S}^{T}*Y (4)

In some embodiments, in performing a fit operation process, the computer 210 may evaluate whether to use linear least squares or nonlinear least squares to obtain the optimal set of model parameters by evaluating the form of the model equation (takes the form of eq # or not). Linear least squares may not require an initial guess for each parameter because an analytical solution exists.

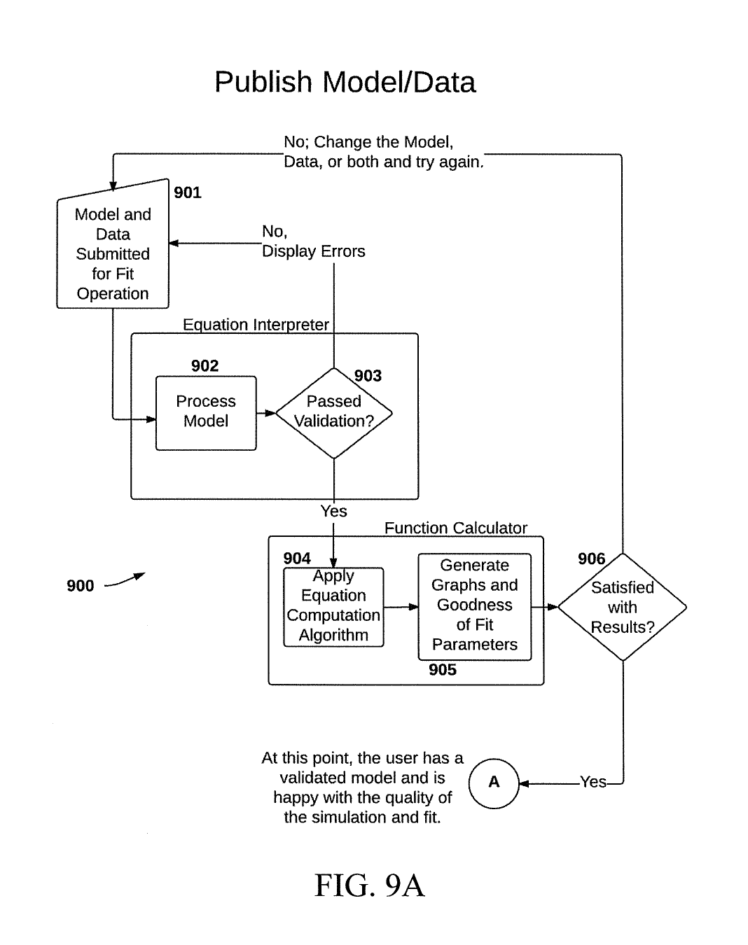

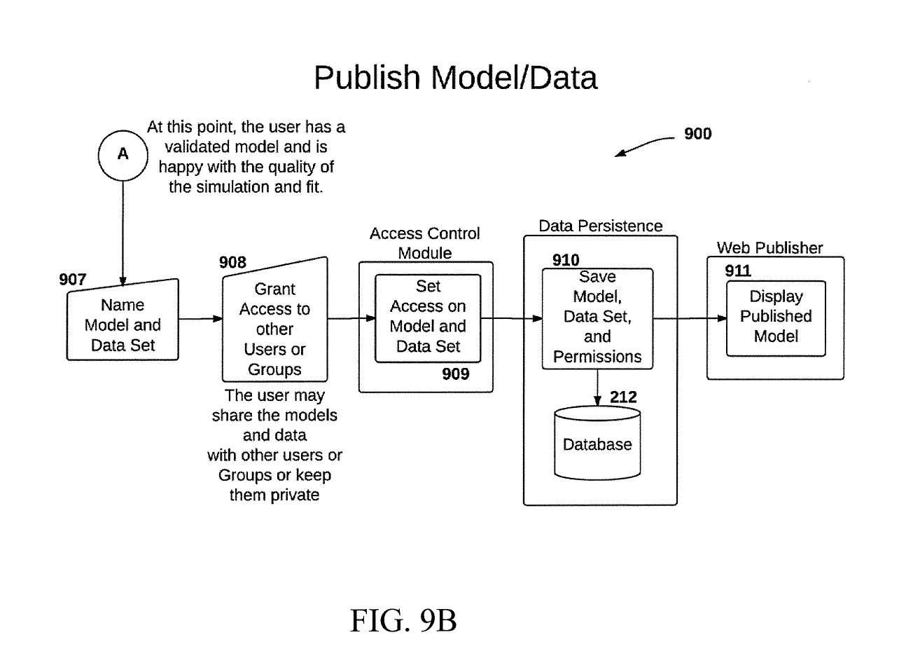

FIGS. 9A-B are a flowchart illustrating a process 900 for publishing model and/or dataset according to some non-limiting embodiments. The process 900 may enable a user to publish a model and dataset to be made available to the user for later use, to a select group of colleagues, or to the entire public. In some embodiments, the process 900 may begin in step 901 with the computer 210 submitting one or more of a mathematical model and a dataset for a fit operation. In some embodiments, the process 900 may include a step 902 in which the computer 210 performs validation processing, which may correspond to steps 401-403 of validation process 400 described above with reference to FIG. 4. In some embodiments, the process 900 may include a step 903 in which the computer 210 determines whether the model and/or dataset passed validation. In some non-limiting embodiments, step 903 may correspond to steps 404 and/or 405 of validation process 400 described above with reference to FIG. 4.

In some embodiments, the process 900 may include a step 904 in which the computer 210 applies an equation computation algorithm. In some non-limiting embodiments, step 904 may correspond to steps 804-809 of fit operation processing 800 described above with reference to FIG. 8. In some embodiments, the process 900 may include a step 908 in which the computer 210 generates graphs and goodness of fit parameters. In some non-limiting embodiments, step 905 may correspond to step 811 of fit operation processing 800 described above with reference to FIG. 8.

In some embodiments, the process 900 may include a step 906 in which the computer 210 determines whether the user is satisfied with the results. In some embodiments, the computer 210 may receive an indication as to whether the user is satisfied with the results from the remote device 104. If the computer 210 determines whether the user is not satisfied with the results, the process 900 may return to step 901, where the computer 210 may submit a different model and dataset for a fit operation. If the computer 210 determines whether the user is not satisfied with the results, the process 900 may proceed to step 907.

In some embodiments, the process 900 may include a step 907 in which the computer 210 names the model and data set. In some non-limiting embodiments, the computer 210 may receive a user-specified name for the model and dataset from the remote device 104. In some embodiments, the process 900 may include steps 908 and 909 in which the computer 210 grants or denies access to other users or groups and sets the access permissions for the model and data set. In some non-limiting embodiments, the computer 210 may grant or deny access based on an indication of any persons and/or groups to be allowed access from the remote device 104. Accordingly, in some non-limiting embodiments, the user may be able to share one or more models and data with one or more other users and/or groups or keep the models and data private. In some embodiments, the process 900 may include a step 910 in which the computer 210 saves one or more of the model, data set, and permissions in the database 212 (e.g., as models 214, datasets 216, and/or permissions 218) and/or in another database.

In some embodiments, the process 900 may include a web publisher step 911 in which the computer 210 may make published models and datasets available for display (e.g., on one or more remote devices 104).

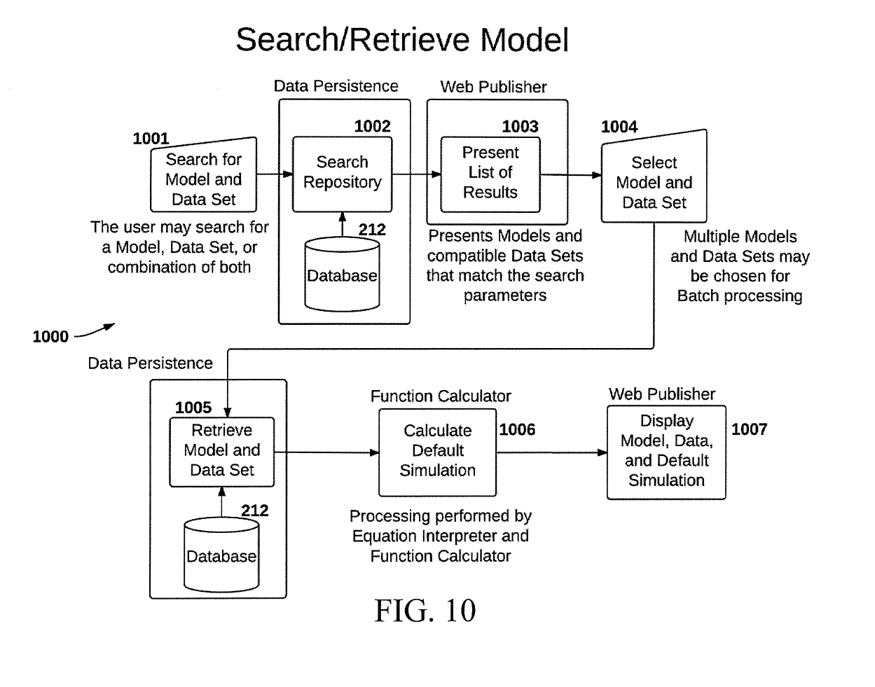

FIG. 10 is a flowchart illustrating a process 1000 for searching and/or retrieving models and/or datasets according to some non-limiting embodiments. In some embodiments, the process 900 may begin in step 1001 with the computer 210 receiving a search for one of more of a model and a dataset. In some non-limiting embodiments, the computer 210 may receive search terms from a remote device 104. In some embodiments, the process 1000 may include a step 1002 in which the computer 210 searches the repository (e.g., the models 214 and/or datasets 216 in the database 212) for models and/or datasets based on the received search. In some embodiments, the process 1000 may include a step 1003 of presenting a list of results (i.e., a list of models and/or datasets that match the received search parameters).

In some embodiments, the process 1000 may include a step 1004 in which the computer 210 receives a selection of a model and/or dataset (e.g., from a remote device 104). In some embodiments, multiple models and datasets may be selected for batch processing. In some embodiments, the process 1000 may include a step 1005 in which the computer 210 retrieves the selected model(s) and/or dataset(s) from the repository. In some embodiments, the process 1000 may include a step 1006 in which the computer 210 calculates a default simulation based on the retrieved model(s) and/or dataset(s). In some non-limiting embodiments, the default simulation may include steps corresponding to steps 301-307 of model simulation process 300 described above with reference to FIG. 3 or steps 801-811 of fit operation process 800 described above with reference to FIG. 8. In some embodiments, the process 1000 may include a step 1007 in which the computer 210 transmits the generated model data (e.g., one or more graphs) and/or the results of the default simulation to one or more remote devices 104. In some embodiments, the model data and/or the results may be transmitted to the remote device 104 via the network interface 208 and the network 106. In some non-limiting embodiments, one or more of the remote devices 104 may display the model data and/or the results to a user of the remote device 104 (e.g., via a user interface).

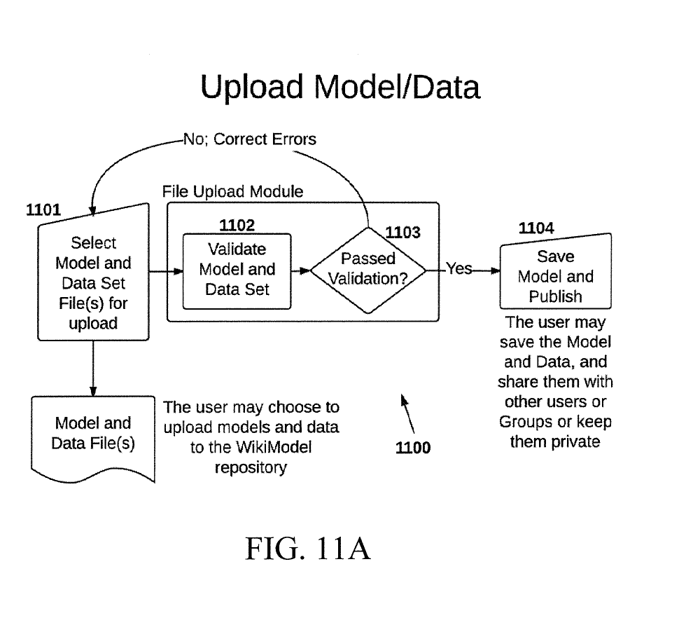

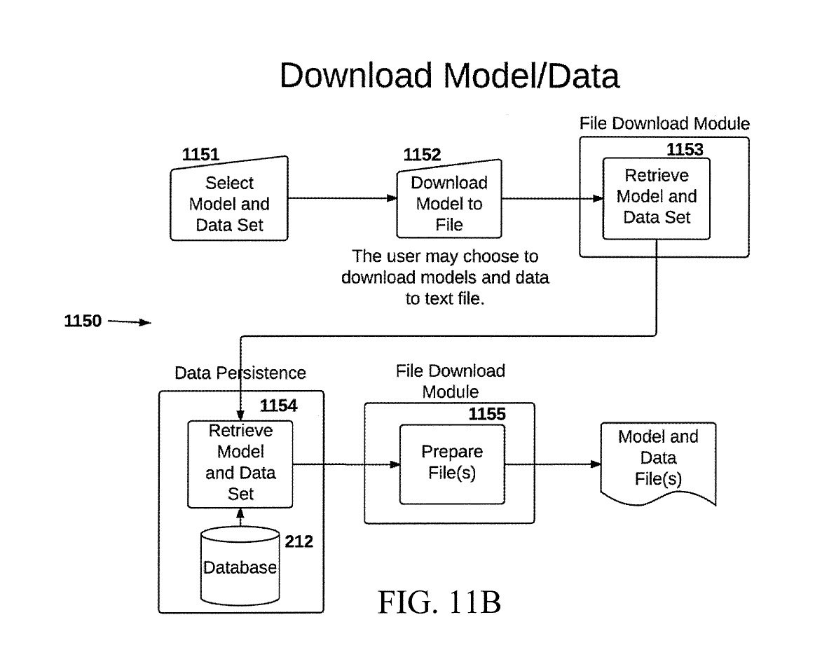

FIGS. 11A and 11B are flowcharts illustrating non-limiting embodiments of processes that enable a user upload or download one or more models and/or one or more datasets from or to multiple formats and sources. Uploading and downloading models and data may facilitate collaboration. In some embodiments, the system 100 may support uploading from and/or downloading to one or more file formats (e.g., text, XML, Excel Spreadsheet, etc) for users to upload and download data. In some non-limiting embodiments, the system may support integration with Dropbox, Google Drive, and/or similar services for easier upload and download.

FIG. 11A is a flowchart illustrating a process 1100 for uploading one or more models and/or one or more datasets according to some non-limiting embodiments. In some embodiments, the process 1100 may begin in step 1101 with the computer 210 receiving one or more model and dataset files from a remote device 104 (e.g., via the network 106 and the network interface 208). In some embodiments, the process 900 may include a step 1102 in which the computer 210 performs validation processing, which may correspond to steps 401-403 of validation process 400 described above with reference to FIG. 4, on the model(s) and/or dataset(s) uploaded/received from the remote device 104. In some embodiments, the process 1100 may include a step 1103 in which the computer 210 determines whether the model(s) and/or dataset(s) passed validation. In some non-limiting embodiments, step 1103 may correspond to steps 404 and/or 405 of validation process 400 described above with reference to FIG. 4. In some embodiments, the process 1100 may include a step 1104 in which the computer 210 saves the model(s) and/or dataset(s) to the repository (e.g., database 212) and/or publishes the model(s) and/or dataset(s). In some non-limiting embodiments, step 1104 may correspond to one or more of steps 907-911 of the publication process 900 described above with reference to FIGS. 9A-B. In some embodiments, users need not upload an entire model and its data (e.g., a user may upload just a model or just a dataset). For example, the user may want to upload only data and associate it to a model that already exists in the repository. This is often the case when a scientist wants to test another user's model with their own experimental data.

FIG. 11B is a flowchart illustrating a process 1150 for downloading one or more models and/or one or more datasets according to some non-limiting embodiments. In some embodiments, the process 1150 may include steps 1151, 1152, 1153, and 1154 in which the computer 210 receives a selection of one or more models and/or one or more datasets and retrieves the selected model(s) and/or dataset(s). In some non-limiting embodiments, steps 1151, 1152, 1153, and 1154 may correspond to one or more of steps 1004 and 1005 of search and retrieval process 1000 described above with reference to FIG. 10. In some embodiments, the process 1150 may include a step 1155 in which the computer 210 prepares the retrieved file(s) for download. In some non-limiting embodiments, the step 1155 may include the computer 1155 transmitting the retrieved file(s) (i.e., model(s) and/or dataset(s)) to one or more remote devices 104.

In some non-limiting embodiments, an independent variable and the “Start”, “Delta” and “End” that define its range and increment can be entered into the Graphical User Interface or uploaded from/downloaded to a text file, excel file, XML file or other formats. In some non-limiting embodiments, model equations can be entered into a table within a Graphical User Interface or uploaded from or downloaded to a text file, excel file, XML file or other formats. In some non-limiting embodiments, parameters and constant values assigned to them can be entered into a separate table within the Graphical User Interface or uploaded from/downloaded to a text file, excel file, XML file or other formats. In some non-limiting embodiments, datasets (e.g., tables), which may include inputs to the model and/or experimental data, can be entered into a separate table (e.g., under the “Data” tab) within the Graphical User Interface or uploaded from/downloaded to a text file, excel file, XML file or other formats. In some non-limiting embodiments, the header of a data column may be used as an input variable name accessed by the model. In some non-limiting embodiments, variables to a plot (e.g., x,y) and/or plotting properties can be entered into a separate table (e.g., under a “Plots” tab) within the Graphical User Interface or uploaded from/downloaded to a text file, excel file, XML file or other formats. In some non-limiting embodiments, the header of a data column may be used as input variable name accessed by the model. In some non-limiting embodiments, all or a portion of the information entered into the GUI and/or downloaded/uploaded may be grouped together into a single workspace file. In some non-limiting embodiments, the single workspace file may contain the model equations, parameters, datasets, plot options, fitting options, and/or other advanced settings that can be uploaded/downloaded.

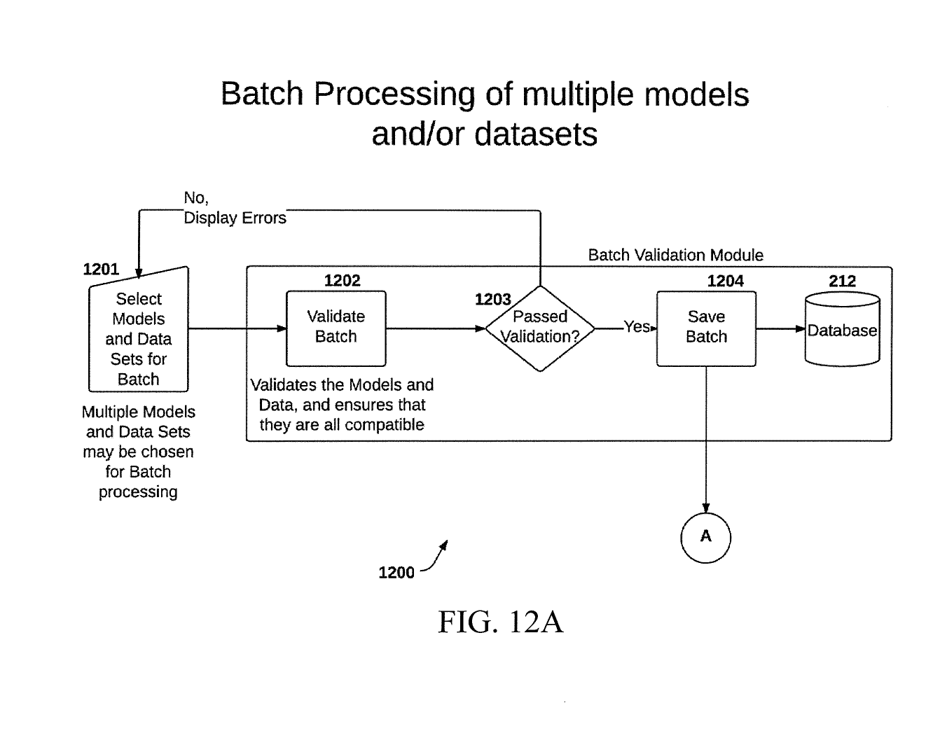

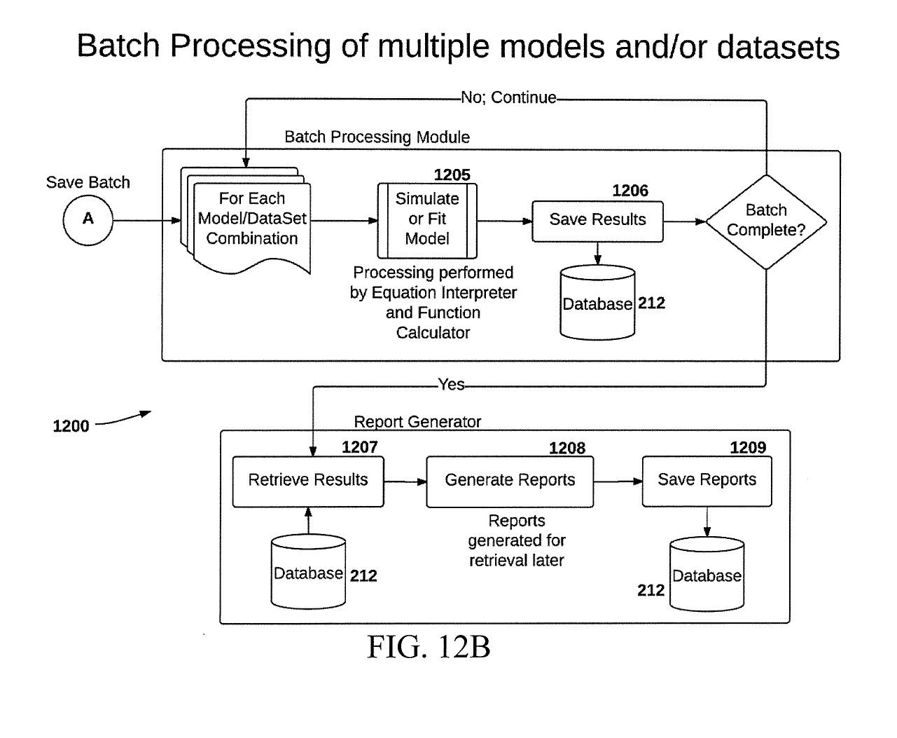

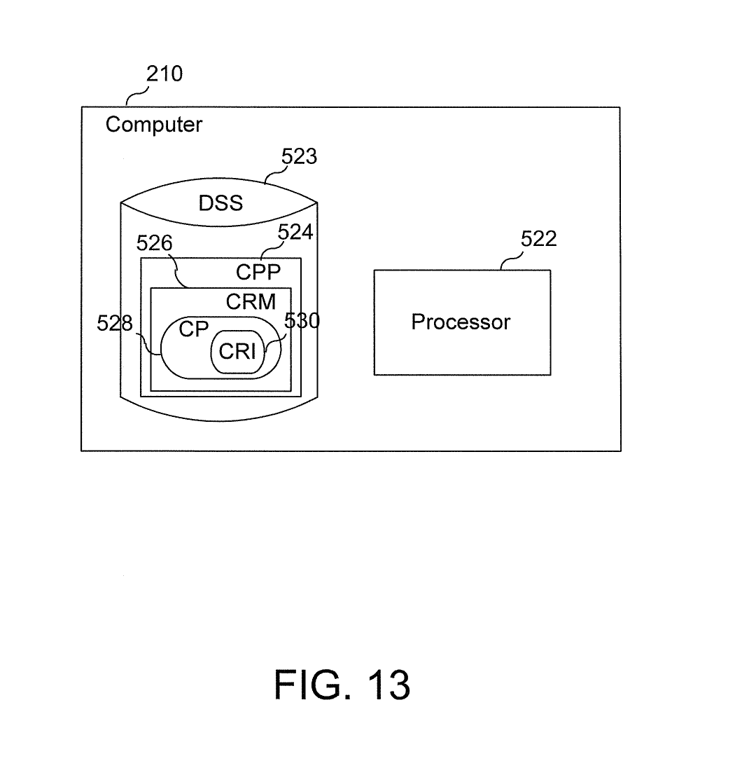

In some embodiments, a user can batch fit one model to multiple datasets and/or one dataset to multiple models to determine which one best represents the experimental data. In some embodiments, distributed processing (e.g., using map-reduce or other means) may be used to perform the processing on multiple processors (e.g., in the cloud). This may speed processing times for large batch computations. FIGS. 12A-B are a flowchart illustrating a process 1200 for batch processing of multiple models and/or datasets according to some non-limiting embodiments. The batch process 1200 may fit one model to multiple data sets and/or fit multiple datasets to one model. In some embodiments, the process 1200 may begin in step 1201 with the computer 210 receiving a selection of multiple models and datasets from a remote device 104 (e.g., via the network 106 and the network interface 208). In some embodiments, the process 1200 may include a step 1202 in which the computer 210 performs validation processing to validate that the selected models and datasets and/or ensure that they are compatible. In some non-limiting embodiments, the processing of step 1202 may correspond to steps 401-403 of validation process 400 described above with reference to FIG. 4. In some embodiments, the process 1200 may include a step 1203 in which the computer 210 determines whether the models and datasets passed validation. In some non-limiting embodiments, step 1203 may correspond to steps 404 and/or 405 of validation process 400 described above with reference to FIG. 4. In some embodiments, the process 1200 may include a step 1204 in which the computer 210 saves the models and datasets to the repository (e.g., database 212). In some non-limiting embodiments, step 1204 may correspond to step 910 of publication process 900 described above with reference to FIGS. 9A-B.

In some embodiments, the process 1200 may include, for each model/dataset combination, a step 1205 in which the computer 210 performs a model simulation or fit operation and a step 1206 in which the computer 210 saves the results of the model simulation or fit operation in the repository (e.g., database 212). In some non-limiting embodiments, step 1205 may correspond to steps 304-307 of model simulation process 300 described above with reference to FIG. 3 or steps 804-811 of fit operation process 800 described above with reference to FIG. 8. In some embodiments, the process 1200 may include a step 1207 in which the computer 210 retrieves the results from the repository, a step 1208 in which the computer 210 generates reports based on the retrieved results of the batch processing, and/or a step 1209 of saving the reports to the repository (e.g., database 212). In some embodiments, in step 1208, the computer 210 may generate statistics comparing the degree to which a two or more models fit the same dataset. For example, in some non-limiting embodiments, the computer 210 may perform an F-test that compares the SSEs of the two or more models relative to the same experimental data taking into consideration the number of parameters (i.e., flexibility) in each model. If a model with more fit parameters yields a lower SSE than a model with less parameters, the F-test may generate a p-value that determines whether the improvement (reduction in SSE) is significant given its added flexibility of the difference in number of fit parameters.

FIG. 13 is a block diagram of a non-limiting embodiment of the computer 210 of the mathematical model analysis computer system 102. As shown in FIG. 5, the computer 210 may include one or more processors 522 (e.g., a general purpose microprocessor) and/or one or more circuits, such as an application specific integrated circuit (ASIC), field-programmable gate arrays (FPGAs), a logic circuit, and the like. In some embodiments, the computer 210 may include a data storage system (DSS) 523. The DSS 523 may include one or more non-volatile storage devices and/or one or more volatile storage devices (e.g., random access memory (RAM)). In embodiments where the computer 210 includes a processor 522, the DSS 523 may include a computer program product (CPP) 524. CPP 524 may include or be a computer readable medium (CRM) 526. The CRM 526 may store a computer program (CP) 528 comprising computer readable instructions (CRI) 530. CRM 526 may be a non-transitory computer readable medium, such as, but not limited, to magnetic media (e.g., a hard disk), optical media (e.g., a DVD), solid state devices (e.g., random access memory (RAM) or flash memory), and the like. In some embodiments, the CRI 530 of computer program 528 may be configured such that when executed by processor 522, the CRI 530 causes the computer 210 to perform one or more of the steps described above (e.g., steps described above with reference to the flowcharts shown in FIGS. 3-12 or below with reference to the flowchart shown in FIG. 34). In other embodiments, the computer 210 may be configured to perform steps described herein without the need for a computer program. That is, for example, the computer 210 may consist merely of one or more ASICs. Hence, the features of the embodiments described herein may be implemented in hardware and/or software.

In some embodiments, the mathematical model analysis computer system 102 may ease the creation and analysis of complex mathematical models. In some embodiments, the mathematical model analysis computer system 102 may enable the created models to be shared easily with others. For example, a scientist who has hypothesized a mathematical model describing some physical phenomena may use the mathematical model analysis computer system 102 to replicate the hypothesized model in simulation. Experimental data from different systems or individuals may follow the same model, but may have different parameters or constants. The scientist (e.g., operating a remote device 104) may use an embodiment of the mathematical model analysis computer system 102 to identify the parameters for a unique system or individual by fitting the model to each dataset. Subsequently, the scientist may use the model to simulate what would happen under different input conditions before implementing changes. In some non-limiting embodiments, the scientist may use the mathematical model analysis computer system 102 to publish the model and its data. Others may use the mathematical model analysis computer system 102 to access the published model and run their own analysis on it, making refinements and testing it with their own experimental data or set of inputs.

In some embodiments, the system 100 may eliminate the need for the scientist to program mathematical models for model analysis. In some embodiments, the scientist may use a remote device 104 to enter the equations representing the model and enter the experimental data, and the mathematical model analysis computer system 102 will perform the necessary mathematical analysis. In some embodiments, the scientist may use the system 100 to tweak the model if it does not fit the data well. For example, in some non-limiting embodiments, the scientist may add or eliminate data points (outliers) depending on how well the model performs. In such cases, the scientist's remote device 104 may receive results from mathematical model analysis computer system 102 in a matter of seconds or minutes rather than the days or weeks often required when manual programming is required to make the changes. In some embodiments, the model is described in mathematical terms (as opposed to a programming language) so the expression language is familiar to the scientist, and great efficiencies can be realized.

In some embodiments, the system 100 may be web-based so that the mathematical model analysis computer system 102 is accessible from multiple platforms and devices (e.g., remote devices 104). In some non-limiting embodiments, the system 100 may require no installation of software (e.g., including “run time engines” such as, for example, Adobe's Flash Player, Java's Runtime Engine, and Wolfram's Computable Document Format (CDF) Player, which may not run on all operating systems and internet accessible devices) on a remote device 104. In some embodiments, the system 100 may provide a graphical user interface (GUI) for display on a remote device 104, and, in some non-limiting embodiments, the GUI may run on base technology built into all modern web browsers. Some non-limiting examples of remote devices 104 accessing the mathematical model analysis computer system 102 may include a Dell personal computer (PC) with a FireFox web browser on a Windows XP operating system (OS), an Apple MacBook with a Safari web browser on a Mac OS X 10.5.8, an Apple MacBook Pro with a Safari web browser on a Mac OS X 10.8.2, an Apple iPhone smart phone with a Safari web browser on an iOS, a Samsung Galaxy S3 smart phone with a Chrome web browser on an Android OS, an Apple iPad tablet with a Safari web browser on an iOS, and a Samsung Galaxy tablet with a web browser on an Android OS.

In some non-limiting embodiments, the mathematical model analysis computer system 102 may be hosted in the cloud (e.g., in a heavily redundant, replicated, and load-balanced cluster of servers and networking infrastructure ensuring maximum availability and minimal risk of data loss). Many mathematical models capable of being analyzed by the mathematical model analysis computer system 102 require a fair amount of computing power to analyze properly. A fair deal of storage may be required for the experimental data. In embodiments where the mathematical model analysis computer system 102 is hosted in the cloud, the cloud may provide ample storage and computing (possibly distributed), and absolves the user from having to maintain hardware. In some embodiments, the system 100 may include one or more cloud based remote servers that may be used to perform computational analysis. In some non-limiting embodiments, the runtime of the computational analsysis may be accelerated relative to the runtime of installed software on a single local machine as the computational load may be distributed (particularly with batch processing).

In some embodiment, the system 100 may facilitate the publishing of models and data with others, thus fostering creativity and collaboration. In some embodiments, the mathematical model analysis computer system 102 may offer users access to one or more models (e.g., one or more of models 214 stored in database 212) for users to study, copy, and/or edit. In some embodiments, users may search for or browse through models (e.g., using the search and retrieve process 1000 illustrated in FIG. 10) and try them out using default data sets or their own. In some embodiments, scientists may publish their findings on the web (e.g., using the model publication process 900 illustrated in FIGS. 9A-B) in addition to paper publications. A web-based publication may make it easy for other scientists to test the findings against their own experimental data. The other scientists may want to ask questions or make comments, which may be facilitated by the mathematical model analysis computer system 102, which may be, for example, a website. In some non-limiting embodiments, model authors may provide direct web links (urls) to their published models so that users may navigate directly to the specific model and data set (e.g., for immediate viewing and analysis). One or more of these features may facilitate collaboration.

In some non-limiting embodiments, users may register themselves on the mathematical model analysis computer system 102 in order to avail of the full functionality. For example, in one embodiment, a user must be registered in order to save models and participate in forums. In some embodiments, a user may create groups and/or request to be added to groups for private collaboration. In some embodiments, the mathematical model analysis computer system 102 will ensure that users can log in securely (e.g., users' password and registration details may be encrypted and stored securely). In some embodiments, the system 100 may support social media site integration in the form of single sign on using Google, Facebook, and/or other credentials. In some embodiments, users can create models and post descriptions and comments adjacent to the models with those credentials.

In some embodiments, a saved model (and its related experimental data) may be kept private or published to a group or to the public. In some embodiments, the mathematical model analysis computer system 102 may only allow private models to be deleted. In some embodiments, a private model may only be visible to the author, and the author may modify, save, and/or delete a private model at will. In some embodiments, only the author of a model may make private a public or group public model, and only the model's author may delete it.

In some embodiments, group-published models are visible to all members of a group. In some embodiments, group members may run the model but may not delete it. In some embodiments, group members may modify the model but can only save it using a different name (essentially making a new model from the group-published model). In some embodiment, the same rules may apply to public models.

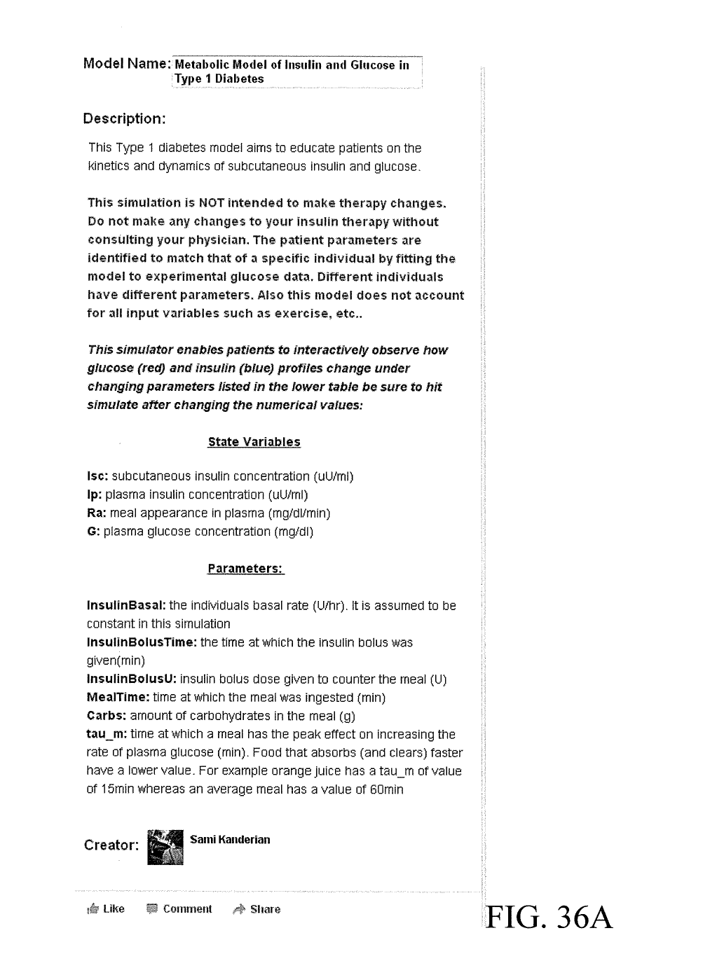

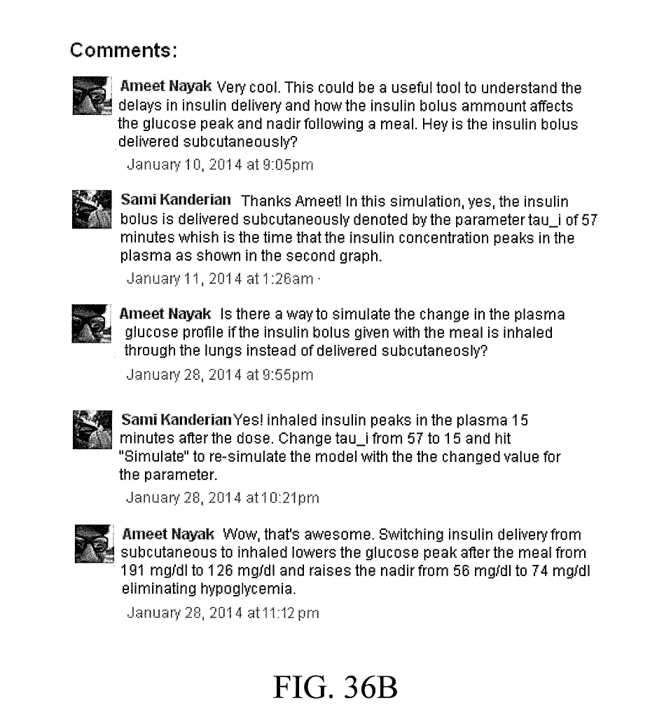

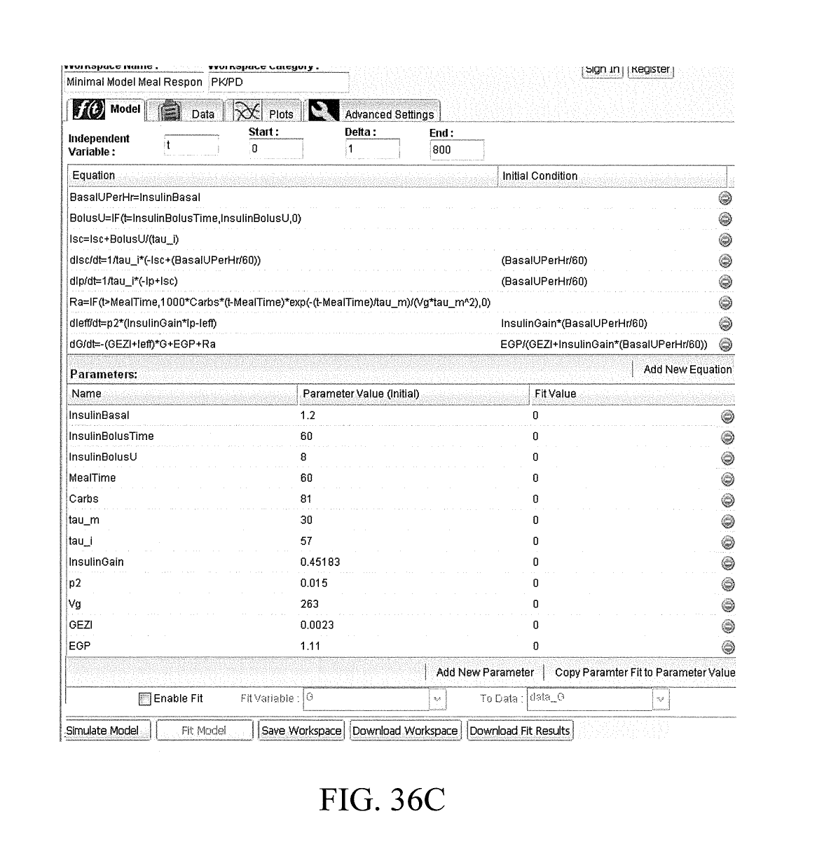

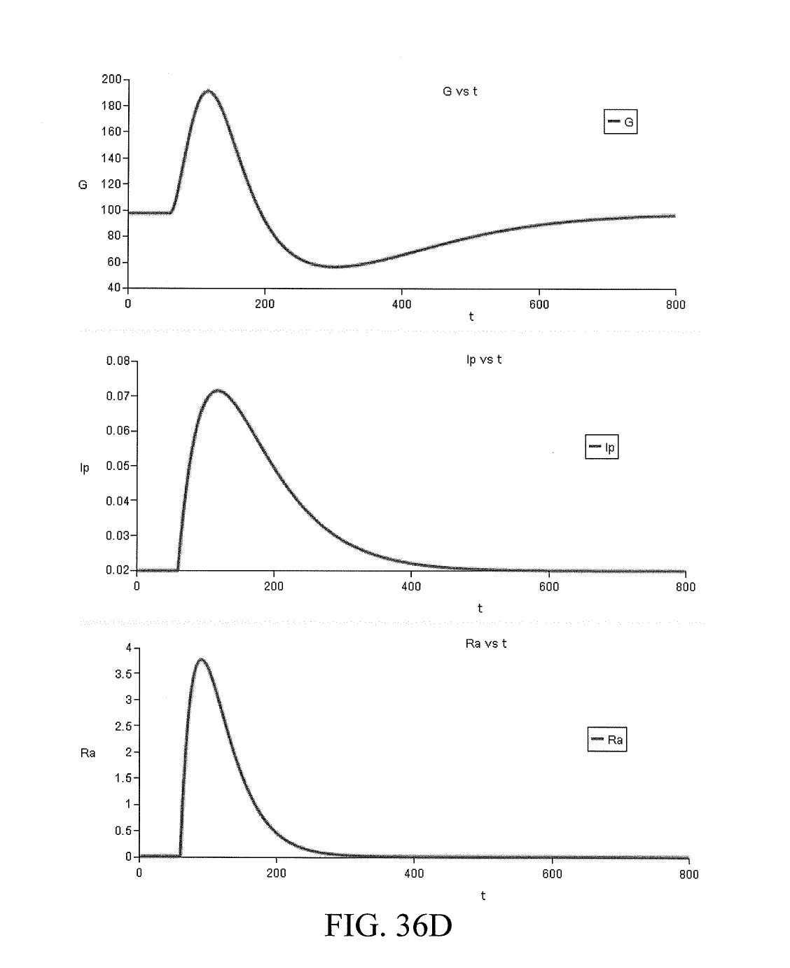

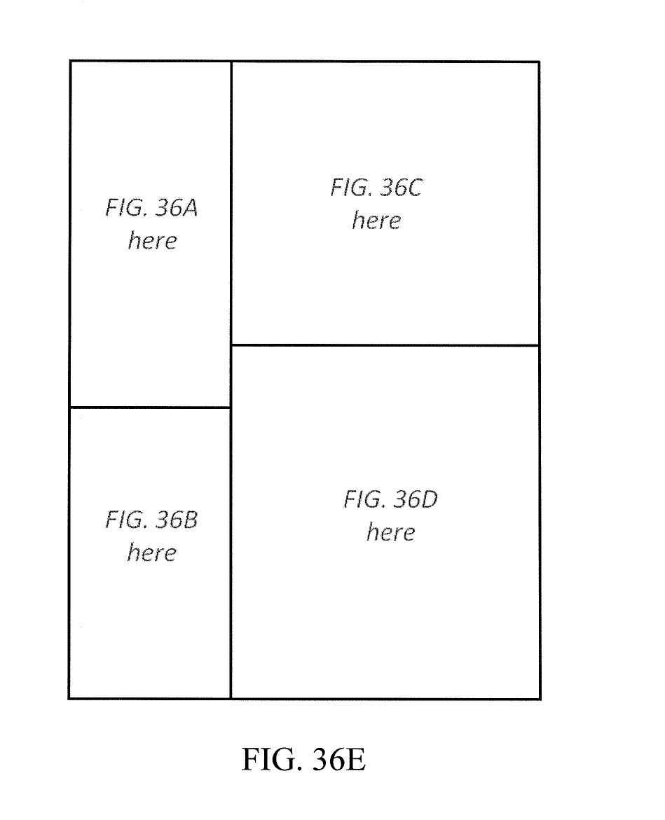

In some embodiments, the creator may write a description of the model, its comprised set of equations, state variables, and parameters. In some embodiments, the description may include the model's relevance to a particular problem (e.g., an explanation of the experimental phenomenon the model simulates) along with a description of a particular data set to which the model is fit. Registered users may comment on the model or data set. Registered users may “like” or give a rating to the model (e.g., with ratings for a model limited to a maximum of one per user), whereby the total number of likes is tabulated and displayed for each model. In some embodiments, a remote device 104 may display the description in a forum window, which may be, for example, adjacent to the model and/or the data set. See FIGS. 36A-E for an example.

Below are several non-limiting examples that demonstrate the usage and value of a mathematical model analysis computer system in accordance with embodiments of the invention relative to the current state of the art in solving engineering and scientific problems. However, the use of this invention is not limited to the models or algorithms provided in these examples; the model can be customized to have any set of user defined equations (closed form and/or differential equations), and any set of parameters.

### Non-Limiting Example 1

In some embodiments, the mathematical model analysis computer system 102 may be used to evaluate (fit) out the current suspension properties of a shock absorber to experimental data and modify it to have the optimal critically damped response.

### Independent Variable: t

Model equations:

$$\begin{matrix}\frac{d {y}_{0}}{d t} = - 2 * eta * {w}_{0} * {y}_{0} - {w}_{0}^{2} * {y}_{1} , & ( 5 ) \\ {y}_{0} ( 0 ) = 0 & ( 6 ) \\ \frac{d {y}_{1}}{d t} = {y}_{0} , & ( 7 ) \\ {y}_{1} ( 0 ) = {y}_{1} \_ini & ( 8 )\end{matrix}$$

### Parameters:

eta, w₀, y₁_{_{—}}ini

In this example y₀ and y₁, are state variables that change with time which are velocity and displacement of the shock absorber respectively. y₀(0) and y₁(0) are the initial velocity and displacement respectively. Any time differential equations of state variables relative to an independent variable (in this case time) are integrated, and the initial conditions of those state variables may be required. The parameters eta, w0 define the viscoelastic properties of the shock absorber. The parameter y1_ini defines the initial displacement of the mass attached to the shock absorber consisting of a spring and damper in parallel. Different shock absorbers may be described by the same set of model equations with different numerical values assigned to the parameters.

FIGS. 14A-B contains model equations, parameters (initial guess), and resulting plot of simulated variables of the model in Example 1 that may be generated by the mathematical model analysis computer system 102 (e.g., by the simulation process 300 described with reference to FIG. 3) using a value or initial guess for each parameter. The graph and results may be transmitted to and displayed by a remote device 104. In some embodiments, to identify the best fit parameters eta, w0 and y1_ini that will fit the model to the data using a nonlinear least squares routine, the mathematical model analysis computer system 102 may use an initial guess for each parameter, which may be supplied by the user (e.g., through a remote device 104) or generated (e.g., randomly) by the mathematical model analysis computer system 102. The initial guess or values parameters for the model equations in FIG. 14A yield the simulated result in the plot shown in FIG. 14B.

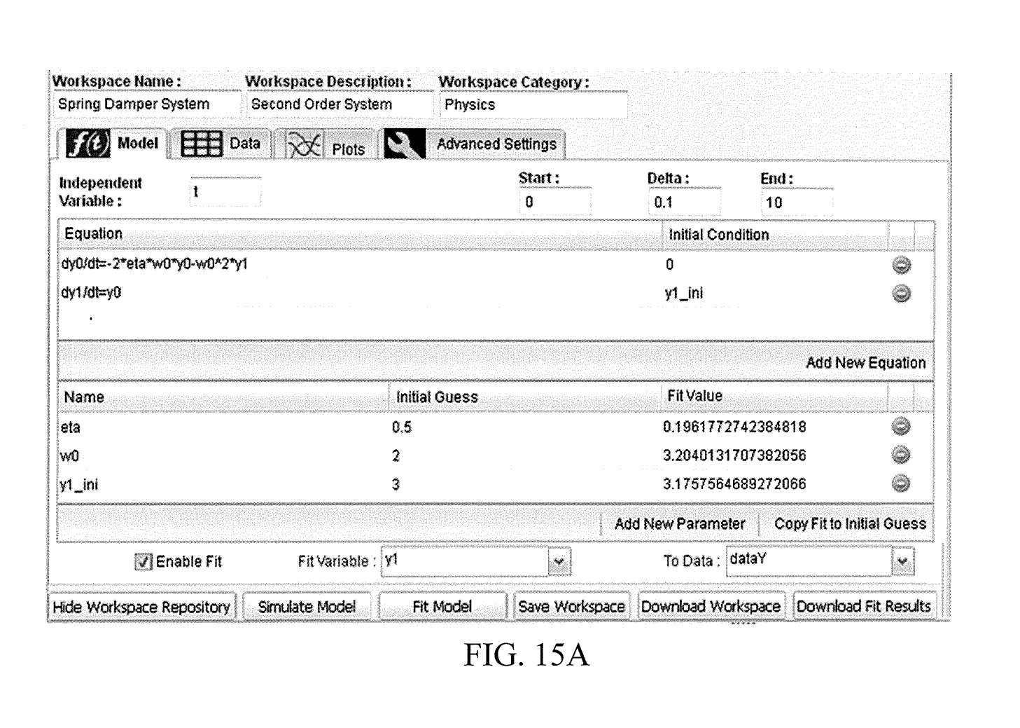

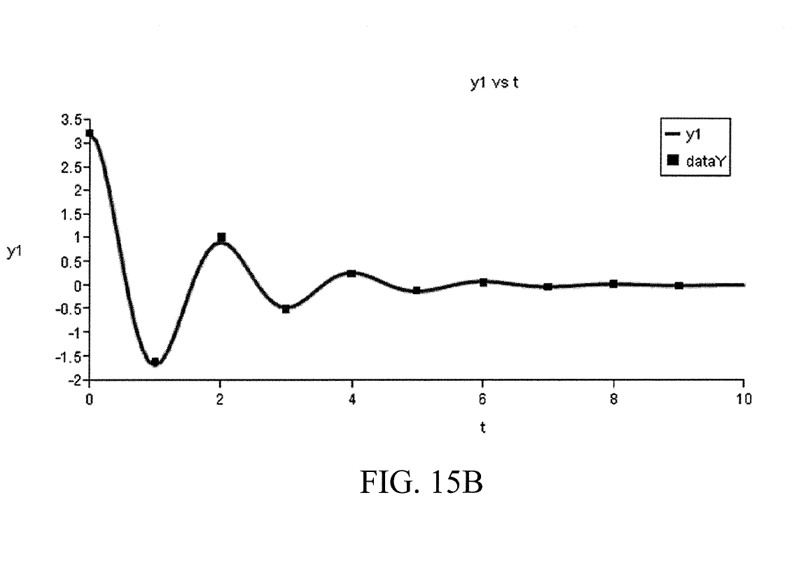

Applying the fit operation in Example 1 using the initial guess listed in FIG. 14A yields the fit parameters shown in FIG. 15A along with the updated simulated plot in FIG. 15B which now better follows the experimental data. This is done by the mathematical model analysis computer system 102 (e.g., by the fit operation process 800 described with reference to FIG. 8). In one non-limiting embodiment, the mathematical model analysis computer system 102 may perform the fit operation after the user inputs a fit operation instruction into a remote device 104 (e.g., hits, selects, or presses a fit button on displayed on the remote device). In some embodiments, the mathematical model analysis computer system 102 may identify the best fit parameters for the model that yield the minimum sum squared error between the model (line) and the experimental data through an iterative non-linear least squares procedure. The fit parameters may be returned to the remote device 104 along with the updated model simulation results and plot using the fit parameters. Thus, the remote device 104 may display the fit parameters and the updated model simulation results and plot, as shown in the right panel of FIG. 2 without any programming by the user.

In contrast, MATLAB requires the programming of script and functions, such as the script and functions described below, to simulate and fit the Example 1 model to experimental data. The following illustrates a MATLAB file (FitSpringDamperSystem.m) that is the main programming script but requires the additional three functions described below to run:
% FitSpringDamperSystem.m: MATLAB main script function that fits parameters
% of the model of differential equations defined in

SpringDamperSystemODE.m
% to experimental data given an initial guess set of parameters
% Experimental data to fit model to:
data_t=[0; 1; 2; 3; 4; 5; 6; 7; 8; 9];
data_y=[3.2; −1.6; 1; −0.5; 0.25; −0.125; 0.05; −0.03; 0.02; −0.01];
% Define Initial Guess parameters
eta_IG=0.5;
w0_IG=2;
y1_ini_IG=3;
% Group Initial Guess of parameters into array parameterArray_IG=[eta_IG,w0_IG, y1_ini_IG];
% Define Independent Variable span tSpan=(0:0.1:10)′;
% Simulate SpringDamperSystem model using Initial Guess of parameters and times in tSpan
[Y_IG]=SimulateSpringDamperSystem(parameterArray_IG, tSpan);
% Y is the 101x2 simulated output matrix
% Pull out resulting variables (vectors) of interest
y0_IG=Y_IG(:,1); % velocity
y1_IG=Y_IG(:,2); % displacement
% generate plots
figure;hold on;
% plot experimental data as black points
p1=plot(data_t, data_y, ‘k.’,‘MarkerSize’,20);
% plot [x,y] simulated model based on initial guess parametersp2=plot(tSpan, y1_IG,‘g’);
%% Fit model parameters to experimental data
% Find the indices of tSpan where experimental data exists
[intersection,ia,indexPairs]=intersect(data_t,tSpan);
% Get MATLAB's default options for fitting routine optionsFit=optimset;
% Use MATLB's Nelder-Mead non-linear least squares implementation to fit model to experimental data starting
% with initial guess to obtain model fit parameters [parameterArray_Fit]=fminsearch(‘SSESimulateSpringDamp erSystem’, parameterArray_IG, optionsFit, tSpan, data_y, indexPairs);
% Re-simulate SpringDamperSystem model using Fit parameters
[Y_Fit]=SimulateSpringDamperSystem(parameterArray_Fit, tSpan);
y0_Fit=Y_Fit(:,1); % model fit of velocity
y1_Fit=Y_Fit(:,2); % model fit of displacement figure;
hold on;
% plot experimental data as black points
p1=plot(data_t, data_y, ‘k.’,‘MarkerSize’,20);
% plot simulated model based on fit parameters
p2=plot(tSpan, y1 Fit,‘g’);
legend([p1,p2], ‘experimental dataY’, ‘y1 (model fit)’);
xlabel(‘t’);
ylabel(‘y1’);

(Text following the “%” are merely comments for the reader and are not interpreted as code). The following illustrates a MATLAB function (SSESimulateSpringDamperSystem.m) that calls the SimulateSpringDamperSystem function to simulate the model of differential equation defined in Example 1 and returns the sum squared error between the model and the experimental data for the iterative non-linear least squares fitting routine:
% SSESimulateSpringDamperSystem.m: MATLAB function that solves or simulates the model of differential equation defined in SpringDamperSystemODE.m given a set of parameters and independent span vector of times points. Its primary purpose is to return the Sum Squared Error between the model and the experimental data during the iterative non-linear least squares fitting routine.
function [SSE,Y]=SSESimulateSpringDamperSystem(parameterArray, tSpan, data_y, indexPairs)
[Y]=SimulateSpringDamperSystem(parameterArray, tSpan);
resid=Y(indexPairs,2)−data_y; % calculate residual error array from indexPairs subset of simulated result
SSE=resid’*resid; % Sum Squared Error between the model and the experimental data is the penatly function to minimize.

The following illustrates a MATLAB function (SimulateSpringDamperSystem.m) that solves or simulates the model of differential equation defined in the SpringDamperSystemODE.m file using MATLAB's built in ODE (Ordinary Differential Equation) solver:
% SimulateSpringDamperSystem.m: MATLAB function that solves or simulates the model of differential equation defined in SpringDamperSystemODE.m given a set of parameters and independent span vector of times points.
function [Y]=SimulateSpringDamperSystem(parameterArray, tSpan)
% pull out initial condition from parameterArray:
y1_ini=parameterArray(3);
% Define initial conditions of differential equation state variables:
yArrayInitial=[0, y1_ini];
% Load default options:
odeOptions=optimset;
% Run Matlab's ode45 function that integrates model of differential equations described in SpringDamperSystemODE. Inputs to ode45( ) must appear in a particular order for code to execute properly:
[tSpan, Y]=ode45(@SpringDamperSystemODE,tSpan,yArrayInitial, odeOptions,parameterArray);
% Y is the 101x2 simulated output matrix.

The following is a MATLAB function (SpringDamperSystemODE.m) that contains the differential equations of the model described in Example 1 and is called by MATLAB's ODE solver:
% SpringDamperSystemODE.m: MATLAB ODE function that solves for (integrates) a second order model consisting of two differential equations that models a shock absorber or spring damper system.
function dydt=SpringDamperSystemODE(t,yArray,parameterArray)
% Pull out parameters from parameterArray:
eta=parameterArray(1);
w0=parameterArray(2);
y1_ini=parameterArray(3);
% Pull out current state variables from yArray:
y0=yArray(1);
y1=yArray(2);
% Allocate space for output variables (code does not run without following line):
dydt=zeros(2,1);
% Spring Damper System Model Equations (differential equations):
dydt(1)=−2*eta*w0*y0−w0̂2*y1; % derivative of velocity given by equation
dydt(2)=y0; % derivative of position is velocity

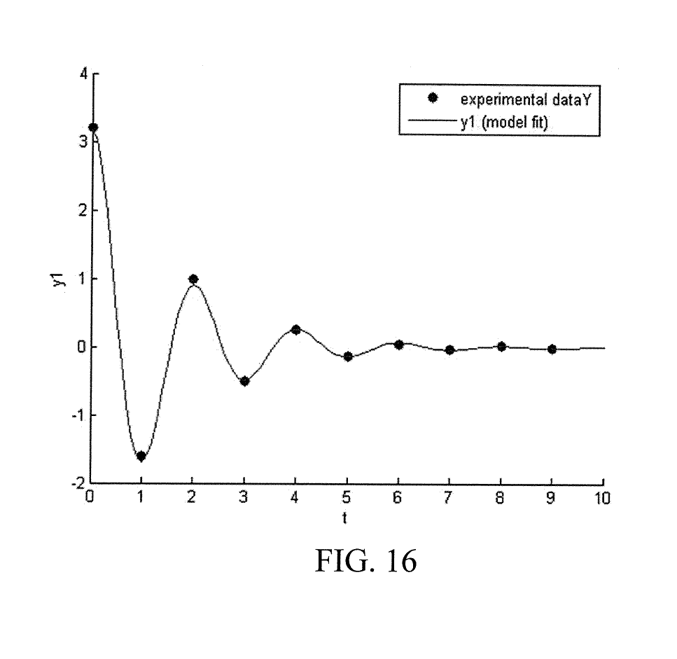

FIG. 16 illustrates the MATLAB results of the MATLAB code set forth above. As shown in FIG. 15A, the system 100, without any programming by the user, may produce analysis and results (FIG. 15B) equivalent to the MATLAB analysis and results.

In some embodiments, one or more of the model equations of a mathematical model 214, which may include one or more differential equations and/or one or more closed form equations and may be entered manually or by uploading a file (e.g., text file) via a GUI displayed on a remote device 104, may be in a format like one would see in a scientific or mathematics publication. In some non-limiting embodiments, one or more model equations of a mathematical model 214 may be typed into an equation editor (e.g., of the GUI displayed on a remote device 104) in a format like one would see in a scientific or mathematics publication. In some embodiments, one or more model equations of a model 214 may not be written in a syntax particular to a specific programming language. In some non-limiting embodiments, the left had side (i.e., the state variable) of the equations of a model 214 are not elements assigned to a coded array.

For instance, in some non-limiting embodiments, the model equations of example 1, when input into the system 100 (e.g., via the GUI displayed on a remote device 104) may look like “dy0/dt=−2*eta*w0*y0−w0̂2*y1” and “dy1/dt=y0” instead of “dydt(1)=−2*eta*w0*y0−w0̂2*y1” and “dydt(2)=y0” in MATLAB or other conventional software where dydt(1) and dydt(2) the first and second elements of the same array and not the first derivatives of two distinct variables. In some non-limiting embodiments, in contrast with MATLAB and the other conventional software, the mathematical model analysis computer system 102 may interpret “dy0/dt” on the left hand side of an equation as the first derivative of the variable “y0” with respect to “t.”

In non-limiting alternative embodiments, the models equations illustrated in FIGS. 14A and 15A (e.g., “dy0/dt=−2*eta*w0*y0−w0̂2*y1” and “dy1/dt=y0”) may be displayed by the GUI in a more visually appealing style/graphic (e.g., as displayed by LaTeX or by MS Word's equation editor) after entry and validation by the mathematical model analysis computer system 102, which would make the display of the above equations appear as shown in equations 5 and 7 above.

### Non-Limiting Example 2

In some embodiments, the mathematical model analysis computer system 102 may be used to evaluate (fit) the pharmacokinetics of orally or subcutaneously delivered drug such as insulin to a particular individual from a known insulin delivery profile and measured plasma insulin concentration profile.

A dynamic model that describes insulin concentration in the plasma from known insulin delivery profile is given by the following 2 differential equations as typed in the graphical user interface (GUI) shown in FIGS. 17A-D and 18A-B:

### Independent Variable: t

Model equations

$$\begin{matrix}BolusU = impulse ( data\_t , BolusInsulin , t ) & ( 9 ) \\ BasalUPerHr = step ( data\_t , basalInsulin , t ) & ( 10 ) \\ {y}_{1} = {y}_{1} + BolusU / ( {tau}_{1} * ( clearance / 1000000 ) ) & ( 11 ) \\ \frac{d {y}_{1}}{d t} = \frac{1}{{tau}_{1}} * ( - {y}_{1} ( t ) + \frac{BasalUPerHr / 60}{clearance / 1000000} ) , & ( 12 ) \\ {y}_{1} ( 0 ) = \frac{BasalUPerHr / 60}{clearance / 1000000} & ( 13 ) \\ \frac{d {y}_{2}}{d t} = \frac{1}{{tau}_{2}} * ( - {y}_{2} + {y}_{1} ) , & ( 14 ) \\ {y}_{2} ( 0 ) = \frac{BasalUPerHr / 60}{clearance / 1000000} & ( 15 )\end{matrix}$$

### Parameters:

tau₁, tau₂, clearance

In this example y₁ and y₂, are state variables that change with time, BolusInsulin and BasalInsulin are inputs entered or uploaded by the user into the “Data” tab. BolusU and BasalUPerHr are variables that define inputs BolusInsulin and BasalInsulin available for any time required by the ODE integrator to evaluate state variables y₁ and y₂ which are the insulin concentrations in a remote compartment and plasma respectively. The parameters tau1, tau2 and clearance define the pharmacokinetic properties of an administered drug such as insulin for a particular individual. The parameter table below the model equation table allows the user to quickly modify the values assigned to the model parameters and re-simulate the model with different values.

FIG. 17A shows model equations of Example 2. FIG. 17B shows a data table of input variables accessed by one or model equations (i.e. BasalInsulin, BolusInsulin) as well and experiment data (i.e. PlasmaInsulin). Simulations may be generated by the mathematical model analysis computer system 102 (e.g., by the simulation process 300 described with reference to FIG. 3) using an initial guess for each parameter. FIG. 17C contain plots of input variables The initial guess parameters for the model yield the simulated plasma insulin result in FIG. 17D. Experimental plasma insulin versus data are displayed as points in FIG. 17D. As shown in FIG. 2, the mathematical model analysis computer system 102 may handle multiple discrete inputs, such as for the basal insulin and bolus insulin. The bolus insulin input may be given as a series of impulses or insulin boluses at many different points (see bottom plot), and the basal insulin continuous input changes suddenly in a stepwise fashion (see middle plot).

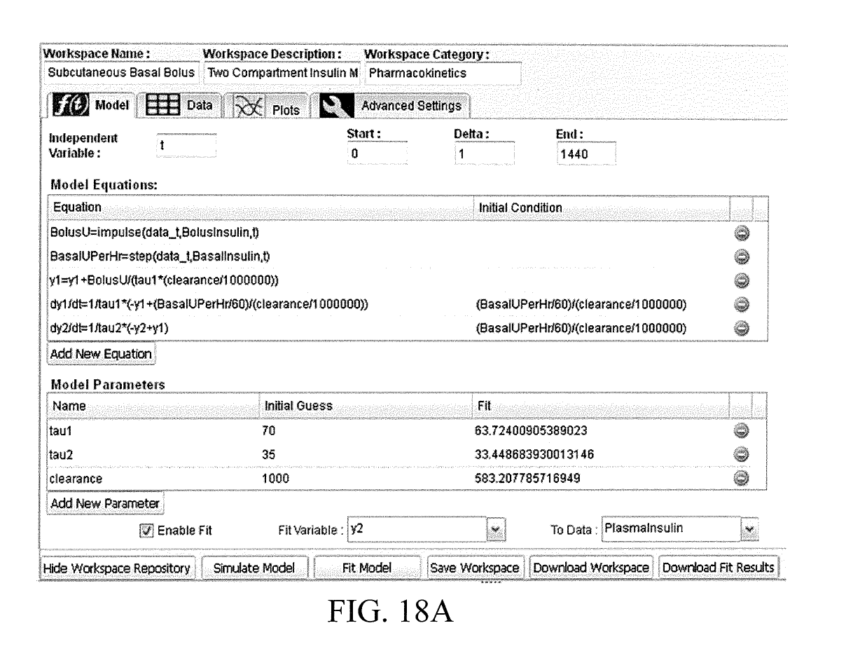

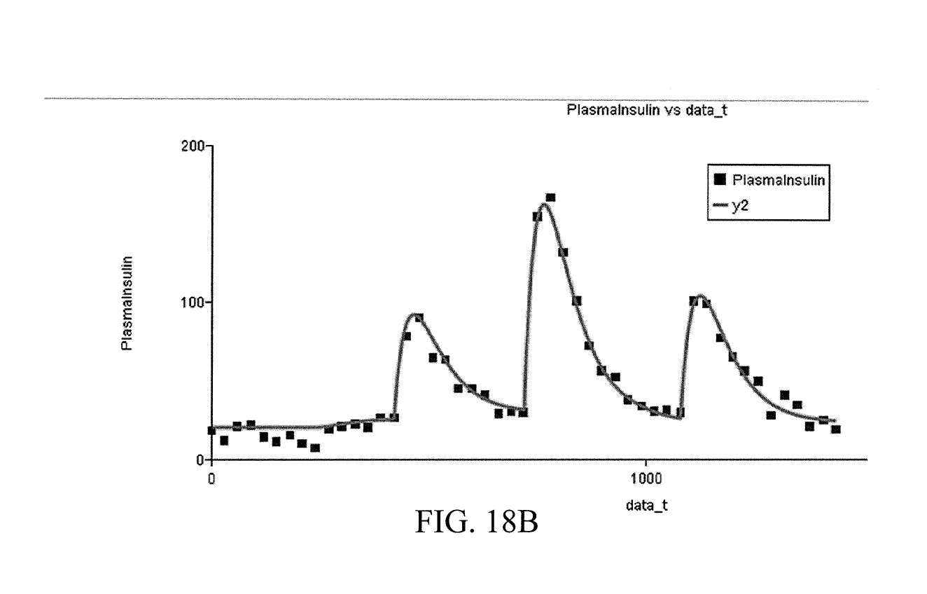

Applying the fit operation in Example 2 using the initial guess for parameters in FIG. 17A yields the fit parameters shown in FIG. 18A along with the updated simulated state variable, y2 shown in FIG. 18B. The mathematical model analysis computer system 102 may fit the model of concentration of the drug in the plasma (y2 profile in FIG. 18B) to the experimental data (points in FIG. 18B) to identify (fit) the model parameters, tau1, tau2 and clearance (e.g., by the fit operation process 800 described with reference to FIG. 8). Once fit, the model output y2 goes through the experimental plasma insulin data points. The resulting fit parameters and updated simulation shown in FIGS. 18A-B may be produced by the mathematical model analysis computer system 102 without any programming by the user. As shown in FIG. 18B, the plot generated by the mathematical model analysis computer system 102 may be integrated into the GUI displayed by a remote device 104.

In contrast, MATLAB requires the programming of script and functions, such as the script and functions described below, to simulate and fit the Example 2 model to experimental data. The following illustrates a file (FitBasalBolusInsulin.m) that is the main programming script but requires the additional three functions described below to run:
% FitBasalBolusInsulin.m: MATLAB main script function that fits parameters of the model of differential equations defined in FitBasalBolusInsulin.m to experimental data given an initial guess set of parameters %
% Load Data table:
load dataTable;
% Experimental data to fit model to:
data_t=dataTable(:,1); % first column of dataTable
PlasmaInsulin=dataTable(:,4); % last column of dataTable
% Define input data to the model
BasalInsulin=dataTable(:,2); % second column of dataTable
BolusInsulin=dataTable(:,3); % third column of dataTable
% Define Initial Guess parameters
tau1_IG=70;
tau2_IG=35;
clearance IG=1000;
% Group Initial Guess of parameters into array:
parameterArray_IG=[tau1_IG,tau2_IG,clearance IG];
% Define Independent Variable span:
tSpan=(0:1:1440)′;
% Simulate BasalBolusInsulin model using Initial Guess of parameters and times in tSpan. Since there are multiple changing basal and bolus inputs,they have to be input to the model along with the times where the changes occur:
function [Y_IG]=
SimulateBasalBolusInsulin(parameterArray_IG, tSpan, data_t, BasalInsulin, BolusInsulin);
% Y is the simulated output matrix where y1 is in the first column and y2 is in the second column.
% Pull out resulting variables (vectors) of interest:
y1_IG=Y_IG(:,1);
y2_IG=Y_IG(:,2); % model plasma insulin
% plot experimental data and model simulated with initial guess parameters:
figure;
hold on;
p1=plot(data_t, PlasmaInsulin, ‘k.’,‘MarkerSize’,20);
p2=plot(tSpan, y2_IG,‘g’);
legend([p1,p2], ‘Plasma Insulin (experimental data)’, ‘model: initial guess parameters’);
%% Fit model parameters to expertimental data:
% Find the indices of tSpan where experimental data exists:
[intersection,ia,indexPairs]=intersect(data_t,tSpan);
% Get MATLAB's default options for fitting routine optionsFit=optimset;
% Use MATLAB'd Nelder-Mead non-linear least squares implementation to fit model to experimental data starting with initial guess to obtain model fit parameters:
[parameterArray_Fit]=fminsearch(‘SSESimulateBasalBolus Insulin’, parameterArray_IG, optionsFit, tSpan, data_t, BasalInsulin, BolusInsulin, PlasmaInsulin, indexPairs);
% Re-simulate BasalBolusInsulin model using Fit parameters
[Y_Fit]=SimulateBasalBolusInsulin(parameterArray_Fit, tSpan, data_t, BasalInsulin, BolusInsulin);
y1_Fit=Y_Fit(:,1);
y2_Fit=Y_Fit(:,2); % model fit of plasma insulin
% plot experimental data and model simulated with fit parameters
figure;
subplot(3,1,1)
hold on;
p1=plot(data_t, PlasmaInsulin, ‘k.’,‘MarkerSize’,20);
p2=plot(tSpan, y2_Fit,‘b’); % plot simulated model based on fit parameterslegend([p1,p2], ‘Plasma Insulin (experimental data)’,‘y2 (model fit plasma insulin):’);
ylabel(‘PlasmaInsulin’);
subplot(3,1,2);
stairs(data_t,BasalInsulin);
ylabel(‘BasalUPerHr’);
set(gca,‘Ylim’, [0,1]);
subplot(3,1,3);
stem(data_t,BolusInsulin, ‘Marker’, ‘none’);
set(gca,‘Ylim’, [0,10]);
xlabel(‘t’);
ylabel(‘BolusU’);

The following illustrates a MATLAB function (SSESimulateBasalBolusInsulin.m) that calls the SimulateBasalBolusInsulin function to simulate the model of differential equation defined in Example 2 and returns the sum squared error between the model and the experimental data for the iterative non-linear least squares fitting routine:
% SSESimulateBasalBolusInsulin.m: MATLAB function that solves or simulates the model of differential equation defined in BasalBolusInsulinODE.m given a set of parameters and multiple changing basal and bolus inputs. Its primary purpose is to return the Sum Squared Error between the model and the experimental data during the iterative non-linear least squares fitting routine.
function [SSE, Y]=SSESimulateBasalBolusInsulin(parameterArray, tSpan, data_t, BasalInsulin, BolusInsulin, PlasmaInsulin, indexPairs)
[yArrayAll]=SimulateBasalBolusInsulin(parameterArray, tSpan, data_t, BasalInsulin, BolusInsulin);
% calculate residual error array (between model and experimental data) from indexPairs subset of simulated result:
resid=yArrayAll(indexPairs,2)−PlasmaInsulin;
SSE=resid’*resid; % Sum Squared Error between the model and the experimental data is the penatly function to minimize

The following illustrates a MATLAB function (SimulateBasalBolusInsulin.m) that solves or simulates the model of differential equation defined in the BasalBolusInsulinODE.m described in Example 2 using MATLAB's built in ODE (Ordinary Differential Equation) solver. This file contains a for loop to handle periodically changing inputs to the differential equations.
% SimulateBasalBolusInsulin.m: MATLAB function that solves or simulates the model of differential equation defined in SpringDamperSystemODE.m given a set of parameters and multiple changing basal and bolus inputs.
function [yArrayAll]=SimulateBasalBolusInsulin(parameterArray, tSpan, data_t, BasalInsulin, BolusInsulin)
deltaT=tSpan (2)−tSpan (1);
% Allocate space for 2 column output matrix:
yArrayAll=zeros(length(tSpan),2);
% pull out parameters from parameterArray:
tau1=parameterArray(1);
tau2=parameterArray(2);
clearance=parameterArray(3);
% Define initial conditions of differential equation state variables:
yArrayInitial=[(BasalInsulin(1)/60)/(clearance/1000000), (BasalInsulin(1)/60)/(clearance/1000000)];
yArrayThis=yArrayInitial;
% Load default options:
odeOptions=optimset;
nInputs=length(BasalInsulin);
% In Matlab, a for loop is required to handle multiple changing bolus (impulse) and basal (step) inputs to modify the initial conditions to the Matlab ODE solver:
totalSimPoints=0;
for k=1:nInputs−1
tStart=data_t(k);
tEnd=data_t(k+1);
% Modify initial condition of ODE to include new (kth) bolus input:
yArrayThis(1)=yArrayThis(1)+BolusInsulin(k)/(tau1*(clearance/1000000));
thisBasalInsulin=BasalInsulin(k);
if k>1%
   % Store last simulation segment into yArrayAll along with latest state variables with new inputs accounted for
yArrayAll(totalSimPoints+1:totalSimPoints+nSubset,:)=[Y(1:end−1,:); yArrayThis];
   totalSimPoints=totalSimPoints+nSubset−1;
end
% Run Matlab's ode45 function that integrates model of differential equations described in SpringDamperSystemODE. Inputs to ode45( ) must appear in a particular order for code to execute properly
tSimSubset=(tStart:deltaT:tEnd)’;
nSubset=length(tSimSubset); [tOutVec, Y]=ode45(@BasalBolusInsulinODE,tSimSubset,yArrayThis,odeOptions,parameterArray, thisBasalInsulin);
   % Y is the several row, 2 column simulated output matrix for the time subset between current and next input.
      % Store last row of ODE output Y into yArrayThis: yArrayThis=Y(end,:);
end
yArrayAll(totalSimPoints+1:totalSimPoints+nSubset,:)=[Y(1:end−1,:); yArrayThis];

The following is a MATLAB function (BasalBolusInsulinODE.m) that contains the differential equations of the model described in Example 2 and is called by MATLAB's ODE solver:
% BasalBolusInsulinODE.m: MATLAB ODE function that solves for (integrates) a second order PharmacoKinetic drug absorption model consisting of two differential equations. function dydt=
BasalBolusInsulinODE(t,yArray,parameterArray, thisBasalInsulin)
% Pull out parameters from parameterArray
tau1=parameterArray(1);
tau2=parameterArray(2);
clearance=parameterArray(3);
% Pull out current state variables from yArray
y1=yArray(1);
y2=yArray(2); % y2 is the modeled plasma insulin
% Allocate space for output variables (code does not run without following line)
dydt=zeros(2,1);
% Second order PharmacoKinetic drug absorption model
Equations (differential equations) dydt(1)=1/tau1*(−y1+(thisBasalInsulin/60)/(clearance/1000000));
   % derivative of velocity given by equation dydt(2)=1/tau2*(−y2+y1);

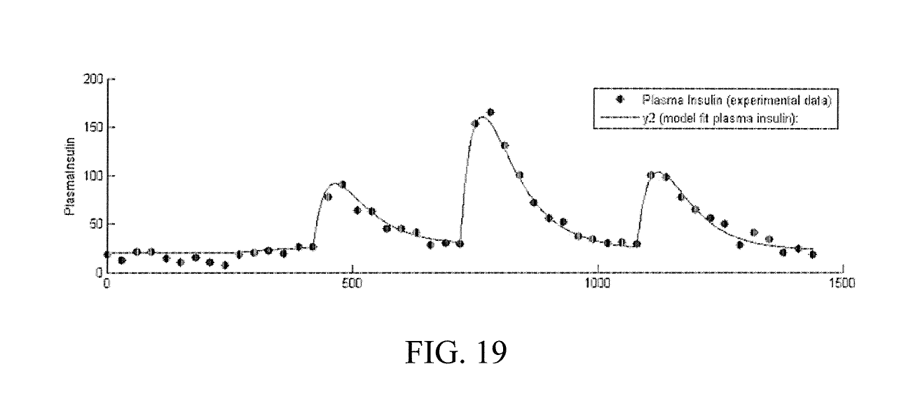

FIG. 19 illustrates the MATLAB results of the MATLAB code set forth above. As shown in FIG. 18A, the system 100, without any programming by the user, may be capable of producing analysis and results (FIG. 18B) equivalent to the MATLAB analysis and results.

### Non-Limiting Example 3

In some embodiments, the mathematical model analysis computer system 102 may be used to simulate and identify (fit) parameters of a metabolic model to experimental glucose data from an individual patient with type 1 diabetes for a given meal and insulin delivery profile and predict what the glucose profile would have looked like had the insulin delivery profile been different.

### Independent Variable: t

Model equations

$$\begin{matrix}InsulanBasal = 1.2 & ( 16 ) \\ InsulinBolusTime = 60 & ( 17 ) \\ InsulinBolusU = 7 & ( 18 ) \\ MealTime = 60 & ( 19 ) \\ Carbs = 81 & ( 20 ) \\ BasalUPerHr = InsulinBasal & ( 21 ) \\ BolusU = IF ( t = InsulinBolusTime , InsulingBolusU , 0 ) & ( 22 ) \\ {I}_{SC} = {I}_{SC} + \frac{BolusU}{{tau}_{i}} & ( 23 ) \\ \frac{d {I}_{SC}}{d t} = \frac{1}{{tau}_{i}} * ( - {I}_{SC} + BasalUPerHr / 60 ) , & ( 24 ) \\ {I}_{SC} ( 0 ) = BasalUPerHr / 60 & ( 25 ) \\ \frac{d {I}_{P}}{d t} = \frac{1}{{tau}_{i}} * ( - {I}_{p} + {I}_{SC} ) , & ( 26 ) \\ {I}_{P} ( 0 ) = BasalUPerHr / 60 & ( 27 ) \\ {R}_{a} = if ( t > MealTime , \frac{\begin{matrix}1000 * Carbs * ( t - MealTime ) * \\ exp ( - ( t - MealTime ) / {tau}_{m} )\end{matrix}}{{V}_{g} * {tau}_{m}^{2}} , 0 ) , & ( 28 ) \\ \frac{d {I}_{EFF}}{d t} = {p}_{2} * ( InsulinGain * {I}_{p} + {I}_{EFF} ) , & ( 29 ) \\ {I}_{EFF} ( 0 ) = InsulinGain * BasalUPerHr / 60 & ( 30 ) \\ \frac{d G}{d t} = - ( GENZI + {I}_{EFF} ) * G + EGP + {R}_{a} , & ( 31 ) \\ G ( 0 ) = \frac{EGP}{( GENZI + InsulinGain * ( BasalUPerHr / 60 )} & ( 32 )\end{matrix}$$

### Parameters:

tauᵢ, Insulin Gain, tauₘ, V_{G}, p₂, GEZI, EGP

In this example I_{SC}, I_{P}, I_{SC}, Rₐ, I_{EFF}, I_{SC} and G are state variables that change with time which are subcutaneous insulin, plasma insulin, meal appearance rate, insulin effect, and plasma glucose respectively. Conditional expressions such as Equation 24 allow for one of two possible equations to be active depending on whether the condition is satisfied. InsulinBasal, InsulinBolus, InsulinBolusTime, InsulinBolusU, MealTime, Carbs and BasalUPerHr are variables that are assigned to constant values. Constants can also be assigned as parameters in the parameters table if they are to be identified by fitting the model to experimental glucose data. Different individuals may be described by the same set of model equations with different numerical values assigned to the pharmacokinetic and pharmacodynamic parameters depending on the physiological differences between individuals. The parameters tau_{S}, Insulin Gain, tauₘ, V_{G}, p₂, GEZI, EGP, are the insulin time constant, insulin gain, meal time constant, glucose distribution volume, insulin effect time constant, glucose effectiveness at zero insulin and endogenous glucose production. These parameters vary from individual to individual.

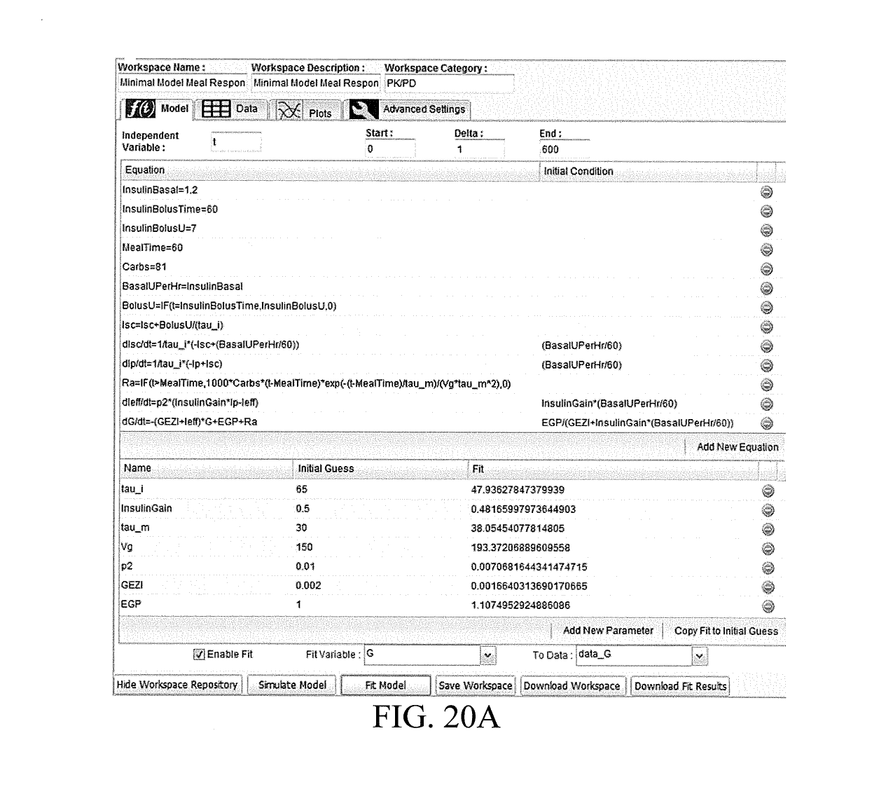

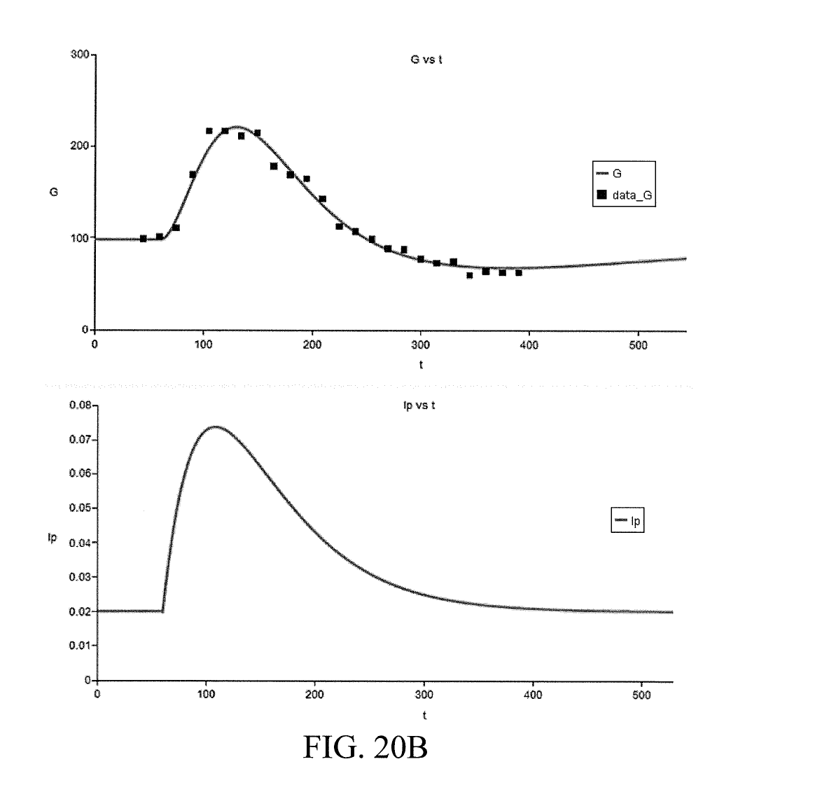

FIG. 20A contains model equations and fit parameters of Example 3 with resulting simulated glucose (G) shown in the top subplot of FIG. 20B by the mathematical model analysis computer system 102 (e.g., by the fit operation process 800 described with reference to FIG. 8). Following a meal of 81 g carbohydrate at time 60 min along with 7 U of insulin bolus given at the same time, a patient's experimental glucose is measured (black points). In some embodiments, the mathematical model analysis computer system 102 may fit the data points to a metabolic model (top grid, FIG. 20A) resulting in the identified (fit) parameters (bottom grid, fit column of FIG. 20A) for the models. In some embodiments, the mathematical model analysis computer system 102 may return the fit parameters to the remote device 104 along with model simulation results and a plot using the fit parameters. The remote device 104 may display the fit parameters and the model simulation results and plot without any programming by the user. As shown in the top subplot of FIG. 20B, the model fit simulated glucose profile (line) has a post-prandial glucose peak of 222 mg/dl and a nadir of 68 mg/dl.

### Non-Limiting Example 4

In some embodiments, the mathematical model analysis computer system 102 may be used to simulate the Hodgkin-Huxley action potential model and identify parameters (fit model) to replicate experimental voltage data from the squid axon resulting from a current clamp (clamp the current and measure the resulting voltage). The mathematical model analysis computer system 102 may then be used to simulate a voltage clamp and measure the resulting current. Hodgkin and Huxley tested many models to develop of this model simulation that replicated experimental data with the identified parameters, earned Hodgkin and Huxley the Nobel Prize in Physiology or Medicine in 1963, formed the basis understanding of ionic mechanisms involved in neural activation, and revolutionized the treatment of neurological disorders with drugs or electrical stimulation. In some embodiments, the mathematical model analysis computer system 102 may be used to quickly simulate the Hodgkin-Huxley action potential and fit it to data, without the need for software installation or knowledge in computer programming and applied mathematics.

### Independent Variable: t

Model equations

$$\begin{matrix}Iapp - if ( t > 0 , 0.1 , 0 ) & ( 33 ) \\ \frac{d v}{d t} = \frac{1}{Cm} * ( \begin{matrix}Iapp - g\_Na * {m}^{3} * h * ( v - E\_Na ) - \\ g\_K * {n}^{4} * ( v - E\_K ) - g\_L * ( v - E\_L )\end{matrix} ) , & ( 34 ) \\ v ( 0 ) = - 16 & ( 35 ) \\ a\_n = \frac{0.01 * ( v + 50 )}{( 1 - exp ( - ( v + 50 ) / 10 ) )} & ( 36 ) \\ b\_n = 0.125 * exp ( - ( v + 60 ) / 80 ) , & ( 37 ) \\ a\_m = \frac{0.01 * ( v + 35 )}{( 1 - exp ( - ( v + 35 ) / 10 ) )} , & ( 38 ) \\ b\_m = 4 * exp ( - 0.0556 * ( v + 60 ) ) , & ( 39 ) \\ a\_h = 0.07 * exp ( - 0.05 * ( v + 60 ) ) , & ( 40 ) \\ b\_h = \frac{1}{( 1 + exp ( - 0.1 * ( v + 30 ) ) )} , & ( 41 ) \\ \frac{d n}{d t} = a\_n * ( 1 - n ) - b\_n * n , & ( 42 ) \\ n ( 0 ) = a\_n / ( a\_n + b\_n ) & ( 43 ) \\ \frac{d m}{d t} = a\_m * ( 1 - m ) - b\_m * m , & ( 44 ) \\ m ( 0 ) = a\_m / a\_m + b\_m & ( 45 ) \\ \frac{d h}{d t} a\_h * ( 1 - h ) - b\_h * h , & ( 46 ) \\ n ( 0 ) = a\_n / ( a\_n + b\_n ) & ( 47 )\end{matrix}$$

### Parameters:

Cm, E_Na, E_K, E_L, g_Na, g_K, g_L

In this example v, n, m, h, a_n, b_n, a_m, b_m_a_h, b_h are state variables that change with time. v is the intracellular voltage, n, m, h dictate the probabilities of certain ionic channels being open. a_n, b_n, a_m, b_m_a_h, b_h are voltage dependent rate constants. The parameters Cm represents capacitance, E_Na, E_K, and E_L represent the sodium, potassium and leak membrane potentials respectively. g_Na, g_K, and g_L represent the sodium, potassium and leak conductances respectively.

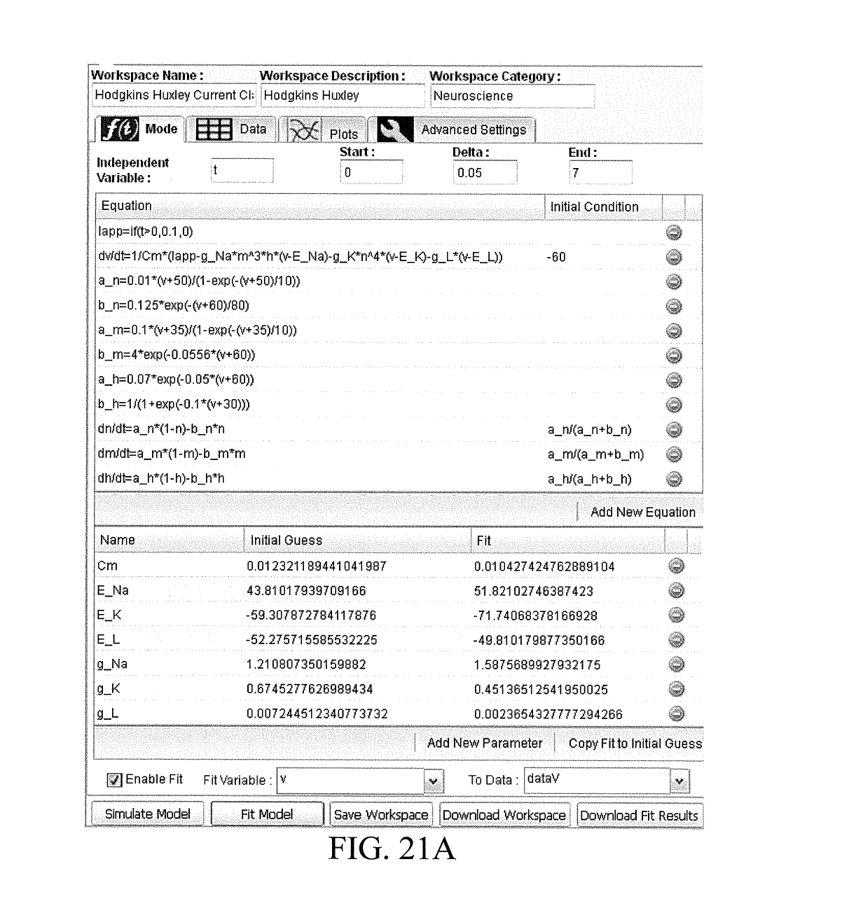

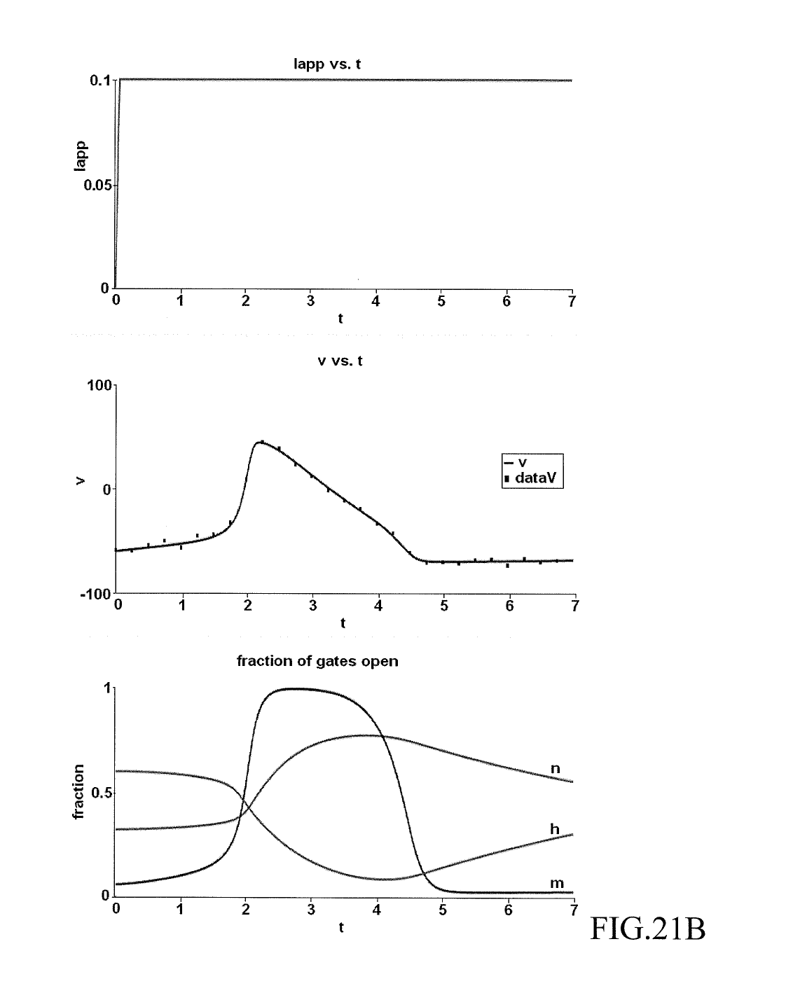

FIG. 21A contains model equations and fit parameters of Example 4 with resulting simulated voltage (v) profile shown in the middle subplot of FIG. 21B fit to the experimental data (black points) by the mathematical model analysis computer system 102 (e.g., by the fit operation process 800 described with reference to FIG. 8). In FIG. 21A, the axon is under a current clamp input (top subplot).

In some embodiments, the system 100 may not require the installation of software on a remote device 104 to perform the model analysis; rather, in some embodiments, the a remote device 104 may access mathematical model analysis computer system 102 by going to a website independent of the remote device 104 and/or operating system running on the remote device 104. The website may provide a graphical user interface (GUI) from which a user can define a model, its parameters, and upload data. In some embodiments, the user may instruct mathematical model analysis computer system 102 on what analysis to perform (e.g., simulations or model fitting to data) by entering information and/or clicking buttons on the GUI. The remote device 104 may send data from the GUI to the mathematical model analysis computer system 102, which may be hosted on one or more cloud based servers. The mathematical model analysis computer system 102 may perform computational analysis with an accelerated the runtime compared to traditional software packages that require installation and run on one local machine. In some nonlimiting embodiments, once data and models are saved, they can be saved and shared with any number of individuals, whereby the data, models and plots can be accessed from any other device with access to the internet. In some non-limiting embodiments, users can access the computation engine (e.g., mathematical model analysis computer system 102) from their website using their own custom GUI (third-party extension). In some embodiments, the model equations, parameters, and data may be sent to the computation engine through web communication. In some embodiments, the computation engine may perform analysis, model simulation, and/or fit models to data and send the result back to the user's website.

In some embodiments, users can create any custom mathematical model or algorithm by typing in a set of custom equations that include one or more closed form equations and/or one or more differential equations. In some embodiments, the equations that define a model may be typed into a GUI displayed on a remote device 104 exactly as they would appear in a mathematics, science, or engineering textbook. In other words, in some embodiments, the equations may be typed into the GUI just as they appear as listed in the examples above in the same format with the same variable names (see, e.g., FIGS. 14A, 15A, 17A, 20A, and 21A). In some embodiments, unlike conventional programs like MATLAB, Mathematica, R, Python, Perl, S+, or SAS, no programming is required to set up the model equations. Conventional programs like MATLAB, Mathematica, R, Python, Perl, S+, or SAS requires programming whose syntax varies from one programming language or software package to another. In some embodiments, the multi-equation (model) interpreter of the mathematical model analysis computer system 102 interprets or solves multiple equations (discrete, differential, and/or closed form) with ease where users can use any variable or parameter names they want without programming. In some non-limiting embodiments, model equations maybe entered in a table (e.g., a top table), and parameters that are constants in the model are entered in another table (e.g., a bottom table). In some embodiments, the mathematical model analysis computer system 102 may simulate and fit a user-defined model to experimental data and, with no programming by the user, yield results identical to MATLAB results.

In some embodiments, the mathematical model analysis computer system 102 may handle closed form and differential equations. In some embodiments, the set of differential equations may be numerically integrated at different time points using standard Runge-Kutta Ordinary Differential Equation (ODE) solvers or numerical integration methods to obtain the state variables y₁(t) and y₂(t) at the desired time points or every minute from start to end time (see, e.g., the process 600 for simulating a mathematical model that contains at least one differential equation described above with reference to FIG. 6A). In some embodiments, initial conditions for all state variables (at t=0 min) may need to be provided (e.g., by the state variable initialization process 700 described above with reference to FIG. 7). In some non-limiting embodiments, the ODE solver of the mathematical model analysis computer system 102 may calculate the values of these variables more frequently than the desired minute interval if the magnitude of the rate of change of these variables is high. That is, in some embodiments, the time step size may be adaptively chosen to maintain high accuracy even though the simulated output may only be stored at values spanned by the independent variable. In some non-limiting embodiments, the adaptive time step size may be the default setting for numerical integration of differential equations, and a user may have the option of changing the minimum step size to a fixed numerical value (e.g., via an advanced settings tab of the GUI displayed on a remote device 104).

In some embodiments, the mathematical model analysis computer system 102 may be able to integrate differential equations. Unlike conventional system, the mathematical model analysis computer system 102 may not require programming to integrate the differential equations. In conventional system, closed form equations and differential equations have to be treated differently in how they are programmed; multiple state variables listed as differential equations have to be grouped together in arrays. In conventional systems, an array containing the integrated state variables has to be passed in an out of a function call that has to be programmed along with various settings that have to be sent in as additional arguments to the function in a specific order for the simulation to execute properly. In conventional systems, this function containing the model equations has to be called multiple times if the inputs to the model change over time. In conventional systems, parameters that are input to the model have to be entered as the first argument to the function. In summary, conventional systems require much programming, which changes if the model changes and leaves much room for user error (see MATLAB scripts and functions set forth above with respect to Examples 1 and 2).

In some embodiments, the mathematical model analysis computer system 102 may be able to handle both closed form equations as well as differential equations without the user having to treat them differently or do any programming. In some embodiments, the user only has to enter the equations (e.g., as they appear in a math or science textbook) and corresponding parameters and assigned values. In some non-limiting embodiments, the span of the independent variable may define the sampling frequency and range of the simulated results of state variables according to the “Start”, “Delta” and “End” values.

Some conventional standalone software packages allow users to simulate and fit a single, closed form, non-linear equation to experimental data with programming (e.g., Graphpad Prism). However, unlike conventional software packages, mathematical model analysis computer system 102 may allow users to simulate and fit a model consisting of a set of one or more closed form equations and/or one or more differential equations without extensive programming. In some embodiments, the mathematical model analysis computer system 102 may simulate and fit a model containing any number of closed form equations and/or any number of differential equations that have to be integrated.

In some embodiments, the mathematical model analysis computer system 102 may handle multiple changing input data to the model (other than parameters). See, e.g., FIGS. 3-8. In some embodiments, the mathematical model analysis computer system 102 may handle the solving or integration of multiple differential equations with an adaptive time step using an ODE solver. In some embodiments, the mathematical model analysis computer system 102 may additionally handle multiple changing discrete non-continuous and non-differentiable inputs to the model. In many instances, inputs describing physical phenomena resemble a series of impulses or spikes or include sudden step-wise changes. The basal and bolus insulin inputs of Example 2 are two examples. In example 2, the initial conditions are determined by the basal and bolus insulin given at time t=0. However, the input for the bolus insulin is given in multiple discrete inputs as a series of impulses or insulin boluses at many different points in time, as shown by the BolusInsulin column of the input table in FIG. 17B using the impulse keyword in an equation in FIG. 17A. Similarly, the basal insulin rate, which is a continuous input, changes suddenly in a step wise fashion as shown in the BasalInsulin column in FIG. 17B using the step keyword in an equation in FIG. 17A.

In some non-limiting embodiments, discrete inputs can be uploaded into or entered into an input table. In some embodiments, the input table may be uploaded as part of a text file or manually entered. As shown in FIG. 17B, in some embodiments, the input table may be viewed under a “Data” tab. In some non-limiting embodiments, the header of the data column in the input table may be used as the input variable name accessed by the model (e.g., BolusInsulin and BasalInsulin in FIG. 17B). In some embodiments, the mathematical model analysis computer system 102 may handle such input changes to the mathematical model correctly by stopping and starting the integration routine every time there is an input change (see, e.g., FIG. 34). In some non-limiting embodiments, the mathematical model analysis computer system 102 may require that all inputs have a value defined for all time between the first and last time point defined by the independent variable. In some non-limiting embodiments, to ensure continuity, this is handled through the use of simple step, impulse, and/or interpolation equations that handle the discrete/impulse inputs and changing discrete stepwise continuous inputs, such as by adding Equations 5, 6, and 7 to handle multiple inputs shown in FIG. 17A.

Although conventional modeling software, such as MATLAB, has similar impulse and step functions to ensure inputs are continuous for all time, the MATLAB ODE function does not start and stop at all time points where there is a sudden change in inputs to the model. For such inputs to be handled correctly additional code would need to be written in a for loop that starts and stops the ODE routine every time there is a sudden change in the input variables as shown in the MATLAB function (SimulateBasalBolusInsulin.m) that solves or simulates the model of differential equation defined in the BasalBolusInsulinODE.m described in Example 2.

In some embodiments, the mathematical model analysis computer system 102 may simulate the model with a set of parameters. Each customized model or algorithm can have parameters that are particular to a unique system, individual or experiment. Parameters may have a physical meaning associated with their value. In some embodiments, after defining the model and values to a set of parameters, users can easily run a model simulation by entering a simulate model instruction (e.g., clicking the “Simulate Model” button). In some embodiments, users can quickly modify the parameters and/or the model equations and re-simulate the model. In some embodiments, each state variable of a model (i.e., left hand side of a closed form model equation) may have computed values stored for each value spanned by the independent variable, and the stored values may be downloadable to a file. FIGS. 3-7 illustrate flowcharts that for performing the simulation process according to some embodiments. In Example 1, y₀ and y₁ will have a value at all times from 0 (“Start”) and 10(“End”) at 0.1 increments (“Delta”). Results and plots of desired output variables will be updated automatically. In contrast, with conventional systems, if model is to be changed, the program has to be rewritten, which takes much more time and the user is much prone to making errors.

In some embodiments, the mathematical model analysis computer system 102 may identify or fit the model parameters to experimental data from particular system or individual. In some embodiments, the mathematical model analysis computer system 102 may fit a simulated model to data collected from a particular experiment or individual (e.g., through linear or non-linear least squares (regression)). In embodiments using non-linear least squares, model parameters may be given an initial guess and simulated (e.g., as shown in FIG. 14A with resulting simulation plot in FIG. 14B for Example 1). In some embodiments, after a user enter a fit model instruction (e.g., by pressing a “Fit Model” button), the mathematical model analysis computer system 102 may perform a fit operation (e.g., the fit operation process 800 described above with reference to FIG. 8) and return updated results based on the best fit parameters (e.g., as shown in FIG. 15A with updated simulated results in FIG. 15B for Example 1,which shows the model simulated variable, y₁ replicating the experimental data points defined by dataY).

FIG. 8 illustrates a flowchart describing a fit operation process 800 that may be performed by the mathematical model analysis computer system 102 according to some embodiments. In some non-limiting embodiments, upon entry of a fit model instruction (e.g., hitting the “Fit Model” button), the mathematical model analysis computer system 102 may receive the instruction from the remote device 104 and automatically iterate the values assigned to the parameters and simulate the model using these changing parameters until the Sum Squared Error (SSE) between a model output variable and the experimental data (y1 and dataY respectively in Example 1) is minimized. In some non-limiting embodiments, the SSE may be minimized in a process known as non-linear least squares:

SSE=(y1(t)−dataY(t))² (48)

Here the model variable y1 is fit to the experimental data dataY listed under the “Data” tab. The mathematical model analysis computer system 102 may automatically pair up model values and experimental data that occur at the same point in time (or other independent variable) when the experimental data points (shown as black squares in the figures) does not exist at every point in time the model variable is simulated.

In Example 2, the simulated model variable y2 is fit to the experimental data PlasmaInsulin listed under the “Data” tab of FIG. 17B and generates the fit parameter results shown in FIG. 18A with resulting fit simulated profile, y2 in FIG. 18B that represents experimental data.

In Example 3, the simulated model variable G (glucose) is fit to the experimental data data_G listed under the “Data” tab and generates the fit parameter results shown in FIG. 20A with resulting fit simulated glucose profile, G in FIG. 20B.

In some embodiments, when the SSE is minimized, the model parameters are optimized or fit to that experimental data set. In some embodiments, the iterative process may terminate when further reduction in SSE is marginal, change in model parameters is marginal, or the maximum number of iterations is reached (see, e.g., step 809 of FIG. 8). Each of these termination conditions may have default values that can be changed by the user. In some embodiments, users can manually change these settings from their default values (e.g., by accessing the “Advanced Settings” tab). The model parameters that yield the lowest sum SSE are called the identified or fit parameters. When the SSE is relatively low or the Correlation Coefficient (CC, Equation 7) between the paired model and the experimental data is high (close to 1) the mathematical model with the fit parameters may replicate the experimental data under the same inputs. In some non-limiting embodiments, the default metric or penalty being minimized is the SSE. Alternatively other penalty functions can be optimized defined under the “Advanced Settings” tab, such as, for example, weighted SSE which assigns different weights priority to certain experimental data points

$$CC = \frac{{\sum }_{i = 1}^{n} [ ( {y}_{1} ( i ) - {μ}_{y 1} ) ( data Y ( i ) - {μ}_{data Y} ) ]}{( n - 1 ) {σ}_{y 1} {σ}_{data Y}} \qquad ( 49 )$$

The fit parameters may reveal important properties of the system or individual from which the experimental data came. When the mathematical model analysis computer system 102 yields a good fit between the model and the data, the fit parameters of the model can classify a property of the system from which the data was obtained.

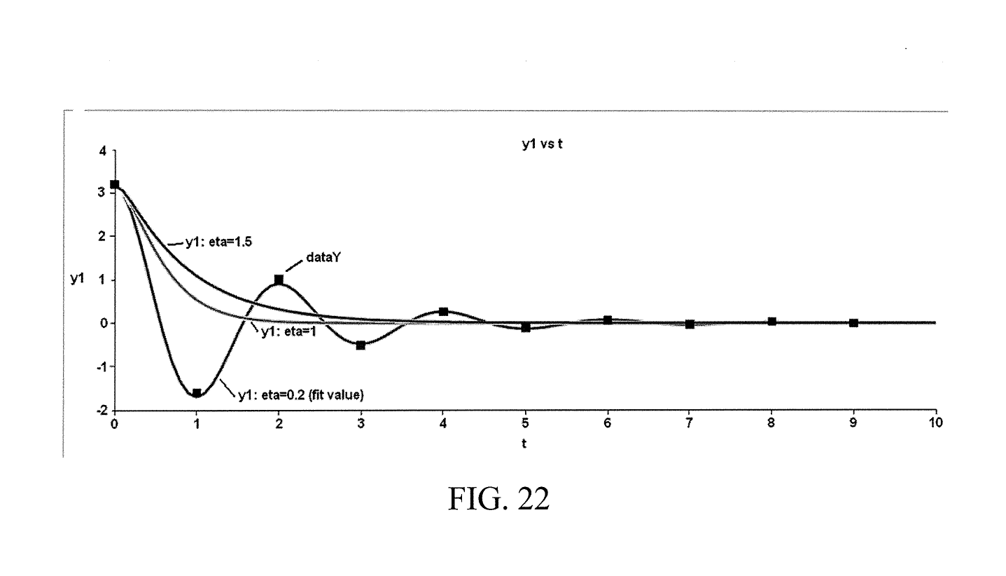

For instance, in Example 1, as shown in FIG. 22, the fit eta parameter may tell the user (e.g., a shock absorber designer) how close the shock absorber is to being critically damped. In this second order example composed of a mass, a spring and a dashpot in the design of a suspension system, an identified eta (0.2) of less than 1 classifies the system as being under damped. If eta is close to 1, the system is classified as being critically damped. This is the optimal response of the system. If eta is greater than 1, the system is classified as being over damped. An eta of 1 gives the optimal critically damped response where steady state displacement is reached as fast as possible without experiencing oscillations as shown by the profile in FIG. 22. Based on the fit parameters from FIG. 15A, the designer may know exactly how to alter the properties of the system (such as spring stiffness or damper viscosity) to achieve the critically damped case (i.e., how to minimize oscillations.

In Example 2, the fit pharmacokinetic parameters tell us the properties of a drug such as insulin for a particular individual. This allows a scientist to figure out how fast a drug is absorbed into the individual, when it reaches maximal concentration in the blood, etc. The fit modeled plasma insulin (simulated plasma insulin using the fit parameters) describes the experimentally collected plasma insulin points shown in FIG. 18B. A model simulation is not limited to the sampling schedule of the experimental data points as the model is capable of simulating the response at times in between experimental data points. Once fit parameters are obtained for a particular individual, the scientist can re-simulate the drugs appearance under different dosing strategy, whether given as a series of boluses (impulses) or delivered continuously (changing continuous delivery profile).

Example 3 is an extension of Example 2 that includes the pharmacodymanics of how insulin therapy affects an individual with type 1 diabetes glucose profile. Identified parameters such as Insulin Gain encapsulates the individuals sensitivity to insulin (i.e., how much glucose is reduced per unit of insulin) and is important in figuring out dosing. Here the model fit glucose replicates plasma glucose collected experimentally by a glucose sensor or lab analyzer.

In Example 4, the nerve axon parameters have been fit in FIG. 21A such that the modeled membrane potential profile matches that which was collected experimentally during a current clamp as shown in FIG. 21B.

The conventional systems, such as MATLAB, require additional programming to fit a defined model to experimental data as shown in MATLAB scripts for Examples 1 and 2. Furthermore additional code is required to indicate which subset of model points are paired up with the experimental data (see code line:“[intersection,ia,indexPairs]=intersect(data_t,tSpan);” in the FitSpringDamperSystem.m file for Example 1, and the same line of code in the FitBasalBolusInsulin.m file for Example 2) as well as calculate the SSE or penalty function to be minimized to identify the optimal model parameters for the particular experimental dataset.

In some embodiments, once the model is entered or uploaded into the GUI along with experimental data, the user may only have to select the model variable and the experimental dataset that the user wishes to fit the model variable to and enter the fit model instruction (e.g., by clicking on the “Fit Model” button). In some embodiments, the model variable and experimental dataset may be selected from a drop down list. In some non-limiting embodiments, all model variables may be listed under the “Fit Variable” drop down, and all experimental data columns are listed under the “To Data” drop down defined by the headers in the table in the “Data” tab. This may prevent the user from typing in variable names that don't exist and may limits the possibility of errors. Here again, no custom programming is required by the user. In some embodiments, when the fitting procedure is complete, the model output and plots may be automatically updated. Model data and experimental data may be automatically paired up for the same independent variable values (e.g., at the same times).

In some embodiments, the mathematical model analysis computer system 102 may simulate an identified model to different input conditions. Once model parameters are identified or fit to a particular system or individual, subsequent simulations using the fit parameters can be done under different inputs. After the fit parameters are obtained in the second column of the parameters table, the user can click on “Copy Fit to Initial Guess” for subsequent simulations to be performed with the fit parameters. This may allow the user to observe how a system or individual would behave under different conditions in simulation prior to implementing them experimentally. Inputs to the system can be optimized to achieve a desired output.

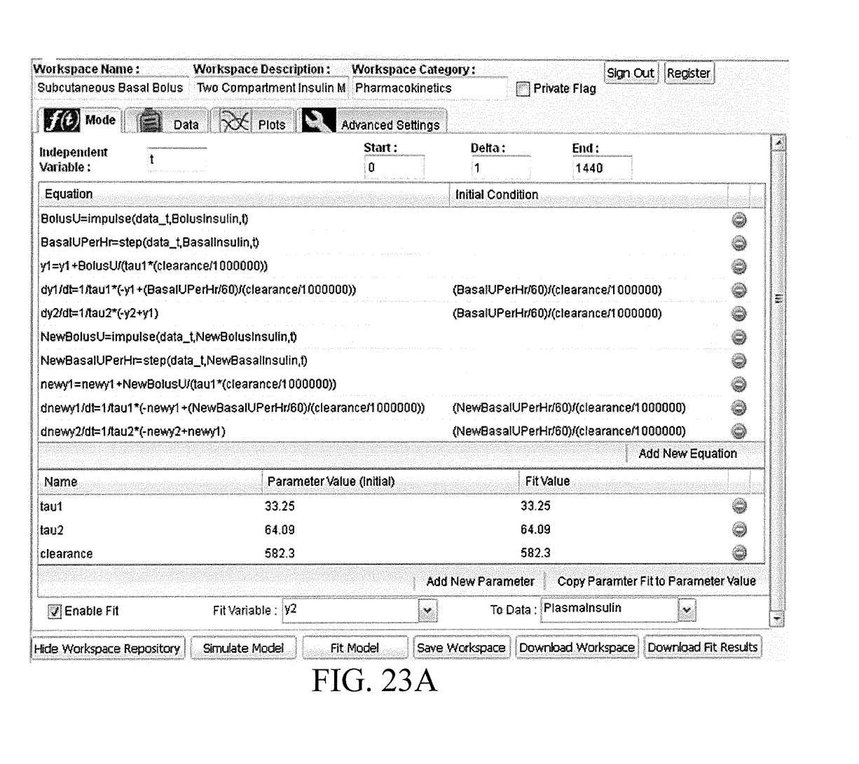

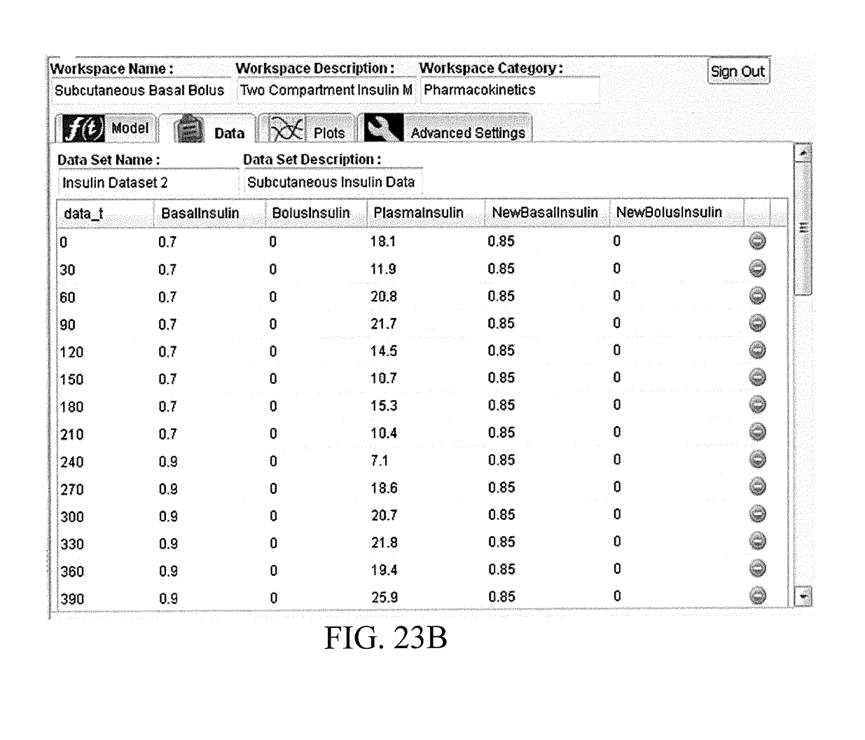

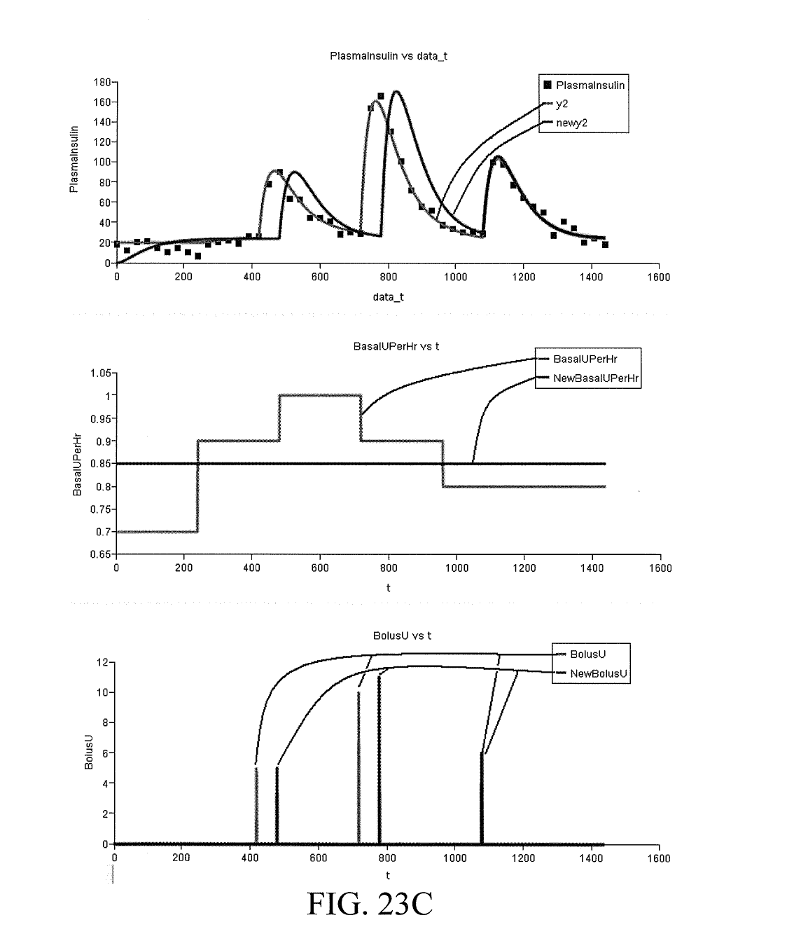

In Example 2, using an initial guess for each parameter, the mathematical model analysis computer system 102 may generate the simulation shown in FIG. 17D. The mathematical model analysis computer system 102 may identify or fit a patient's individual parameters and generate the results shown in FIG. 18B. In some embodiments, the user can use the fit parameters in subsequent simulations by the mathematical model analysis computer system 102 to test what would have happened under a different drug delivery profile. The model in FIG. 23A under new inputs in FIG. 23B illustrates a new simulation in FIG. 23C (newy2), by the mathematical model analysis computer system 102, of the identified drug absorbance model under new input conditions for the basal and bolus infusions as described in Example 2. The ability of the mathematical model analysis computer system 102 to run new simulations of an identified model using new input data allows the user to simulate and test a different scenario prior to implementing it. In other words, this ability may be used to answer what if scenarios, such as what would the appearance or concentration of the drug in the blood look like if we changed the basal rate, bolus timings and/or amounts. Thus, in some embodiments, the mathematical model analysis computer system 102 may be used to evaluate (fit) the pharmacokinetics of subcutaneously delivered insulin of a particular individual from a known insulin delivery profile (BasalUPerHr and BolusU of middle and bottom subplots, FIG. 23C) and measured plasma insulin concentration profile (simulated y2 fit to points, FIG. 23C, top subplot) and simulate how the plasma insulin concentration profilechanges (newy2 of top subplot of FIG. 23C) if the insulin delivery profile changes (newBasalUPerHr and newBolusU of middle and bottom subplots, FIG. 23C).

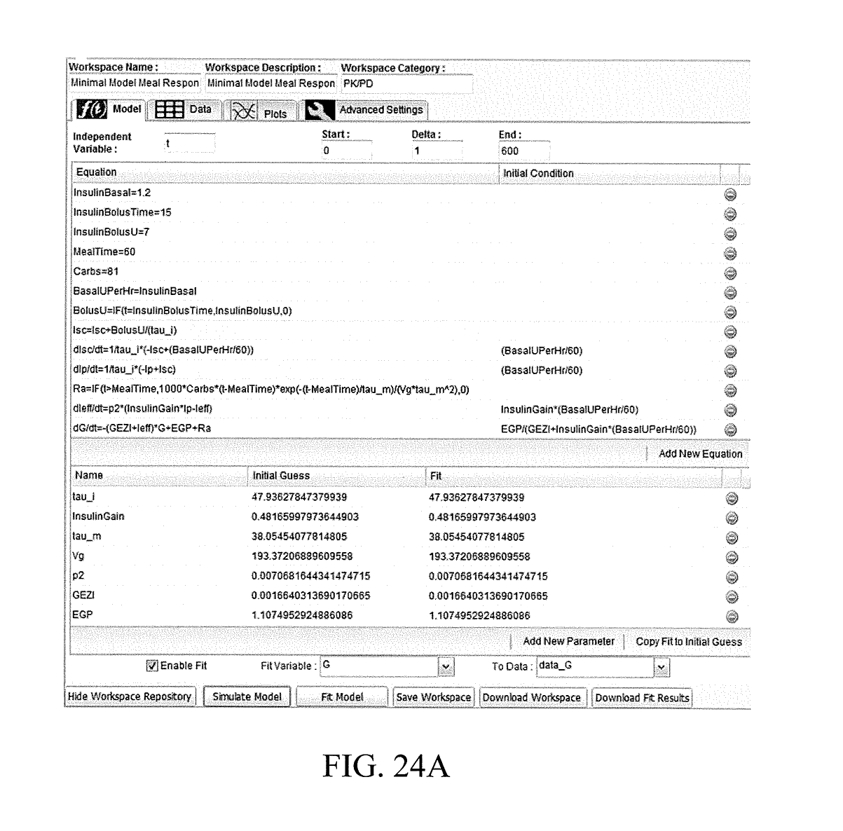

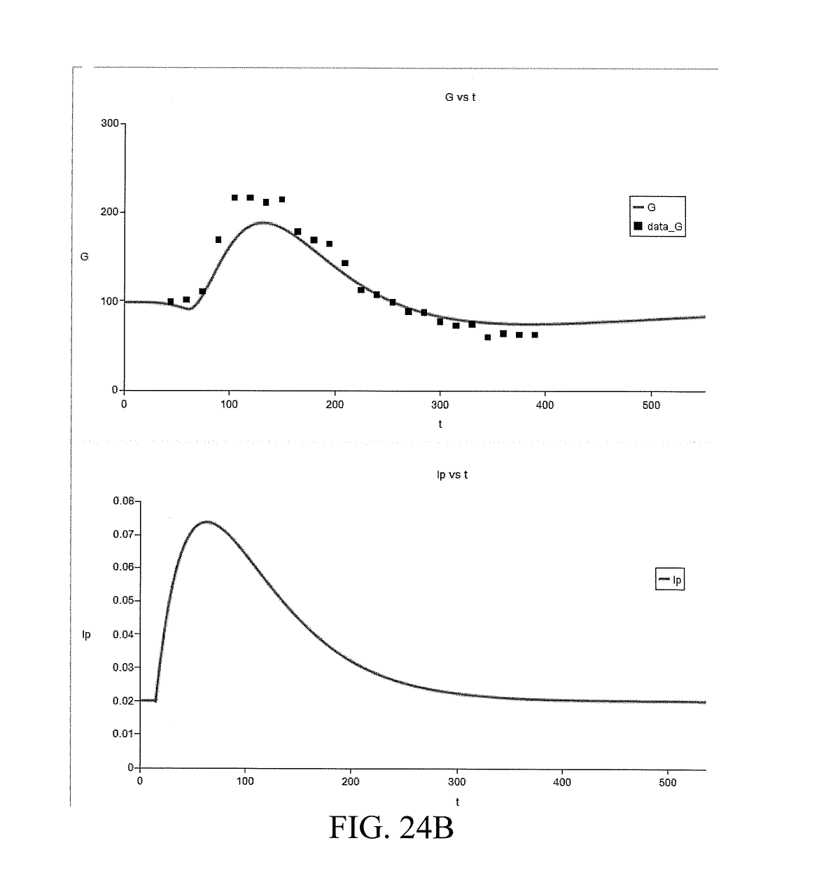

In Example 3, the mathematical model analysis computer system 102 has identified or fit an individual patient's model parameters to their experimental data and generated the fit parameter results shown in FIG. 20A with resulting simulation in FIG. 20B that describes the experimental data (FIG. 20B, top subplot). In some embodiments, the user can use the mathematical model analysis computer system 102 to perform subsequent simulations to optimize the insulin bolus (input profile) in order to minimize a patient's glucose response curve (area under the glucose curve) without achieving a glucose concentration value below a certain threshold. A simulation of the original experiment (7U of insulin bolus given at the same time as a meal of 81 g carbohydrate) yields a post-prandial (after meal) glucose peak of 222 mg/dl and a nadir of 68 mg/dl (see FIG. 20B, top sub plot). The goal of a patient with Type 1 diabetes is to lower the post-prandial peak and increase the ensuing nadir to prevent hypoglycemia. FIG. 24B shows the results of a subsequent simulation by the mathematical model analysis computer system 102 under different input conditions. FIG. 24B shows that if the patient took the same 7 U insulin bolus 45 minutes before the meal of 81 carbohydrates (instead of at the same time as the meal, by changing the InsulinBolusTime from 60 min in FIG. 20A to 15 min in FIG. 24A), the patient's post prandial peak glucose (G) would have lowered to 193 mg/dl, and the nadir would have been raised to 72 mg/dl (FIG. 24B). In the way, the system 100 may be used to make recommendations to achieve better results. In some embodiments, the user may additionally or alternatively simulate different a insulin bolus magnitude (InsulinBolusU) or basal rate (InsulinBasal), different carbohydrate amounts (Carbs), different rates of meal appearance (tau_m), and/or different insulin pharmacokinetic rates (tau_i).

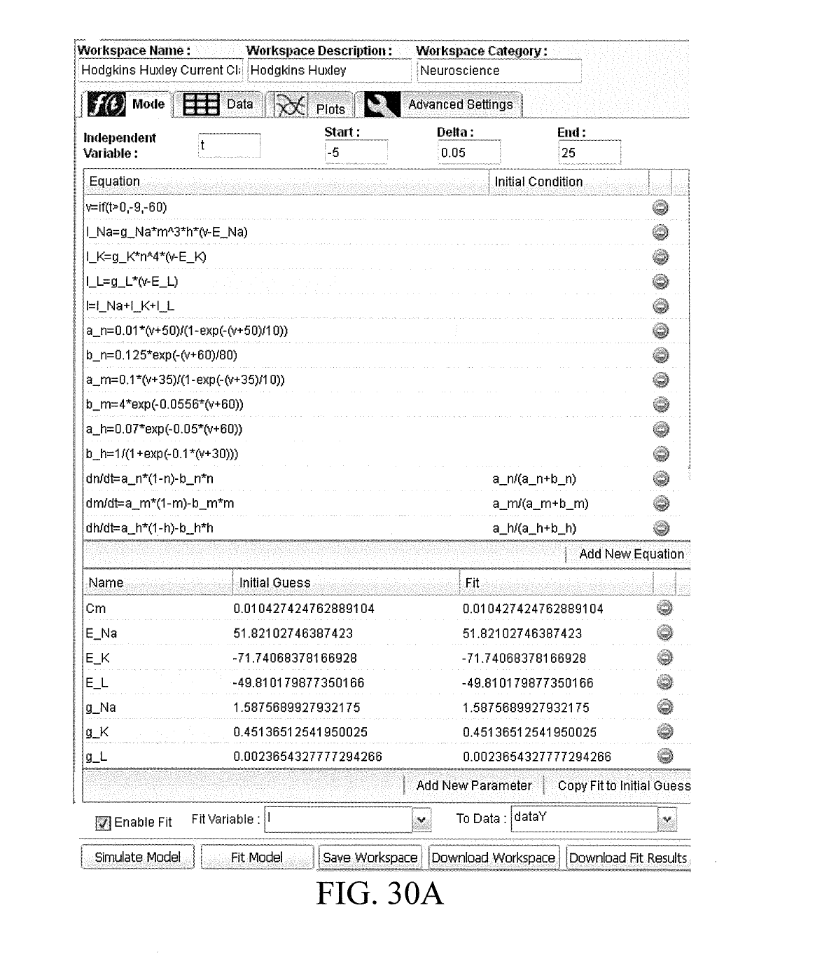

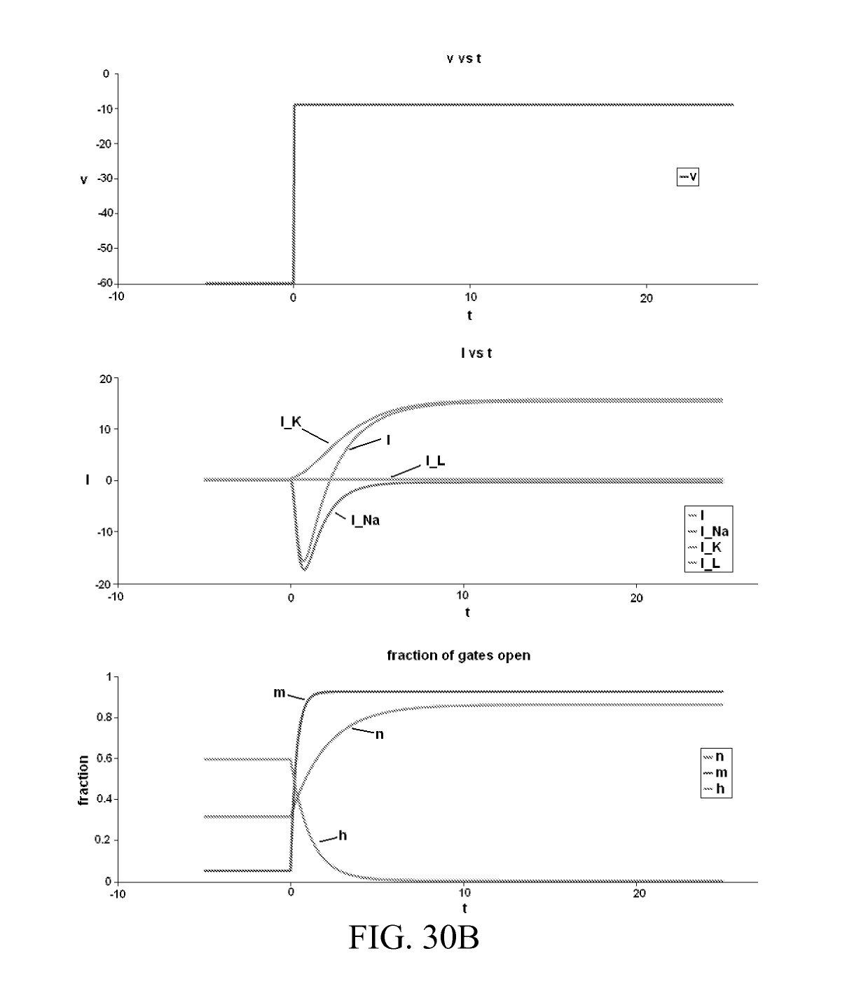

In Example 4, the mathematical model analysis computer system 102 has identified or fit the nerve axon parameters have been identified from data experimentally collected during a current clamp and generated the results shown in FIG. 21B. In some embodiments, the user can replace the data collected during the current clamp with data experimentally collected during a voltage clamp and use the mathematical model analysis computer system 102 to perform a subsequent simulation to observe how currents would behave under a voltage clamp. FIG. 30B illustrates the results of the subsequent simulation the mathematical model analysis computer system 102 using the Hodgkin-Huxely model of membrane potential (cyan line) on the voltage clamp data (top plot).

Conventional, standalone software packages may allow users to simulate and fit a single user defined closed form equation. However, in some embodiments of the present invention, the mathematical model analysis computer system 102 may simulate or fit a custom user defined model consisting of multiple closed form equations and/or single or multiple differential equations without requiring programming or scripting from the user. Furthermore, in some embodiments the mathematical model analysis computer system 102 may handle multiple changing inputs (see Example 2) without requiring programming or scripting from the user. Accordingly, the mathematical model analysis computer system 102 may have the flexibility of model customization with changing inputs that requires no programming (in a particular scripting language) by the user.

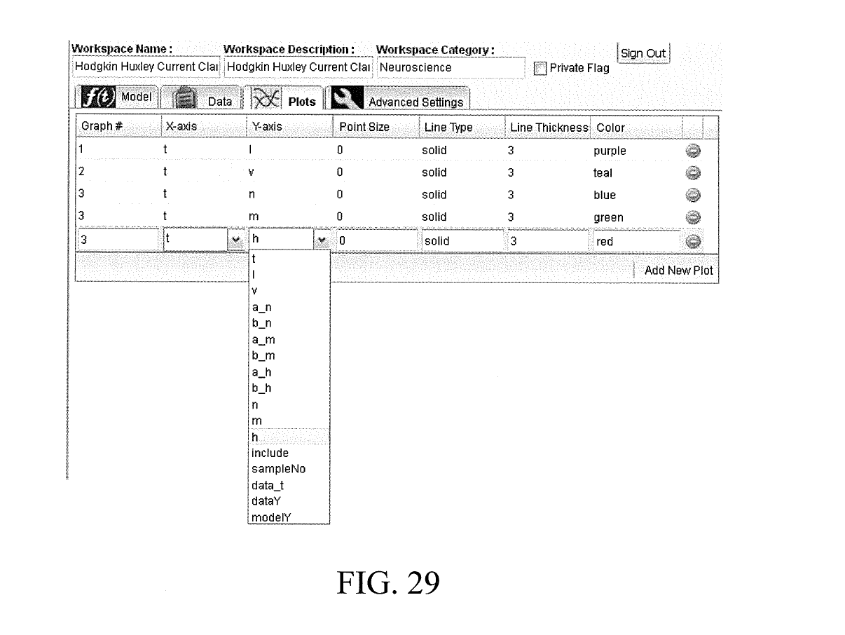

In some embodiments, the system 100 may automatically plot data on graphs on the screen once a model is simulated or fit to a dataset. In some embodiments, users can define a variable on the y-axis to plot against a variable on the x-axis (e.g., using a drop down list containing the names of existing state variables and datasets, which may eliminate data entry errors). In some embodiments, plot properties (e.g., which graph # to plot the data to, “X-axis” variable to plot, “Y-axis” variable to plat, and/or plot properties such as “Point Type”, “Point Size”, “Line Type”, “Line Thickness” and/or “Color” as shown in FIG. 29, which relates to Example 4) may be user definable. In some embodiments, after entry of a simulate model instruction (e.g., hitting a “Simulate Model” button), the graphs are automatically updated with the simulated profiles using initial guesses, which may be in an “Initial Guess” column, for the parameter values. In some embodiments, after entry of a simulate model instruction (e.g., hitting a “Fit Model” button), the graphs may be automatically updated with the simulated profiles using best fit parameter values, which may be in a “Fit” column.

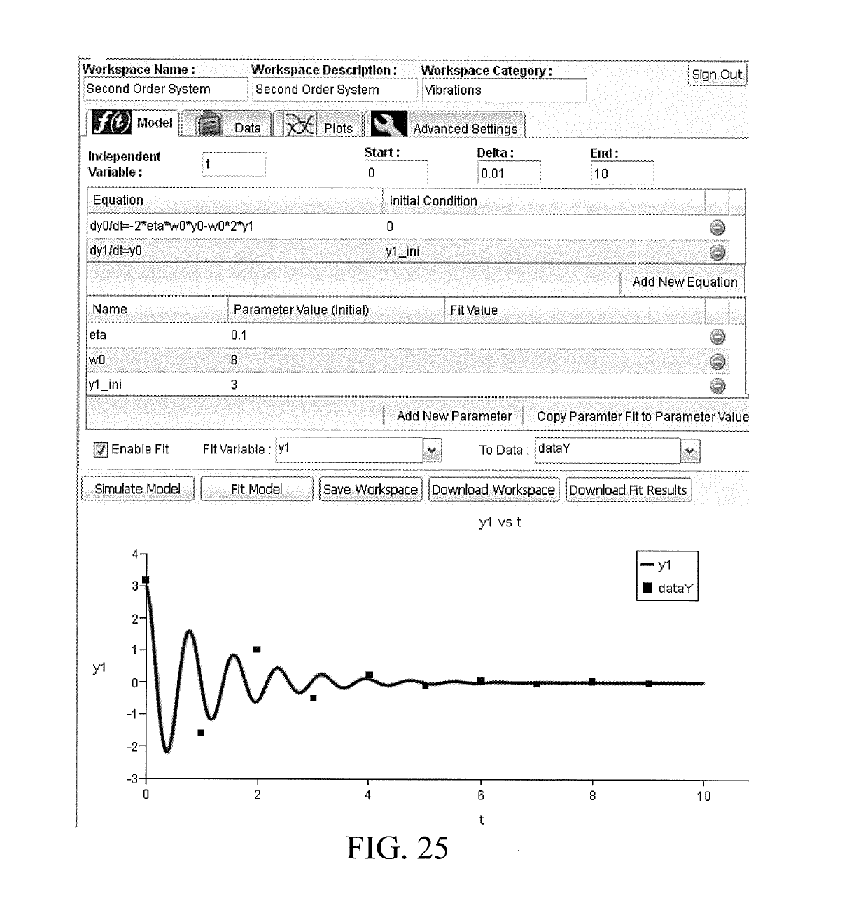

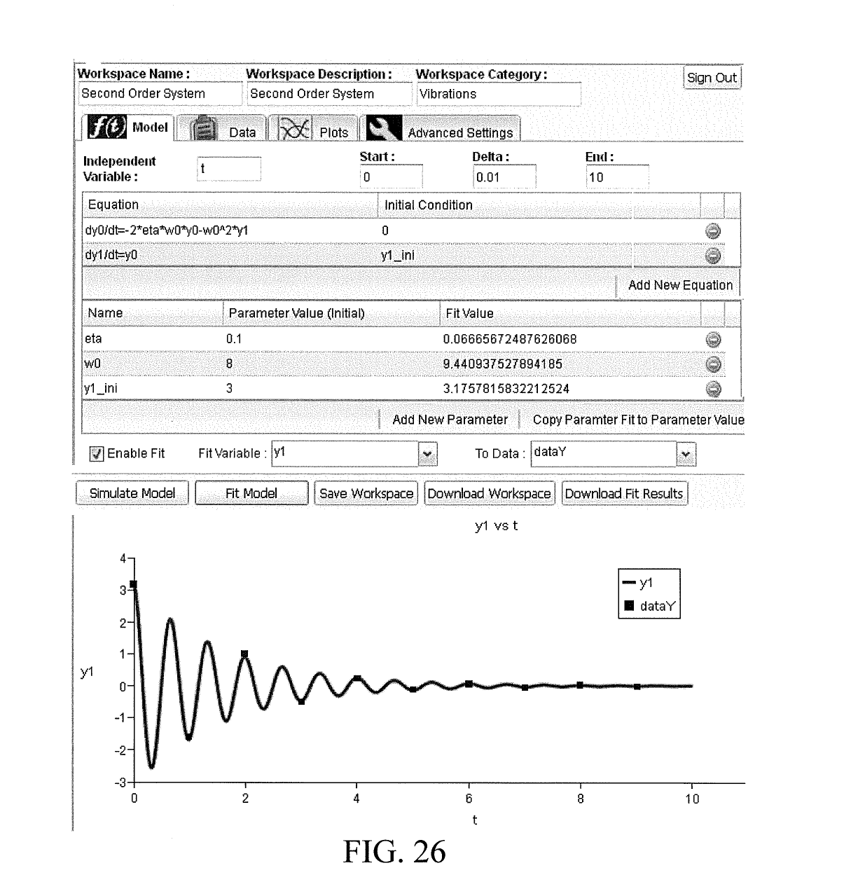

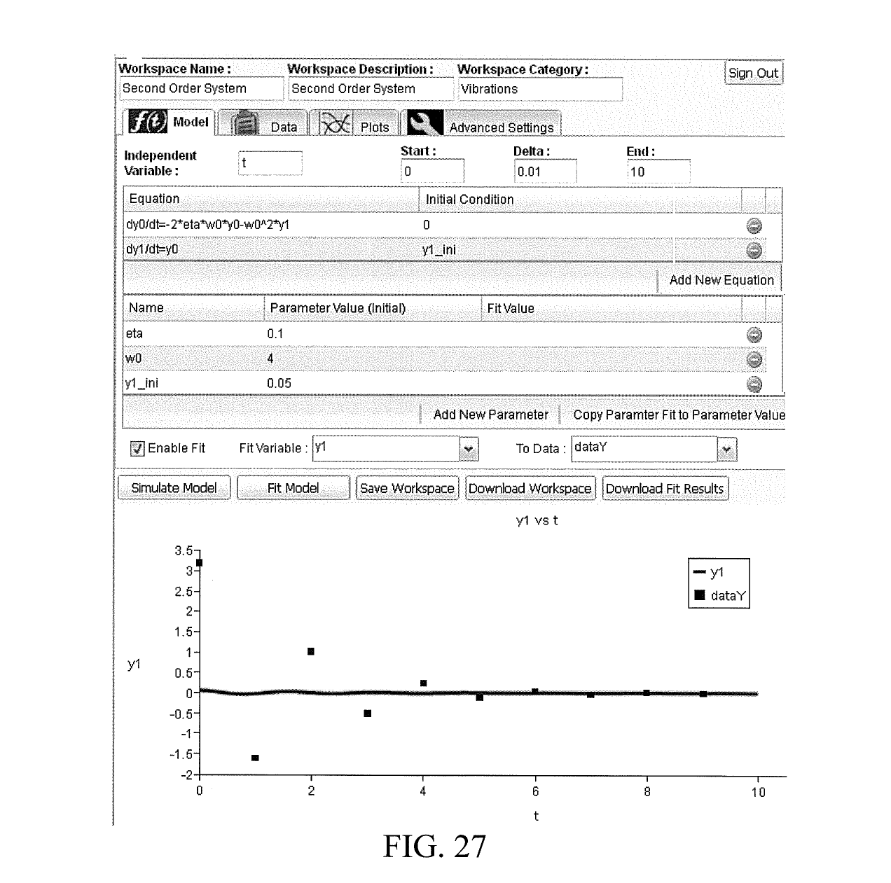

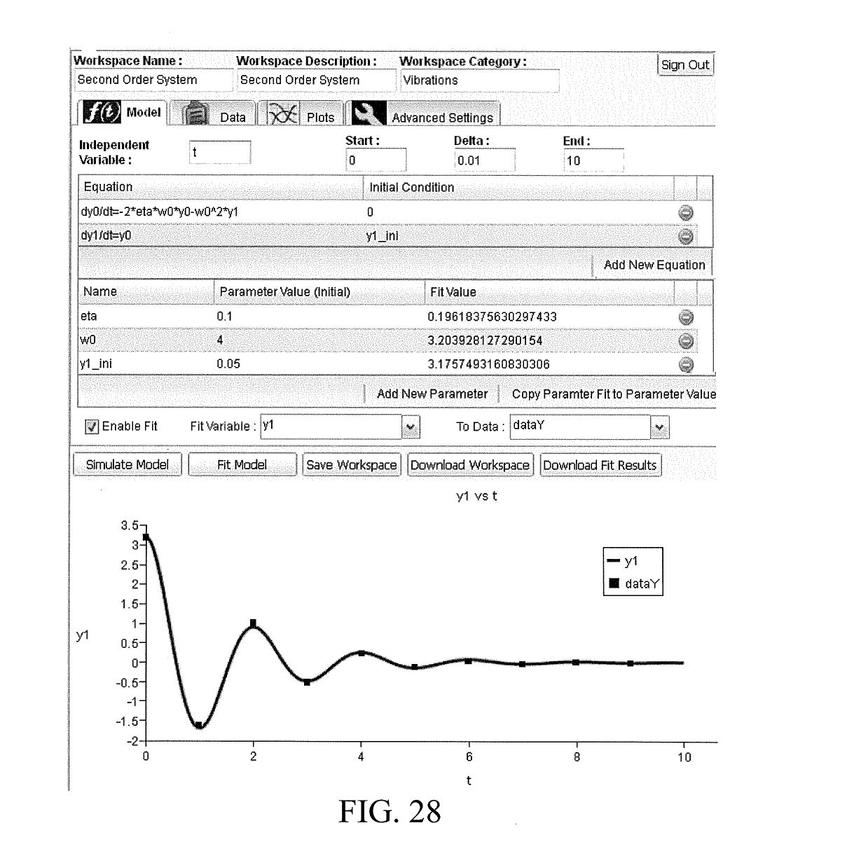

In some non-limiting embodiments, the simulation of the model by the mathematical model analysis computer system 102 using the initial guess parameters may be visualized prior to fitting a model to an experimental dataset. This is because the mathematical model analysis computer system 102 may use a non-linear least squares procedure to iterate model parameters starting with the initial guess to minimize the SSE between the model and the experimental data. Depending on the initial guess values selected for the parameters, the resulting fit parameters and resulting model output may vary. FIGS. 25-28 illustrate the results of simulations and fit operations, by a mathematical model analysis computer system 102, on the Example 1 (shock absorber) model based on different initial guesses for the parameters. The initial guess parameter values selected in FIG. 25 yields the fit result in FIG. 26 whereas the initial guess parameter values selected in FIG. 27 yields the fit result in FIG. 28.

The resulting fit parameters and model in FIG. 26 are different than those in FIG. 28, but the sum squared error between the model and data is just as low. The correct result may be one or the other depending on where experimental data points lie had they been collected at a higher frequency. This demonstrates the value in plotting the simulated model with initial guess parameters as well as the resulting fit parameters to ensure the results make sense.

FIGS. 27 and 28 show the results of initial guess and fit parameter simulations, respectively, of the Example 1 model of a second order shock absorber system using an inappropriate initial guess for the parameters. As shown in FIG. 27, the initial guess for the parameters is inappropriate because the simulated model under these parameters is too far from the experimental data points. FIG. 28 shows the best fit parameters for the Example 1 model that yield the minimum sum squared error between the model (line) and the experimental data through an iterative non-linear least squares procedure starting from the inappropriate initial guess. However, as the initial guess parameters are too far from reasonable values, the mathematical model analysis computer system 102 may get lost in a local minimum and may be unable to converge to the true parameters yielding an erroneous result.

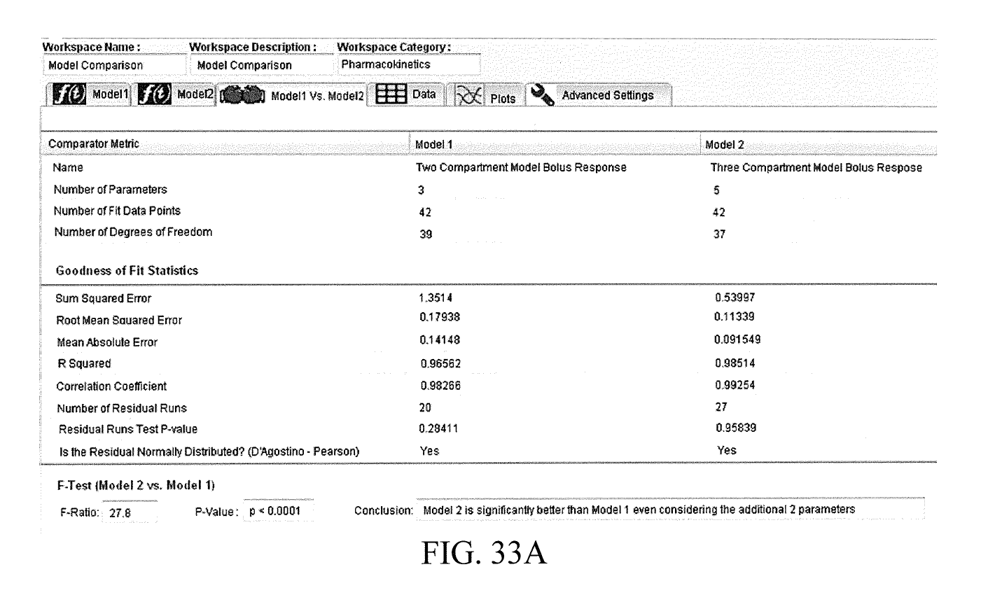

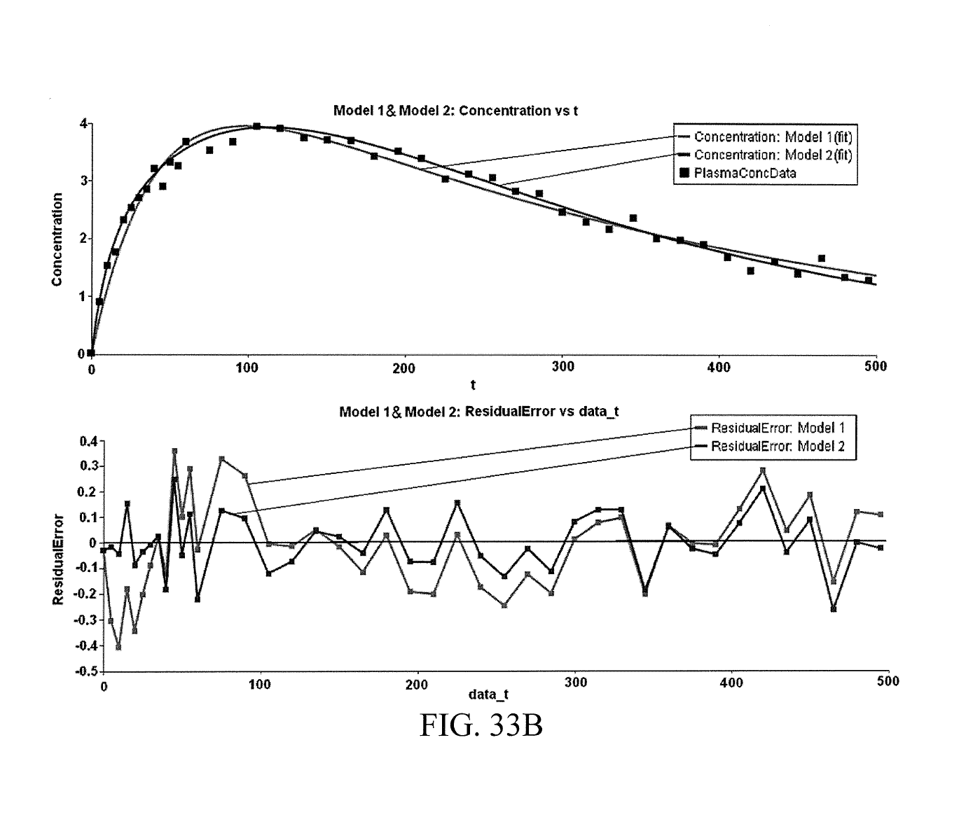

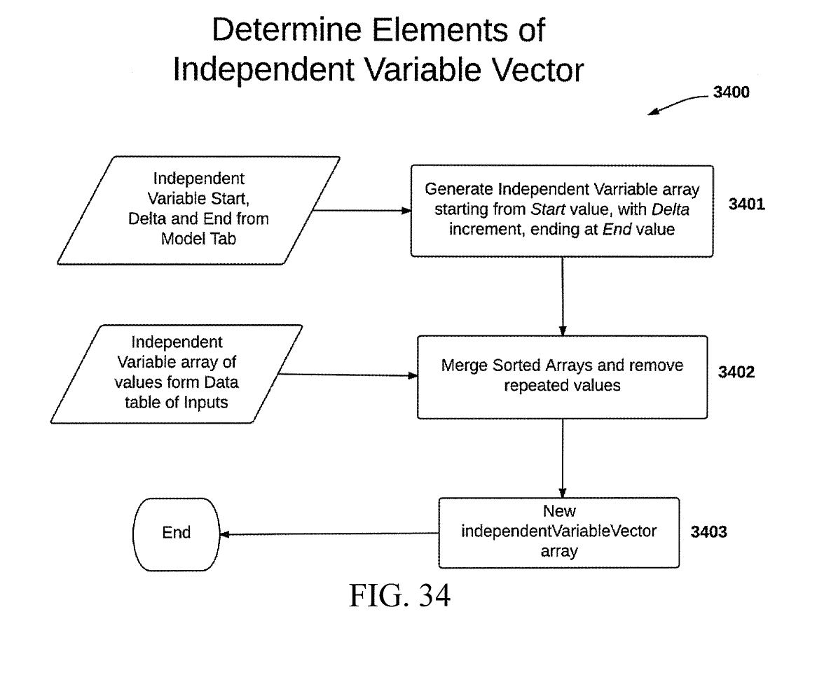

Visualization may also be useful when comparing the goodness of fit of two or more models to a data set as shown in FIG. 33 where each of the fit models are plotted along with the experimental data in addition to comparing the goodness of fit between two or more models.

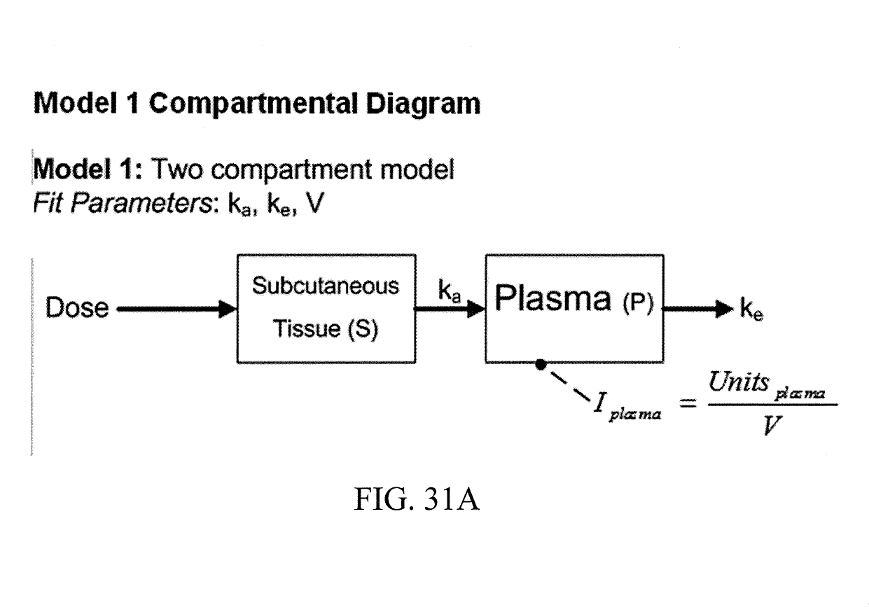

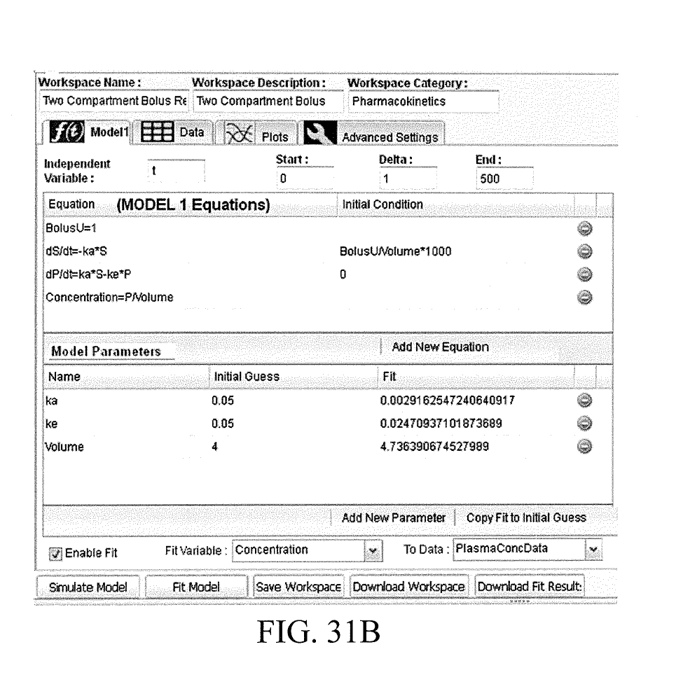

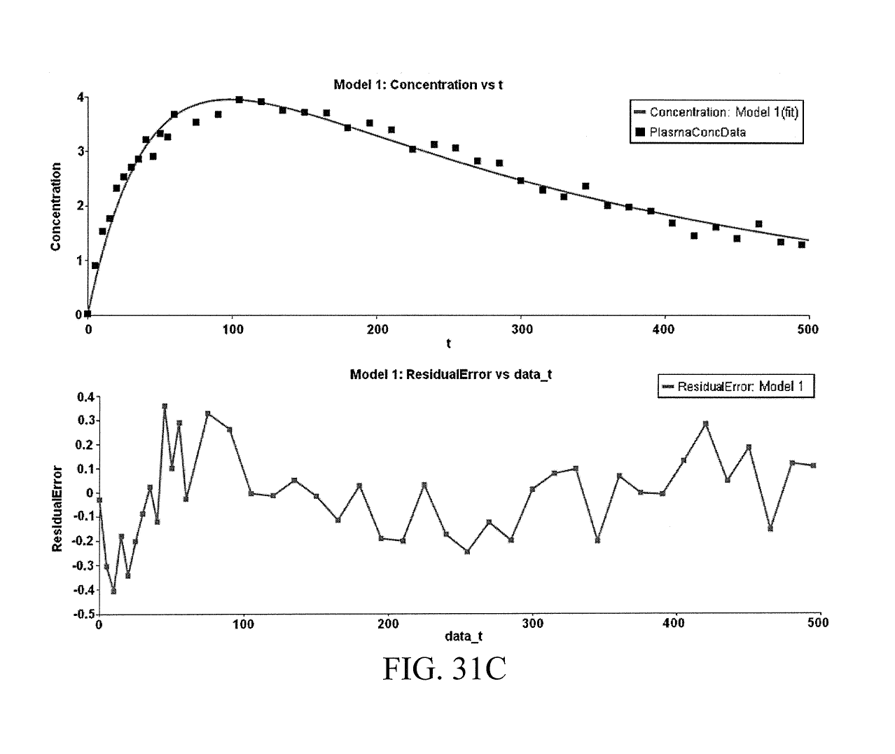

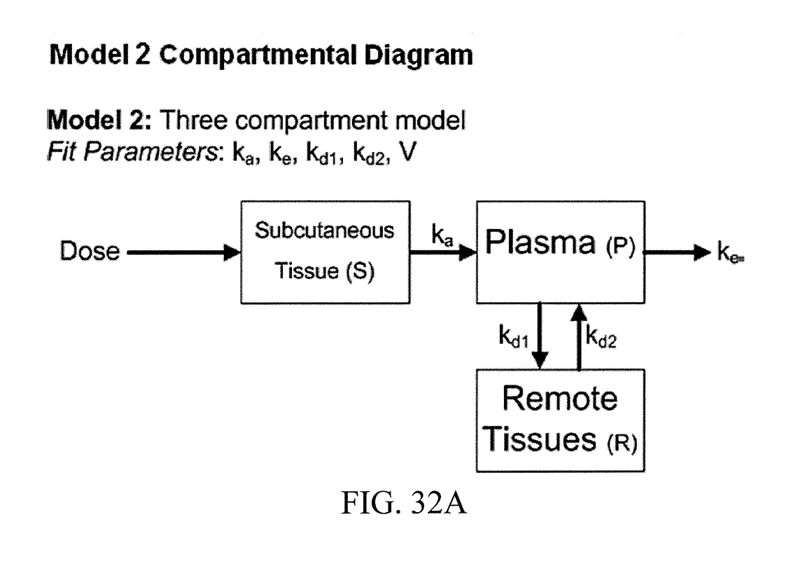

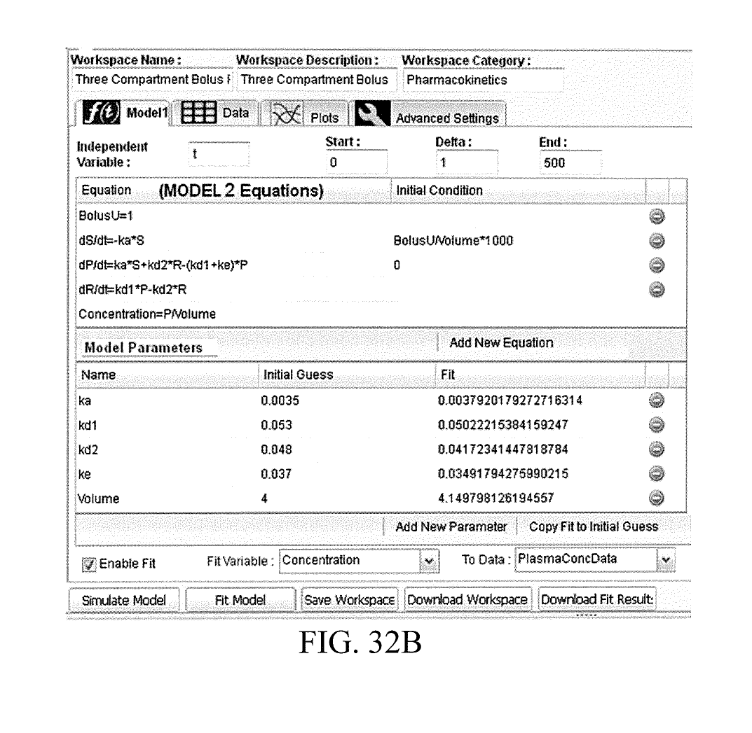

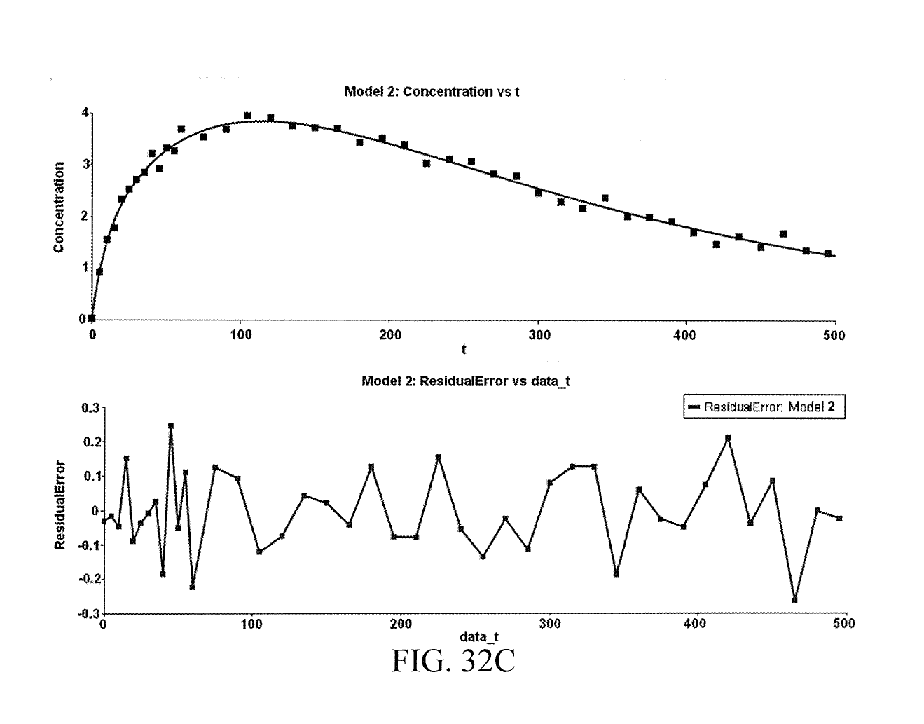

FIGS. 31-33 the results of an analysis of a dose response example model that may be generated by the mathematical model analysis computer system 102. The top subplot of FIG. 31C shows the fit simulated plasma concentration of two compartment model (Model 1) represented by the compartmental diagram in FIG. 31A and model equations in FIG. 31B to experimental data to a dose response to a drug given at time 0. The bottom subplot shows the error (residual) of the fit model relative to the (vertical displacement from the fit model simulation to the data from the top plot). The top subplot of FIG. 32C shows fit of three compartment model (Model 2) represented by the compartmental diagram in FIG. 32A and model equations in FIG. 32B to experimental data to a dose response to a drug given at time 0. The bottom subplot shows the error (residual) of the fit model relative to the (vertical displacement from the fit model simulation to the data from the top plot). FIG. 33A shows a statistical comparison of the goodness of fit of Model 1 versus Model 2 each fit to the experimental dos. FIG. 33B illustrates plotted model fits of each of these models against the experimental data along with their residuals. In some embodiments, the mathematical model analysis computer system 102 may be able to evaluate whether the increased complexity of Model 2 with two additional parameters is worth the reduction in sum squared error relative to the experimental data.

In some embodiments, the functionality mathematical model analysis computer system 102 may be architected as a collection of web services, each performing one or more of the functions listed above. A consequences of such an architecture may be that each service may be load-balanced as per demand. For example, should there be great demand for Data Storage/Retrieval service, then multiple instances of the service may be spawned and requests may be load-balanced between them. Another consequence may be that the Web services may be exposed to power users (third parties) who want to build their own applications using the functionality provided mathematical model analysis computer system 102. That is, in some embodiments, the system 100 may be configured such that a third party website can access the mathematical model analysis computer system 102 from the third party website using its own custom GUI or software. The model equations, parameters, and data would be sent to the mathematical model analysis computer system 102 through web communication. The mathematical model analysis computer system 102 would perform analysis, model simulation, fitting models to data and send the results/plots back to the user's website. Also, the third party website may have the ability to save and retrieve models from the inventions repository.

In some embodiments, the system 100 may be applied to one or more of scientific research, academics, education websites, design of sensors and control systems, the financial industry, and sales teams. In scientific research, models are devised to replicate and physical phenomena (as in Examples 2 and 3). A scientist or engineer hypothesizes a mathematical model describing some physical phenomena and needs to validate and refine the model by comparing it and fitting it to (i.e., replicating) experimental data. After parameters have been fit or identified to an appropriate model, the model is re-simulated under different inputs so as to make predictions as to how the system would behave under different conditions before implementing them to the real patient. A priori knowledge of how a person responds to a drug therapy may add a measure of safety to the patient and therapy can be optimized quickly as opposed to a repetitive test and see approach. Evaluating whether predicted results are independently validated with independent datasets (not used to identify the model) can help further refine and improve the model. For example, the system 100 may be applied in the pharmaceutical industry where pharmacokinetic models of different drugs are used to optimize dosage amounts and scheduling to achieve a desired concentration of the drug at a targeted location (see Example 2). Furthermore, as medicine is moving towards a personalized approach, a unique set of model parameters can be identified to each individual whereby the model is fit to experimental data that measures the concentration of a drug in response to a dose. Then, the patients dosing regimen can be optimized in simulation to achieve a desired concentration profile over time. For example, the dosage of Tylenol is currently the same for adults and normalized to body weight for children. There are many factures that affect an individual's sensitivity to a drug. Models can be used to evaluate an individual's sensitivity and response to a drug and provide an individualized dosing strategy.

In regard to academics, the system 100 may be used to teach applied mathematics can be taught without having the students first learn to program. More time could be spent learning the mathematical concepts as opposed to programming the tool. Students may use the system 100 share their models and data and learn from each other. Collaborating on the current state-of-the-art requires copying programs and re-running them. Such steps are eliminated by the invention. Universities may subscribe entire classes to the system 100 instead of buying licenses for software packages like MATLAB (and installing and maintaining them). Educational websites may access the mathematical model analysis computer system 102 by sending model equations, parameters and data from their own website. Once the mathematical model analysis computer system 102 performs analysis (simulation and/or systems identification), results can be sent back.

Educational websites often publish model equations and simulations; however these simulation outputs are often static images, or fixed animations. They are usually not interactive. For example Wikipedia's description of the Hodgkin-Huxley model is shown here: http://en.wikipedia.org/wiki/Hodgkin%E2%80%93Huxley_model. It would be more instructive if one could evaluate how changes in inputs, model parameters or equations affect the simulated output which can be done with this invention.

In regard to sensors and control systems, temperature sensor and other sensor manufacturers often require users to recalibrate sensors by fitting a calibration model to experimental data. The manufacturers may offer a software download by which users may tweak how their device is calibrated or rely on the end user to have the knowledge to re-calibrate the sensors themselves. Such manufacturers may publish the model on the mathematical model analysis computer system 102 instead of having to develop and maintain their own computational tool.

The financial industry may use the mathematical model analysis computer system 102 to analyze models used to predict the price of a stock. They could calculate whether certain parameters are significantly correlated to the movement in stock price. The time- and cost-efficiencies mentioned above for the scientific research industry can also be achieved by the financial industry—through quick delivery of results, not needing to program, and not having to maintain installed software and hardware.

In regard to sales teams, the mathematical model analysis computer system 102 may be used to create sales forecasts. Sales teams may devise models based on past sales, and use the product to predict future sales based on certain inputs.

While various embodiments of the present disclosure are described herein, it should be understood that they have been presented by way of example only, and not limitation. Thus, the breadth and scope of the present disclosure should not be limited by any of the above-described exemplary embodiments. For example, although embodiments were described in which the mathematical model analysis computer system 102 is remotely accessed by one or more device 104, this is not required. In some alternative embodiments, the mathematical model analysis computer system 102 may be present on user device, such as a laptop, tablet, smart phone, or personal computer. Moreover, any combination of the above-described elements in all possible variations thereof is encompassed by the disclosure unless otherwise indicated herein or otherwise clearly contradicted by context. Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method of analyzing or simulating a mathematical model, the method comprising:
receiving, at a computer, an identification of a user-defined model from a device remote from the computer;
receiving the identified model, wherein the model includes one or more model equations that (i) include at least one differential equation and/or at least one closed form equation, (ii) are not written in a syntax particular to a specific programming language, and (iii) include one or more parameters;
receiving a parameter set including a parameter value for each of the one or more parameters from a device remote from the computer;
receiving an identification of a dataset from a device remote from the computer;
receiving the identified dataset, wherein the dataset includes experimental data related to the model;
generating a simulation of the model based on the one or more model equations and the parameter set;
generating simulation results including a plot of the model simulation and the dataset; and
transmitting the simulation results to a device remote from the computer.

2. The method of claim 1, further comprising calculating an error between the simulated model and the experimental data, wherein the simulation results include the calculated error.

3. The method of claim 1, further comprising identifying a best fit parameter set including a best fit parameter for each of the one or more parameters.

4. The method of claim 3, wherein the parameter set is an initial parameter set, and identifying the best fit parameter set comprises:
calculating an error between the simulated model and the experimental data;
generating a new parameter set including a parameter value for each of the one or more parameters, wherein one or more of the parameter values of the new parameter set is different from a corresponding parameter value of the initial parameter set;
generating a new simulation of the model based on the one or more model equations and the new parameter set; and
calculating an error between the new simulated model and the experimental data.

5. The method of claim 4, wherein identifying the best fit parameter set comprises iteratively generating new parameter sets, wherein the best fit parameter set is a set of the new parameter sets that minimizes a calculated error between a simulation of the model based on the one or more model equations and the set of the new parameter sets and the experimental data.

6. The method of claim 3, wherein identifying the best fit parameter set comprises using either a linear or non-linear least squares procedure.

7. The method of claim 6, wherein identifying the best fit parameter set comprises automatically determining whether to use a linear least squares procedure or a non-linear least squares procedure.

8. The method of claim 3, further comprising:
generating a best fit simulation of the model based on the one or more model equations and the best fit parameter set;
generating best fit results including the best fit parameter set and a plot of the best fit simulation and the dataset.

9. The method of claim 8, further comprising:
receiving a second dataset from a device remote from the computer, wherein the second dataset includes experimental data related to the model;
generating second simulation results including a plot of the model simulation and the second dataset; and
transmitting the second simulation results to a device remote from the computer.

10. The method of claim 1, further comprising:
receiving a second model from a device remote from the computer, wherein the second model includes one or more second model equations that (i) include at least one differential equation and/or at least one closed form equations, (ii) are not written in a syntax particular to a specific programming language, and (iii) include one or more second model parameters;
receiving a second parameter set including a parameter value for each of the one or more second model parameters from a device remote from the computer;
generating a second simulation of the second model based on the one or more second model equations and the second parameter set;
generating second simulation results including a plot of the second model simulation and the dataset; and
transmitting the second simulation results to a device remote from the computer.

11. The method of claim 10, wherein generating the second simulation of the second model requires none of re-writing, re-interpreting, and re-compilation of a program.

12. The method of claim 1, wherein the one or more model equations include one or more differential equations and one or more closed form equations.

13. The method of claim 1, wherein the one or more model equations include multiple closed form equations.

14. The method of claim 1, further comprising:
receiving a second parameter set including a second parameter value for each of the one or more parameters from a device remote from the computer;
generating a second simulation of the model based on the one or more model equations and the second parameter set;
generating second simulation results including a plot of the second simulation of the model and the dataset; and
transmitting the second simulation results to a device remote from the computer.

15. The method of claim 1, wherein generating the simulation of the model comprises interpreting the one or more model equations as an interdependent system of equations.

16. The method of claim 15, wherein interpreting the one or more model equations as an interdependent system of equations comprises treating a state variable listed on the left hand side of a model equation of the one or more model equations that also appears on the right hand side of a model equation of the one or more model equations as the same variable.

17. The method of claim 1, wherein the remote device from which the identification of the user-defined model is received and the remote device to which the simulation results are transmitted comprise a website of a third party user,
wherein the identification of the user-defined model is received through web communication,
wherein the simulated results are transmitted through web communication, and wherein the website includes a custom graphical user interface or custom software capable of transmitting the identification of the user-defined model to the computer and capable of receiving and displaying the simulation results.

18. The method of claim 1, wherein the simulation results are displayed on the remote device adjacent to a forum window capable of displaying a user-defined description of the of the model, users' comments, the one or more model equations, one or more state variables of the model equations, and/or the one or more parameters of the one or more model equations.

19. A computer system for analyzing or simulating a mathematical model, the computer system comprising:
a storage device;
a computer; and
a computer readable medium storing computer readable instructions executable by said computer whereby said computer is operative to:
receive an identification of a user-defined model from a remote device;
receive the identified model from the storage device, wherein the received model includes one or more model equations that (i) include at least a differential equation and/or multiple closed form equations, (ii) are not written in a syntax particular to a specific programming language, and (iii) include one or more parameters;
receive an identification of a dataset from the remote device;
receive the identified dataset from the storage device, wherein the received dataset includes experimental data related to the model;
receive a parameter set including a parameter value for each of the one or more parameters from the remote device;
generate a simulation of the model based on the one or more model equations and the parameter set;
generate simulation results including a plot of the model simulation and the dataset; and
transmit the simulation results to the remote device.

20. A computer program product for analyzing or simulating a mathematical model, the computer program product comprising a non-transitory computer readable medium storing computer readable instructions, the instructions comprising:
instructions for receiving an identification of a user-defined model from a remote device;
instructions for receiving the identified model from the storage device, wherein the received model includes one or more model equations that (i) include at least a differential equation or multiple closed form equations, (ii) are not written in a syntax particular to a specific programming language, and (iii) include one or more parameters;
instructions for receiving an identification of a dataset from the remote device;
instructions for receiving the identified dataset from the storage device, wherein the received dataset includes experimental data related to the model;
instructions for receiving a parameter set including a parameter value for each of the one or more parameters from the remote device;
instructions for generating a simulation of the model based on the one or more model equations and the parameter set;
instructions for generating simulation results including a plot of the model simulation and the dataset; and
instructions for transmitting the simulation results to the remote device.
